(19) United States
(12) Patent Application Publication
(10) Pub. No.: US 2010/0082652 A1
(43) Pub. Date: Apr. 1, 2010

(54) METHOD AND SYSTEM FOR MANAGING USER INTERACTION

(75) Inventors: Scott A. Jones, Carmel, IN (US); Thomas E. Cooper, Indianapolis, IN (US)

Correspondence Address: STAAS & HALSEY LLP, SUITE 700, 1201 NEW YORK AVENUE, N.W., WASHINGTON, DC, 20005, US

(73) Assignee: ChaCha Search, Inc., Carmel, IN (US)

(21) Appl. No.: 12/568,293

(22) Filed: Sep. 28, 2009

Related U.S. Application Data
(60) Provisional application No. 61/101,015, filed on Sep. 29, 2008.
(60) Provisional application No. 61/109,353, filed on Oct. 29, 2008.

(51) Int. Cl. G06F 17/30; G06F 15/16

(52) U.S. Cl. 707/758; 709/206; 707/E17.014; 707/E17.032

(57) ABSTRACT

A system and method are described for managing user interaction(s) and information of user(s). The system may select activities which are associated with a user system and may inform content providers of user systems which have received content from the system. User actions are detected and responses associated with the activities associated with the user system are executed. A user interface which is specific to a user system may be defined. A user may access various forms of information which may include using a human assistant to access information. The system and method include creating an index of redacted information associated with a user and selectively providing access to the information for performing a transaction or service on behalf of the user.

### CROSS-REFERENCE TO RELATED APPLICATIONS

This application is related to and claims the benefit of U.S. patent application Ser. No. 12/109,776, Attorney Docket No. 1918.1029, inventor Scott A. Jones, et al., titled “METHOD AND SYSTEM FOR IMPROVEMENT OF RELEVANCE OF SEARCH RESULTS”, filed Apr. 25, 2008; U.S. patent application Ser. No. 12/275,864, Attorney Docket No. 1918.1034, inventor Scott A. Jones, et al., titled “METHOD AND SYSTEM FOR IMPROVING UTILIZATION OF HUMAN SEARCHERS”, filed Nov. 21, 2008; and, U.S. patent application Ser. No. 12/434,385, Attorney Docket No. 1918.1036, inventor Scott A. Jones, et al., titled “METHOD AND SYSTEM FOR IMPROVEMENT OF REQUEST PROCESSING, filed May 1, 2009; and U.S. patent application Ser. No. 12/500,327, Attorney Docket No. 1918.1058, inventor Scott A. Jones, title “METHOD AND SYSTEM OF FACILITATING A PURCHASE”, filed Jul. 9, 2009. In addition, this application is related to and claims the benefit of Provisional Application Ser. No. 61/109,353, Attorney Docket No. 1918.1059P, inventor Scott A. Jones, titled “METHOD AND SYSTEM FOR PROVIDING SECURE TRANSACTION SERVICES”, filed Oct. 29, 2008; and Provisional Application Ser. No. 61/101,015, Attorney Docket No. 1918.1060P, inventor Thomas E. Cooper, titled “METHOD AND SYSTEM FOR MANAGING USER INTERACTION”, filed Sep. 29, 2008, the contents of all of which are incorporated herein by reference in their entirety.

### BACKGROUND

1. Field of the Invention

The present invention is related to search engine technologies and more specifically to mobile search system(s). Embodiment(s) include responding to user messages which improves the ability to define and manage user interactions via a mobile device is described.

2. Description of the Related Art

Mobile search systems have been developed which allow a user to conduct a search using SMS (Short Message Service) capability of a mobile device. For example, a user may send a text message including a keyword which causes an automated search to be executed responsive to the text message, which may return one or more messages which include search results related to the keyword and a search term provided by the user. Services such as Google™ Mobile, 4Info®, and others may allow a user to enter a keyword and/or a query which may cause a search result to be provided to the user.

Likewise, services such as ChaCha® mobile may allow a user to submit an SMS query which may be processed by the service and may return a search result using an automated response and/or a response generated with the assistance of a human assistant or ‘guide’.

Such systems have been successful, but may have weaknesses. In the case of an automated search, a keyword of a message which requests specific information such as a stock quote or a weather forecast must be identified on a global basis. No matter which user submits a message including the keyword, a response is determined based on a global response assigned to the keyword. Likewise, a user may be provided with a text message which may include a partial search result from a guide, but if the user requests more information of the search result, the new request must be associated with a global keyword (e.g., ‘MORE’ to send more information) or may be routed to a guide, which may be an inefficient use of guide effort.

In light of the above and other existing problems, a method and system for associating a response from a user device with an action which allows a personalized response based on previous messages delivered to the user device would be useful and appreciated.

### SUMMARY

A method and system are disclosed which associate user action(s) with system response(s). A system and method of interacting with a user is provided. The method may include defining an action and associating the action with a first response, associating the action with a second response, associating the action and the first response with a user, detecting the action, determining whether the action is associated with the user, executing the first response when the action is associated with the user and executing the second response when the action is not associated with the user.

A method and system are disclosed herein which enable an index of redacted information associated with a user to be created where the redacted information selectively revealed to an authorized human assistant including to perform a transaction on behalf of the user.

Additional aspects and/or advantages will be set forth in part in the description which follows and, in part, will be apparent from the description, or may be learned by practice of the invention.

These together with other aspects and advantages which will be subsequently apparent, reside in the details of construction and operation as more fully hereinafter described, reference being had to the accompanying drawings forming a part hereof, wherein like numerals refer to like parts throughout.

### BRIEF DESCRIPTION OF THE DRAWINGS

Aspects and advantages of the disclosure will become apparent and more readily appreciated from the following description of the embodiments, taken in conjunction with the accompanying drawings, of which:

FIG. 1 is a block diagram of an exemplary system embodiment.

FIG. 2 is flowchart of creating and editing an interactive user activity.

FIG. 3 is flowchart of processing a user request.

FIG. 4 illustrates a database record for an interactive activity.

FIG. 5 illustrates a database record for a request.

FIG. 6 illustrates a database record for a guide.

FIG. 7 illustrates a database record for a user.

FIG. 8 illustrates a database record for a user device.

FIG. 9 illustrates a database record for a user message.

FIG. 10 is a flowchart of creating a user message.

FIG. 11 illustrates a database record for a content provider.

FIG. 12 illustrates an exemplary interface between the search system and content providers.

FIG. 13 illustrates an exemplary interaction with a user.

FIG. 14 illustrates an exemplary message flow in an embodiment.

FIG. 15 is a block diagram of an exemplary system embodiment.

FIG. 16 is a flowchart of a process of creating and editing a database of private information.

FIG. 17 is a flowchart of a process of handling a request.

FIG. 18 is a flowchart of a process of handling a request by a guide.

FIG. 19 is a flowchart of a process of handling a request by a trustee.

FIG. 20 illustrates a database record for a user.

FIG. 21 illustrates a database record for a trustee guide.

FIG. 22 illustrates a database record for a third party or provider.

FIG. 23 illustrates a database record for a user request for private information.

FIG. 24 illustrates a database record for redacted data.

FIG. 25 illustrates a database record for a result including private information.

FIG. 26 illustrates a graphical user interface (GUI) for responding to a request utilizing private information.

FIG. 27 illustrates a GUI for responding to a request utilizing private information.

FIG. 28 illustrates a GUI for responding to a transaction request utilizing private information.

FIG. 29 illustrates a GUI for responding to a request which requires revealing private information.

FIG. 30 illustrates a GUI for responding to a request utilizing revealed redacted information.

FIG. 31 illustrates a communication flow of processing a request by a guide.

FIG. 32 illustrates a communication flow of processing a request by a guide and a trustee.

### DETAILED DESCRIPTION OF THE PREFERRED EMBODIMENTS

Reference will now be made in detail to the present embodiments discussed herein, examples of which are illustrated in the accompanying drawings, wherein like reference numerals refer to the like elements throughout. The embodiments are described below to explain the disclosed system and method by referring to the figures. It will nevertheless be understood that no limitation of the scope is thereby intended, such alterations and further modifications in the illustrated device, and such further applications of the principles as illustrated therein being contemplated as would normally occur to one skilled in the art to which the embodiments relate. As used herein words importing the singular shall include the plural and vice versa unless specifically counter indicated.

A message received from a user by an information processing system may be parsed to determine if a user message includes information which may trigger a response from the system. A number of triggers which may be keywords or message elements associated with a number of system responses or an ‘activity’ object is created. An activity object defines actions which are to be taken responsive to a message including a number of triggers. A number of activity objects may be associated with a user device. Activity object definitions may change a system response to a trigger from a globally defined action associated with the trigger to a response which is specific to a user device, or to other information such as a location, service provider, or other information which is associated with a user.

Content of an activity object may be defined using a standard template or Application Programming Interface (API) which allows a supplier of content to create an activity object definition which may include a user message which may then be provided to a number of users without the need for the supplier to know specific information of a user who is provided with the activity. If a trigger associated with an activity object associated with a user device is duplicated, the conflict may be resolved based on business rules.

A system response to a user message may cause a number of activity objects to be associated with a user device. For example, if a message delivered to a user device includes information which is provided by an advertiser, an activity object associated with the information provided by the advertiser may be associated with the user device which received the message. A guide response which is included in a message delivered to a user device may cause an activity object associated with the guide response to be associated with a user device which received the message. A message associated with an activity object may be included in a message delivered to a user device based on targeting information associated with a user request.

A system is provided whereby a user may submit a search request or request for information or “request” using any device associated with a user. A user may receive a response to the request automatically and/or using the assistance of a human searcher or guide. If a user receives information from a system, an interactive activity which may be used to determine a system response based on user action(s) may be associated with the user and/or a user device. An interactive activity may be defined in various ways. For example, a provider of content such as advertisements, polls, games, or other content, as well as a guide and/or a search system may define a number of user action(s) which may cause a number of response(s) by the search system.

An interactive activity may be associated with a user based on various criteria. For example, a user may be selected to receive a message and/or be associated with an interactive activity based on a characteristic associated with a user and/or a user device such as a location, demographic, service provider, and/or other data of the user, a type of user device, a keyword and/or other information associated with a request or “query” and/or search result or “result”, etc.

A content provider may define an interactive activity which may have various parameters. For example, a content provider may create an interactive activity which may define actions and responses, and/or messages which may vary based on selections made by the content provider and/or a search system. In at least one embodiment, content and/or an interactive activity may be selected based on a number of characters available in a message to be delivered to a user. An advertisement and/or other interactive activity may be selected based on information associated with an advertiser and/or content. For example, a bid price, inventory considerations, availability of content, etc. may be used to determine whether an interactive activity will be associated with a user and/or a user device.

An activity may be associated with various items. For example, if it is desirable to respond to a user action differently in a first location compared to a second location, a different activity may be associated with each location. Likewise, if different user actions are to produce the same response based on location, an activity which includes the appropriate user action and response information may be associated with the different locations as needed. In this way, actions of a user may be interpreted using a layered approach, which may use priority rules. For example, an activity associate with a message delivered to a user might take precedence over an activity associated with a language of the user, which might take precedence over an activity associated with a mobile service provider, etc.

The terms voice and speech are used interchangeably herein. A user, a resource, an advocate, a vendor, and/or a guide may establish a communication session using a voice service, a messaging service such as Short Messaging Service (SMS), Enhanced Messaging Service (EMS), Multi-media Messaging Service (MMS), Instant Messaging (IM), email, an internet portal or web page, a web service, an API, regular mail or any other type of communication. A connection may be established using any device which is capable of utilizing a communication service. For example, a wireless device such as a cell phone, PDA, smart phone, etc., might be used to establish a communication session using voice, SMS, IM, email and/or internet protocols. A desktop, laptop or server system might be used to establish a communication session. A landline phone, a specialized communication terminal, or any other communication device might be used to establish a communication session.

Communication between a guide, a user, a content provider, and/or a search system may include conversion of text to speech and speech to text. Any type of conversion and/or other processing of information which may facilitate communication between a user, a guide, a content provider and/or a search system may be performed. Any type of media which can be sent and/or received using a communication system may be part of a communication session. A communication session may be conducted using any or all communication service associated with a user, a content provider and/or a guide. Any communication session may include communication via multiple service and/or device. For example, a request may be submitted as a voice query, which might indicate an image located on a system accessible to a user and/or a guide, the voice query might be converted to a text message, the image might be processed in order to associate a tag and/or other images with the image, and a response might be provided as a spoken reply to a mobile phone associated with a user, and a video presentation which is accessible via a high-speed connection, which might be delivered to a browser functionality of a user device.

Any type of content may be transmitted including during any or all communication sessions. A guide, a user and/or any type of content may be rated. Rating information may be obtained from a user, a guide, a content provider and/or a search system. Rating information may be used to select a resource, a guide, an advertisement and/or any item based on information associated with an item indicated in a database. A search service may be compensated by advertising revenue. Advertising or content may be delivered to a user, a content provider and/or guide using any service associated with a user, a content provider and/or guide

A “user” is any person or entity which may submit a request or search request. A “request” or “search request” or “query” is any request for information which may be originated by a person and/or a device or system. A user may be referred to as a “requester”, information seeker or InfoSeeker™.

A “guide” is any person who may be compensated and/or may be a volunteer who may respond to and/or assist with a request. An “ambassador” is a guide who may perform processing of a request and/or a search result. A “searcher” is a guide who may perform an information search responsive to a request. A “transcriber” who may also be a guide may convert a spoken portion of a request into text, and/or may otherwise convert information of a request from one form to another. A guide may be referred to as a “human assistant” or “human searcher” or “searcher”. A guide may perform any type of task. Any guide may act in any defined guide role. However, a human assistant who performs a task and a guide who conducts a search may not necessarily be the same. For example, a human assistant may perform a task to facilitate a search which is conducted by another person who is registered as a guide.

An “identifier” or ID may include character, number and/or other type of information which may be used to identify an item including item of a database. Items may include but are not limited to a guide, a user, a resource, an advertisement, a keyword, a category, a search result, a search request, a query, a rating, ranking, a message and/or a profile. A “guided request” is a request which uses the assistance of one or more guides.

A “result” or “search result” or “answer” is any information which may be provided responsive to a request. A result includes, but is not limited to, any of an advertisement, a link to a web page, a message of any sort, image, audio, text, games, interactive media and/or software of any sort.

A “search resource” or “resource” is any source of information which may be used to obtain a search result. A search resource includes automated and/or human-assisted systems, any repository of information, and any type of media and/or systems which may provide information. A resource may be a provider or source of item and/or service. For example, a resource might provide an item such as a ring tone, a media file (e.g., audio, video, images, games, etc.), information such as news, lyrics, song titles, translations or any other type of information. A resource may be automated, and/or may utilize the assistance of a person.

A “profile” is one or more characteristics which may be associated with a person. Profile characteristics include but are not limited to demographic, geographic, personality, affiliations, areas of interest, historical actions, preferences, memberships, associations, etc.

An “advertisement” is any information which may be delivered to a user including to promote a provider, a product, a service, etc. An advertisement may include text, links, audio, video, images, printed materials, interactive media such as a game, or other forms of media which may be provided to a user device.

A “category” or “taxonomy branch” or “categorization” is a unique node within an index which may be associated with any number of items. If a request is associated with a category, items associated with the category may be more likely to be selected responsive to the request.

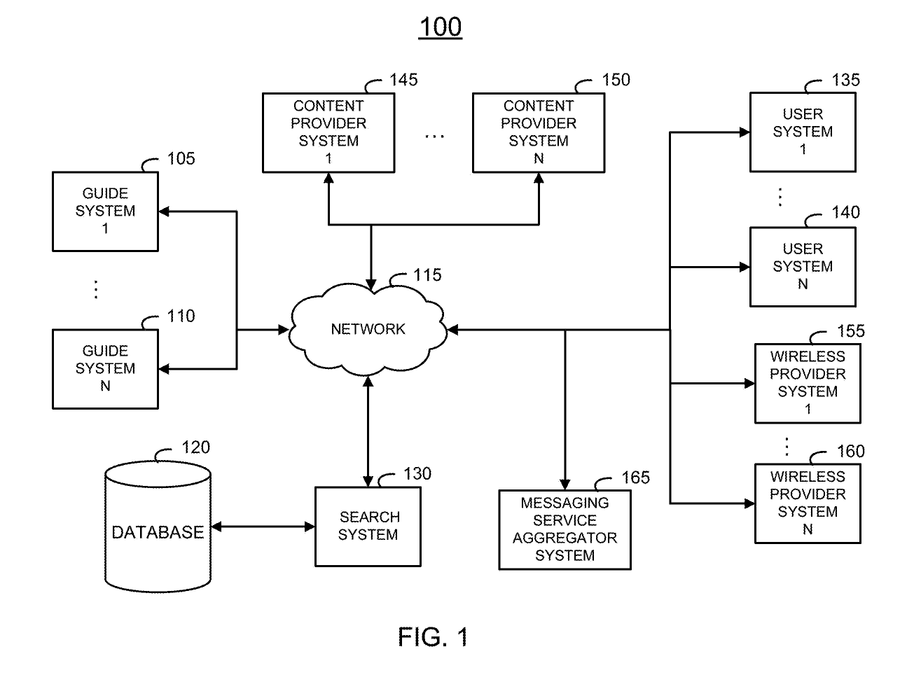

As illustrated in FIG. 1, system 100 includes guide systems 105, 110, a network 115 such as the Internet, a search system 130, user systems 135, 140, a database 120, which may comprise various records, wireless provider systems 155, 160 content provider systems 145, 150, and a messaging aggregator system 165.

While only a limited number of systems associated with a guide, content provider (also referred to as an advertiser or sponsor), user, a wireless provider (also referred to as a carrier or wireless carrier), an aggregator and as a search system are depicted in FIG. 1, it is within the scope of the disclosure for multiple systems for guide, content provider, user, carrier, aggregator and search systems to be utilized. Further, any or all of the systems may be integrated and provided as a single system. For example, a resource system may be incorporated with that of the search system.

Any user system (e.g., the user systems 135, 140) can be operated by an information seeker, who may be any person, to submit a search request to the search system 130 and/or receive a search result and/or other information. Any guide system (e.g., the guide systems 105, 110) can be operated by a human searcher to obtain a search result responsive to a request which may have been submitted by an information seeker located at a user system (e.g., the user systems 135, 140). Any content provider system (e.g., the content provider systems 145, 150) may be operated by a human provider of information and/or may be an automated system which may provide content to the search system 130, such as advertisements, games, promotional information, or other types of information. A wireless provider system such as the wireless provider systems 155, 160 may provide wireless access to any devices associated with the system 100. For example, a wireless carrier may provide voice, messaging and/or data services to mobile devices, which networks may comprise elements of the network 115. The messaging services aggregator system 165 may provide distribution services between the wireless provider systems and other elements of the system such as user systems, guide systems, the search system, etc. in order that messages are correctly routed between the various networks which may be elements of the network 115. For example, a messaging aggregator may receive messages from users associated with various wireless carriers and route the messages to the search system 130, and may receive messages from the search system and route the messages to various wireless carriers as needed to deliver the messages to users. Communication among elements of the system 100 is not limited to any particular type and may include any one of known techniques of transferring information including wireless and wired communication.

The network 115 (FIG. 1) may be a global public network of networks (the Internet) and/or may consist in whole or in part of one or more private networks and communicatively couples the guide systems 105, 100, the content provider systems 145, 150, the wireless provider systems 155, 160, the messaging aggregator system 165 and the user systems 135, 140 with the other components of the system such as the search system 130, and the database 120.

The search system 130 allows interaction to occur among the guide systems 105, 110, the content provider systems 145, 150, the wireless provider systems, 155, 160, the messaging aggregator system 165 and the user systems 135, 140. For example, an information search query in the form of an SMS message can be transmitted from the user system 135 to the wireless provider system 155, which may then be transmitted to the aggregator system 165 and may be transmitted to the search system 130, which may provide information of the request to the guide system 105. The guide system 105 may transmit a message to the search system 130, which may obtain information from the database 120 and the content provider system 145, which may be incorporated into a message which is delivered to the messaging service aggregator system 165, which may deliver a message to the wireless provider system 155, which may transmit an SMS message to the user system 135. While the specific example of routing an SMS message to and from a user system has been used for the purposes of illustration, other types of communications may be exchanged as permitted by the capabilities of the devices associated with the network 115. For example a spoken query might be received via a voice service, or a query might be transmitted by TCPIP or other internet protocols, etc. and a response might be delivered using any communication capabilities of the devices associated with the system 100. Multiple types of communication services may be employed in any communication sessions.

The search system 130 is communicatively coupled with the database 120. As will be described herein in further detail below, the database 120 includes data that is processed in association with operation of the embodiments. Although FIG. 1 illustrates the database 120 as a separate component of the system, the database 120 may be integrated with the search system 130. Further, the records maintained in the database 120 may be stored in any typical manner, including in a Network Attached Storage (NAS), a Storage Area Network (SAN), etc. using any typical or proprietary database software such as DB2®, Informix®, Microsoft® SQLServer™, MySQL®, Oracle®, etc., and may also be a distributed database on more than one server. Elements of the database 120 may reside in any suitable elements of the system 100 as such any or all elements of the system 100 may include any or all of the database 120.

The user systems 135,140, the guide systems 105,110, the search system 130 the content provider systems 145, 150 and the wireless provider systems 155, 160, and the messaging service aggregator system 165 may include equipment, software, systems and personnel required to send and/or receive messages between a user system, a guide system, a content provider system, an aggregator system, a carrier system and/or the search system using the network 115. The database 120 includes information which may allow the search system 130 to establish communication between any or all of the elements of the system 100.

A user system, a guide system, a content provider system, a wireless carrier system, and/or a messaging service aggregator system may be a desktop or laptop PC or Mac®, a mobile phone, a smart phone, a PDA, a server system, a landline phone, a specialized communication terminal, a terminal connected to a mainframe, or any other communication device and/or system. The search system 130 may include one or more servers, computers, etc. For example, servers such as the PowerEdge® 2900 by Dell, or the BladeCenterJS22 by IBM, or equivalent systems might be used to implement elements of the search system 130. The search system 130 may utilize an operating system (OS) such as Microsoft Windows XP, or Linux, etc. Voice routing and packet switching may be accomplished using well established technologies such as those provided by Cisco®, or other networking companies. After being presented with the disclosure herein, one of ordinary skill in the relevant art will immediately realize that any viable computer system or communication device known in the art may be used as user systems, guide systems, content provider systems, wireless provider systems, messaging service aggregator systems, and/or to implement the search system 130.

A guide may be required to register with the search system 130. As part of a registration process, at least one communication method is associated with a guide. In at least one embodiment, a guide may register with the search system 130 and establish a username and password which are associated with the guide. A guide may login to the search system 130 using a web browser functionality of the guide system 105 in order to communicate with the search system 130. Multiple communication services may be associated with a guide and may allow a communication session to be established between a guide system such as the guide system 105 and a user system and/or the search system 130. Multiple identifiers of a guide may be associated with each other. Information such as IM credentials, an email address, a phone number, a URL, a username, etc. of a guide may be identified which may allow the search system 130 to establish a communication session between a guide system and a user system and/or the search system 130.

When a guide registers with the search system 130 the guide may be associated with one or more keywords, categories, and/or other information. For example a keyword or category may be selected by a guide, or may be associated with a guide based on a test administered to a guide and/or other information provided during and/or after a registration process. A profile of a guide may be created which includes demographic, personality, geographic and/or other information of a guide. Information associated with a guide may be stored in the database 120 and may be used for purposes such as matching a guide to a request, determining and/or providing compensation for a guide, communicating with a guide, etc. as will be described further herein below. A guide may be associated with a number of content providers. Registration and/or other information of a guide may be provided by a content provider.

A user may be identified by the search system 130. When a user system such as the user system 135 establishes a communication session with the search system 130, an identifier of a user system is determined. An identifier of a user system may be associated with other information regarding a user. A user system may be identified using an email address, a telephone number, an IM credential, a username, a ‘cookie’ or any other identifier which may be used to associate information with a user. Multiple identifiers of a user may be associated with each other. Using information of communication services associated with a user, a communication session may be established between a user system such as the user system 135 and a guide system, a content provider system and/or the search system 130. Information such as a keyword, a category, a user profile, a previous search request, a search result, etc. may be associated with a user. Information of a user may be stored in the database 120. In at least one embodiment, a user system is characterized based on items such as a wireless carrier, an aggregator, or other information associated with the user device as further described herein below.

A content provider, which may be a person, an entity, a search engine, a database, a software application, a corpus of one or more types of media such as text or printed information, images, audio, video, etc. or a combination thereof, may be identified by the search system 130. Any source of information may be a content provider within the context of the disclosure herein. Information of at least one method of communication is associated with a content provider system which may allow a communication session to be established between the search system 130, a user system 135 and/or a guide system 105 and a content provider system such as the content provider systems 145, 150. An identifier of a content provider system may be associated with other information regarding a content provider. A content provider system may be identified using an email address, a telephone number, an IM credential, a resource username, a URL or other persistent identifier which may be used to associate information with a content provider. Multiple identifiers of a content provider may be associated with each other. Using the information of communication services associated with a content provider, a communication session may be established between a content provider system such as the content provider system 145 and a user system, a guide system, a wireless provider system, a messaging service aggregator system and/or the search system 130. Information such as a keyword, a category, a profile, or other information may be associated with a content provider, which may be used to match content with a guide, a user, a request, etc. In at least one embodiment, a content provider is registered with the search system 130 and may provide compensation to the search system provider based on usage information associated with content delivered to a user. Information of a content provider may be stored in the database 120 and may be used for purposes such as matching content to a request, a user, a guide, etc., determining and/or providing compensation associated with a content provider, communicating with a content provider, etc. as will be described further herein below.

The search system 130 may establish a communication session between any user system, guide system, content provider system, aggregator system, and/or carrier system using information indicated in the database 120. For example, the user system 135 may establish a voice communication session with the search system 130, the search system 130 may establish a voice communication session between the user system 135 and the guide system 105, and the search system 130 may establish a voice communication session between the user system 135 and the content provider system 145. While a voice communication session is used in this example, any type of communication session using one or more services such as SMS, EMS, MMS, email, IM, chat, web based communication, etc. may be established between any user system, guide system, and/or content provider system and/or the search system 130.

Information associated with a user, a guide and/or a content provider may be obtained in various ways. For example, a registration process may be performed using a web form provided by the search system 130, and/or information may be obtained from an external database, and/or information may be obtained based on analysis of information indicated by a user, a guide, and/or a content provider. A ‘profile’ is one or more characteristics which may be associated with one or more individuals. A profile may include geographic data such as a street address, latitude and longitude, etc., may include demographic information such as age, gender, race, income, family size, political affiliations, etc., may include personality information such as results of psychometric testing, subjective evaluations of an individual, etc., may include affiliation information such as employment, club, activity, societal membership information, information of a device, service, transaction and/or any information which might be associated with a user, a guide and/or a content provider.

An “activity” or “trigger activity” as used herein is an object which may be associated with a user and/or a user device. As is known in the art, an object is characterized by identity (i.e., it is distinct), state (i.e., the data that is associated with the object) and behavior (i.e., the methods associated with the object). As will be further described herein, a container or object which can contain other objects such as an activity may be associated with a user device.

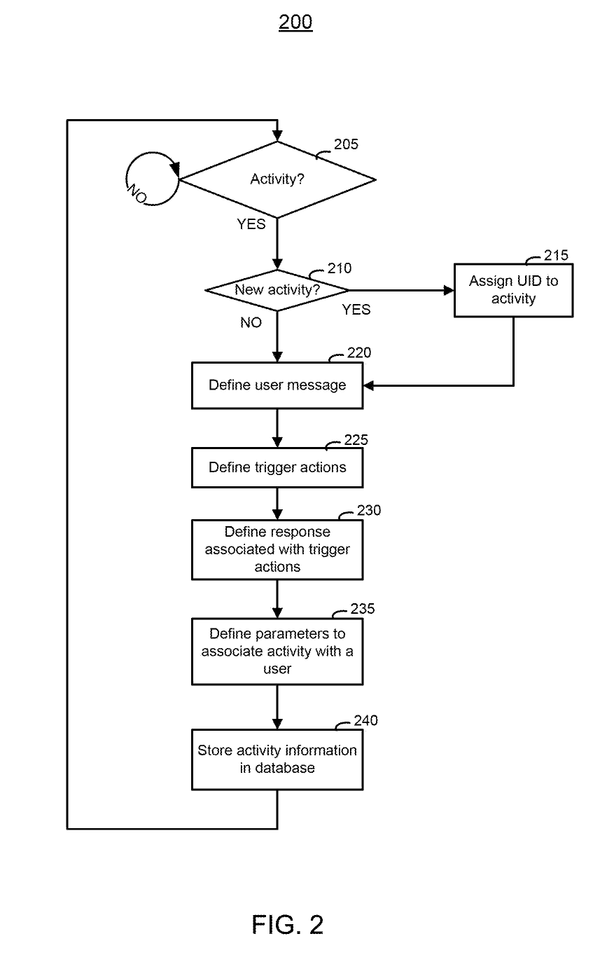

As illustrated in FIG. 2, a process 200 for creating and editing an activity or trigger activity is provided. The process 200 may be operative on any or all elements of the system 100 (FIG. 1).

In operation 205, a determination is made as to whether an activity is to be created or edited. For example, a message may be received at a URL associated with the search system 130 from a content provider system, which may indicate that a content provider intends to edit and/or create an activity. If it is determined in operation 205 that an activity is not to be created or edited control remains at operation 205 and process 200 continues. If it is determined in operation 205 that an activity is to be created or edited, control is passed to operation 210 and process 200 continues.

In operation 210, a determination is made as to whether a new activity is to be created. If it is determined in operation 210 (FIG. 2) that a new activity is to be created, control is passed to operation 215 and process 200 continues. If it is determined in operation 210 that a new activity is not to be created control is passed to operation 220 and process 200 continues.

The determination in operation 210 may be made based on any suitable criteria. For example, content provider may indicate that a new activity is to be created using a GUI provided on a content provider system, or a content provider may elect to edit an existing activity using a message delivered to the search system 130 (FIG. 1), etc.

In operation 215, a unique identifier (UID) is assigned to an activity which is to be created. A UID may be used to store and retrieve information associated with an activity. An identifier of a content provider associated with an activity may be associated with the activity. Association of a content provider with an activity may be used to track information such as compensation associated with an activity. Control is passed to operation 220 and process 200 continues.

In operation 220, a user message associated with an activity is defined. A message associated with an activity may be modified based on information provided by a content provider. A user message may include information which describes one or more user actions or triggers which may be associated with an activity. In at least one embodiment, a content provider may elect to allow the search system 130 to determine any or all elements of a user message associated with an activity. Control is passed to operation 225 and process 200 continues.

In operation 225, a trigger action or “trigger event” associated with an activity is defined. In at least one embodiment, a trigger action may not be associated with a response, in which case the user message is simply a message without an associated action. Such an action may be part of an activity which may serve as a place holder which may allow an activity to be edited rather than being created. A trigger action may include any type of action. In at least one embodiment, a trigger action may be a keyword which is to be received in a message. Control is passed to operation 230 and process 200 continues.

In operation 230, a response or “trigger response” associated with a trigger action is defined. A response may include a number of actions which may occur when a trigger action is detected. A response associated with a trigger action may include actions such as a GET, POST, etc. request which may obtain information to be delivered to a user, or cause an action to occur, association of an activity with a user, or any other action which may be performed by the search system 130 (FIG. 1) responsive to a trigger action. Control is passed to operation 235 and process 200 continues.

In operation 235, information which may be used to associate an activity with a user is defined. A content provider may request that an activity is to be associated with a user based on various types of information. For example, a content provider may designate a category, a keyword, a location, an aggregator, a carrier, a total number of impressions in a time period, or any other information which may be indicated in the database 120 which may be used to associate an activity with a user. Control is passed to operation 240 and process 200 continues.

In operation 240 information of an activity is stored. In at least one embodiment, information of an activity is stored in the database 120 (FIG. 1). Any information defined and/or modified regarding an activity based on the information obtained in the process 200 may be recorded. Control is passed to operation 205 and process 200 continues.

An activity may be associated with a message based on various characteristics of the message. When a message arrives at the search system 130 (FIG. 1), various information in relation to the message may be known. For example, a phone number and/or short-code which received a message, or the aggregator who received the message, or the wireless carrier from which the message originated may be known without examining the content of the message. In such an instance, an activity may be associated with a receiving number, an aggregator, or a wireless carrier, which may provide the ability to provide a different system response based on such factors. For example, if a short-code, an aggregator and/or a carrier is related to a language or region, the system might detect different keywords for a given functionality. A set of triggers based on a language might be determined using information of a carrier, or short code or aggregator associated with a message.

Using a different example, short-codes and/or other receiving numbers might be associated with different types of services. For example, a short code (e.g., short code A) might be associated with a first search service while a different short code (e.g., short code B) might be associated with a second search service. In such a case, the functionality of common triggers might be different. Continuing with the example, if short code A is associated with a music service and short code B is associated with a library service, the keyword ‘Help’ might produce a message which includes the name of the music service when received from short code A, or the name of the library service when received from short code B, or a system message might be returned if the message is received from a short code which is not associated with an activity, or which is associated with an activity at the system level.

Using this feature various priority levels might be established. For example, an activity associated with a short code, aggregator, wireless provider, etc. might take a higher or lower priority than an activity associated with other item such as the system or a user device.

An activity may be edited and/or modified at any time. This may allow the functionality of an activity to be modified based on system conditions, activity of content providers and/or other actions which may modify a trigger and/or action associated with an activity. Using the example above, short code A might be associated with activities defined by a first content provider (e.g., content provider 1) during one time period, and then associated with activities defined by a second content provider (content provider N) during a different time period. In this way, it is not necessary for an activity to be explicitly defined each time a modification to the functionality of the system 100 is desired. An activity associated with any item allowed by the search system 130 (FIG. 1) may be created which allows a trigger to be mapped to a system response without changing the underlying functionality of the system 100.

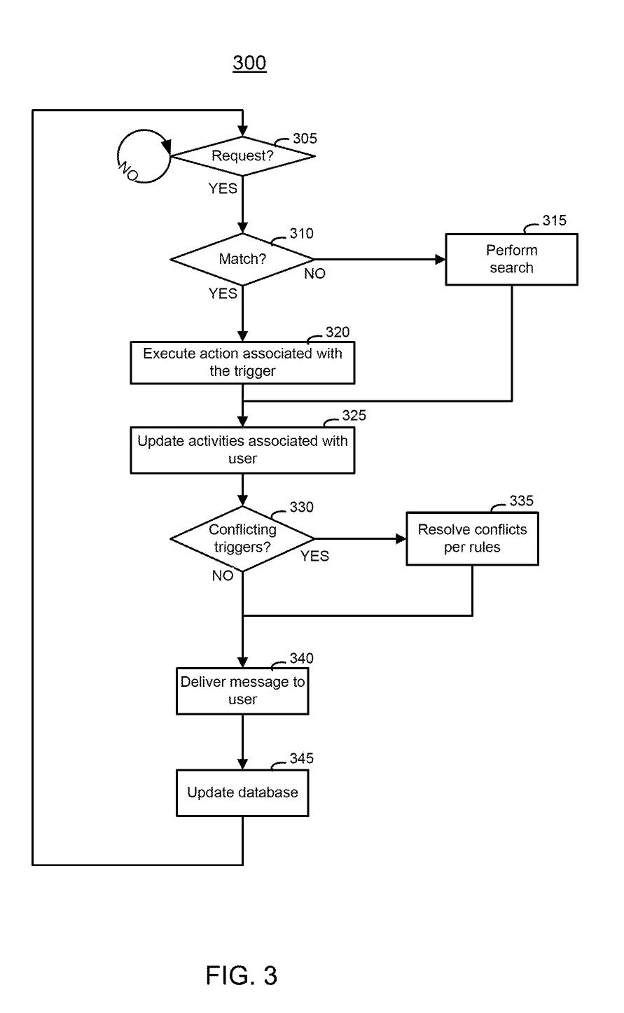

As illustrated in FIG. 3, a process 300 for responding to a request is provided. The process 300 may be operative on, for example, the search system 130 (FIG. 1).

In operation 305, a determination is made as to whether a request is received. For example, if a search query is submitted via voice, or SMS to a server, or an email is received at an email address, or if an Instant Message is received at a IM service account associated with the search system 130 (FIG. 1) or based on other suitable criteria it may be determined that a request has been received. If it is determined in operation 305 that a request is not received control remains at operation 305 and process 300 continues. If it is determined in operation 305 that a request is received, control is passed to operation 310 and process 300 continues.

In operation 310, a determination is made as to whether a search request matches any trigger event which is associated with the request. If it is determined in operation 310 that a search request matches a trigger event which is associated with the request control is passed to operation 320 and process 300 continues. If it is determined in operation 310 that search request does not match a trigger event which is associated with the request, control is passed to operation 315 and process 300 continues.

The determination in operation 310 may be made based on any suitable criteria. For example, a message associated with a request may be parsed to determine whether the message includes one or more keywords which may match a trigger event associated with an activity, or a transcribed voice message may be compared to a trigger event of an activity associated with a device which originated a voice message, or a URL received from a browser functionality of a user device may be compared to trigger event associated with the device, etc. Likewise, an activity and the associated trigger event may be associated with information indicated in a message. For example, a short code, an aggregator, a phone number, a wireless carrier, an area code, etc. may be associated with an activity. If a message indicates that the message originated from a short code, etc. associated with an activity, the trigger events associated with the activity may be compared to content of the message to determine if a search request matches a trigger event. This may allow a differentiated response by the system based on indirect and/or direct parameters of a message as described further herein.

In operation 315, a search is performed responsive to the request received in operation 305. For example, a human assisted search may be performed which may provide a search result to a user device, and/or an automated search may be performed responsive to a request message, etc. Control is passed to operation 325 and process 300 continues.

In operation 320, a response associated with a trigger event is executed. For example, a message which is to be provided to a user may be obtained and/or information may be obtained from a content provider and/or information may be provided to a provider of content and/or other item, etc. Any action and/or sequence of actions may be initiated responsive to a trigger event. For example, communication may be established between a user system and an information provider system, or a message may be sent from a first user system to a second user system, etc. Control is passed to operation 325 and process 300 continues.

In operation 325, activities associated with a user and/or a user device are updated. For example, an activity which has reached an expiration condition such as a time period or a total number of messages delivered to a device may be deleted, or an activity which has been modified based on a trigger action may be updated, or an activity which has been associated with a device due to a search result obtained in the search performed in operation 315 may be associated and/or disassociated with a user device. Any or all activities associated with a user may be modified, and/or deleted. Likewise, an activity associated with an aggregator, a short code, a carrier, etc. may be modified. For example, if an activity is associated with a short code, if a number of trigger events associated with the activity exceeds a pre-determined value, the activity may be modified. Continuing with the example, if an activity such as an advertisement which includes a response keyword is associated with a short code, if a number of responses exceed a predetermined value, the activity may no longer be associated with the short code. Control is passed to operation 330 and process 300 continues.

In operation 330, a determination is made as to whether a conflict exists between trigger events associated with a user device. For example, if a new trigger action which is to be associated with a user device would be identical to a trigger action currently associated with the user device a conflict of trigger actions exists. If it is determined in operation 330 that a conflict exists between trigger actions associated with a user device control is passed to operation 335 and process 300 continues. If it is determined in operation 330 that a conflict does not exist between trigger actions associated with a user device, control is passed to operation 340 and process 300 continues.

In operation 335 conflicts between trigger actions associated with a user device are resolved. For example, a content provider associated with an activity which has conflicting trigger actions may be requested to provide an alternate activity to be associated with a user device, or a different activity associated with the content provider may be selected by the search system 130 (FIG. 1), or an activity associated with a trigger action conflict which has lower priority may be canceled, or if an activity allows substitution of a trigger action defined for an activity with a system-selected trigger action, the search system 130 may select a trigger action which meet the requirements determined by the content provider while resolving the conflict between trigger actions. In at least one embodiment, an activity which was most recently associated with a user device will take precedence over an activity which was previously associated with the user device. For example, if the trigger action of the keyword ‘b1’ being the first element of a message is associated with more than one activity which is associated with a user device, the older activities may be cancelled and the new activity may be associated with the user device. Any suitable set of rules may be implemented to allow conflicts between trigger actions to be resolved. Activities associated with a user may be modified and/or deleted based on resolution of conflicts. Any suitable set of business rules may be applied to resolve conflicts. Control is passed to operation 340 and process 300 continues.

In operation 340, a number of messages associated with an activity are delivered to a user. For example, a message which describes new trigger actions associated with a user device may be delivered to the user device. In at least one embodiment a text message describing trigger actions and/or responses to the trigger actions may be transmitted to a user device. In at least one embodiment, a voice message describing a trigger action may be transmitted to a user device. Control is passed to operation 345 and process 300 continues.

In operation 345, information of the process 300 is recorded. For example, information of a number of activities associated with a user device, information regarding a search result provided to a user device, information of a request, a guide, information of a substitution and/or cancellation of any activity, information of a trigger action, information regarding a response to a trigger action, etc. may be recorded in the database 120. Control is passed to operation 305 and process 300 continues.

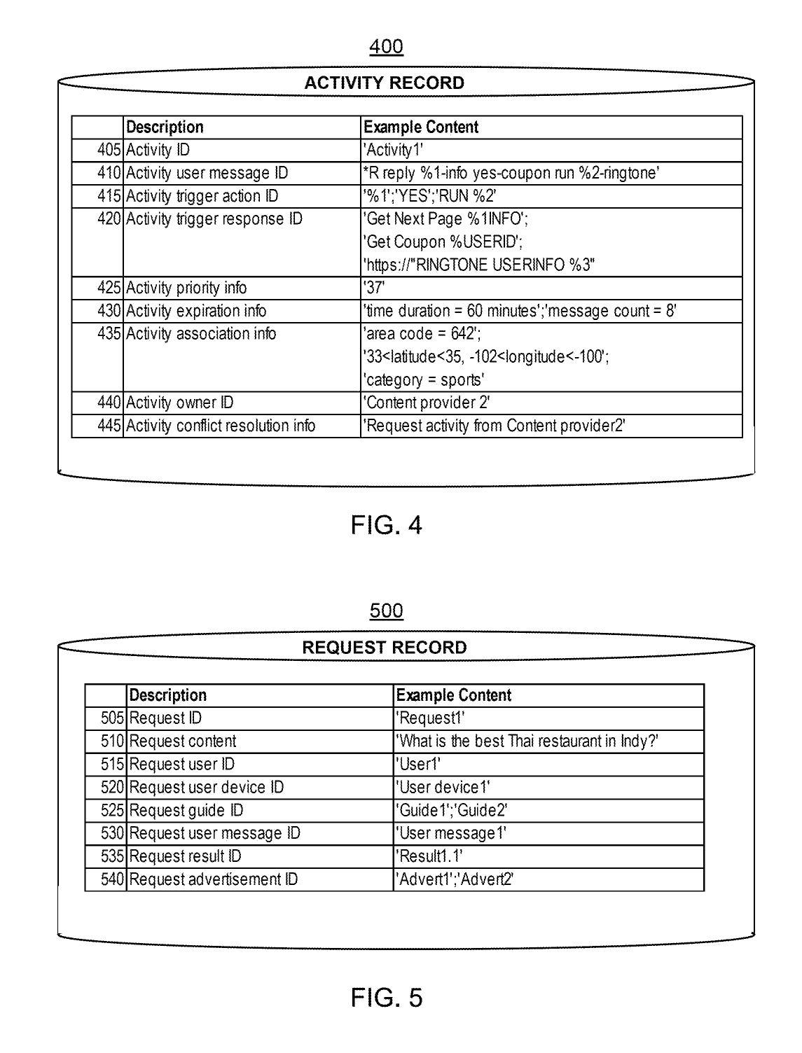

As illustrated in FIG. 4, an exemplary activity record 400 is provided, of which one or more may be associated with or resident in the database 120 (FIG. 1). The activity record 400 may include an activity ID field 405, an activity user message ID field 410, an activity trigger action ID field 415, an activity trigger response ID field 420, an activity priority info field 425, an activity expiration info field 430, an activity association info field 435, an activity owner ID field 440 and an activity conflict resolution info field 445.

An activity record may be created in various ways, including actions by a content provider, actions by a guide, actions by the search system 130 (FIG. 1), etc.

The activity ID field 405 preferably contains a unique identifier of an activity, which is preferably used consistently. For example, in at least one embodiment, the activity ID field 405 can include a randomly generated numerical code, and/or a text string indicating the content of an activity. An activity ID serves to distinguish the activity record associated with an activity from an activity record associated with other activities. Other unique identifiers of an activity may be utilized without departing from the spirit and scope of the embodiments. A unique identifier may be assigned to an activity when it is entered into the database 120 (FIG. 1). As illustrated in FIG. 4, ‘Activity1’ is the activity ID associated with the activity record 400 (FIG. 4).

The activity user message ID field 410 includes information of a message which is to be delivered to a user device when an activity is associated with the user device. The activity user message ID field 410 may include any type of information which may be used to construct a message to be delivered to a user device. In at least one embodiment, the content of the activity user message ID field 410 may be used to determine the total number of characters in an SMS message which is to be delivered to a user device. A variable expression or ‘wildcard’ may be included in the activity user message ID field 410 which may allow substitution of any available character in the formation of a message to be delivered to a user device. Using the example illustrated in FIG. 4, the message ‘*R reply %1-info yes—coupon run %2-ringtone’ is the activity user message associated with the activity ‘Activity1’. This may indicate content of a message to be delivered to a user device when the activity ‘Activity1’ is associated with the user device. For example, ‘%1’ may be a variable expression which may determined by the search system 130 to resolve a trigger conflict as described with respect to operation 335 (FIG. 3).

In at least one embodiment, a message may include multiple wild cards which may be required to be associated with each other. For example, a group of trigger actions might be required to have related triggers such a ‘A’, ‘B’, ‘C’ or ‘3’, ‘4’, ‘5’, but the values may be arbitrary so long as they are consecutive. Elements of the user message may be explicitly defined such as the words ‘reply’ or ‘yes—coupon’ or ‘-ringtone’. For example, the user message associated with ‘Activity1’ might be rendered as ‘*R reply A-info, yes-coupon, run3—ringtone’ if there is no conflict with the keywords ‘A’ and ‘3’, but might alternately be rendered as ‘*R reply C-info, yes-coupon, run5—ringtone’ in the case of a conflict with the keywords ‘A’ and ‘3’ from other activities. In at least one embodiment, content of the activity user message ID field may indicate that no user message is associated with an activity. For example, an activity which is associated with a carrier, a location, a language, etc. may be associated with a user even if no message is delivered to the user responsive to the association of a user with an activity.

The activity trigger action ID field 415 includes information regarding trigger actions associated with an activity. For example, information of a keyword which may be included in a message from a user which is used as a trigger action may be explicitly defined in the activity trigger action field 415, or information of a ‘wild card’ or variable expression which might be substituted to define a trigger action might be indicated, or a combination of a ‘wild card’ and an explicit definition which defines a trigger action may be indicated in the activity trigger action ID field 420. Using the example illustrated in FIG. 4, the trigger actions ‘%1’, ‘YES’, and ‘RUN%2’ are the trigger actions associated with the activity ‘Activity1’. In at least one embodiment, the activity trigger action ID field 415 and the activity user message ID field 410 may be linked by for example a pointer.

The activity trigger response ID field 420 includes information of an action which may be taken responsive to an activity trigger action. In at least one embodiment, the activity trigger action ID field 415 and the activity trigger response ID field 420 may be linked by for example a pointer. The activity trigger response ID field 420 may indicate any type of action which may be taken responsive to a trigger action. For example, a GET request may be sent to a URL associated with a content provider, or information indicated in the database 120 (FIG. 1) may be obtained, or a message may be delivered to a server which may cause a WAP push to a browser functionality of a user device to occur, or an activity associated with a user device may be modified and/or disassociated with a user device, etc. Any number of responses may be associated with a trigger action. Using the example illustrated in FIG. 4, the response ‘Get next page %1INFO’, ‘Get Coupon % UserID’ and ‘https://RINGTONE USERINFO %3’ are associated with the activity ‘Activity1’. This may indicate that the response ‘Get next page %1INFO’ may be executed if the trigger action ‘%1’ is detected, that the response ‘Get Coupon % UserID’ may be executed if the trigger action ‘YES’ is detected and that the response ‘https://RINGTONE USERINFO %3’ may be executed if the trigger action ‘RUN%2’ is detected. In at least one embodiment, a response to a trigger action may be selected and/or modified based on commercial considerations. For example, an advertiser may compensate a provider of the search system 130 (FIG. 1) in order to be associated with a trigger action.

The activity priority info field 425 may include information regarding a priority which is associated with an activity. For example, a higher priority may cause a trigger action associated with an activity to supersede a conflicting trigger action associated with a lower priority activity. Such information may be used to resolve conflicts between trigger actions. Activity priority information may be determined by the search system 130 (FIG. 1), may be associated with activity association information indicated in the activity association info field 435, and/or may be based at least in part on information indicated in the database 120. Using the example illustrated in FIG. 4, the priority ‘37’ is associated with the activity ‘Activity1’.

The activity expiration info field 430 may include information which may be used to determine whether an activity remains associated with a user device or other object. For example, a time period may be specified after which an activity is no longer associated with a user device, or a number of messages which have been delivered to a user device may be specified to determine whether an activity is associated with a user device, or a time of day or date or location, etc. may be specified to determine whether an activity is to be associated with a user device. Using the example illustrated in FIG. 4, the conditions ‘time duration=60 minutes’ and ‘message count=8’ are associated with the activity ‘Activity 1’. This may indicate that if the activity ‘Activity1’ has been associated with a user device for more than 60 minutes, or if the user device has received more than 8 messages from the search system 130 (FIG. 1), the activity may be disassociated with the user device or other object.

The activity association info field 435 may include information of how an activity may be associated with a user device. For example, a carrier, an aggregator, an area code, a location, a category, a device capability, or other information associated with a user device may be used at least in part to determine whether an activity is to be associated with a user device. Using the example illustrated in FIG. 4, an area code, a location and a category have been associated with the activity ‘Activity1’. This may indicate that users in the area code 642, users with latitude between 33 and 35 and longitude between −102 and −100, and/or users submitting queries associated with the category ‘Sports’ may be associated with the activity ‘Activity1’. Content of the activity association info field 435 may be determined at least in part based on information provided by a content provider.

The activity owner ID field 440 may include information of a content provider associated with an activity. Content of the activity owner ID field may be used for purposes such as determining compensation information associated with a content provider, access to an activity, etc. For example, a number of times that an activity is associated with a user device and/or a number of times that a trigger action associated with an activity is detected may be used to determine compensation for a provider of the search system 130 (FIG. 1) and/or a guide, etc.

The activity conflict resolution info field 445 may include information which may be used to resolve conflicts between a trigger action associated with an activity and a trigger action associated with another activity which is associated with a user device. For example if an activity has been selected to be associated with a user device, but there is a conflict with an activity already associated with the user device, a message may be transmitted to a content provider system to request a different activity which may be suitable. Alternately, an activity might be selected from other activities associated with a content provider. Any suitable set of rules might be indicated in the activity conflict resolution info field 445.

As illustrated in FIG. 5, an exemplary request record 500 is provided, of which one or more may be associated with or resident in the database 120 (FIG. 1). The request record 500 may include a request ID field 505, a request content field 510, a request user ID field 515, a request user device ID field 520, a request guide ID field 525, a request user message ID field 530, a request result ID field 535, and a request advertisement ID field 540.

A request record may be created by various processes. In at least one embodiment, a request record is created when a search request is received by the search system from a user device.

The request ID field 505 preferably contains a unique identifier of a request, which is preferably used consistently. For example, in at least one embodiment, the request ID field 505 can include a randomly generated numerical code, and/or a text string indicating the content of a query. A request ID serves to distinguish the request record associated with a request from a request record associated with other requests. Other unique identifiers of a search request may be utilized without departing from the spirit and scope of the embodiments. A unique identifier is assigned to a request when it is entered into the database 120. Using the example in FIG. 5, ‘Request1’ is the request ID associated with the request record 500.

The request content field 510 may include information regarding content of a request. For example, text associated with a query submitted by a user may be indicated in the request content field 510. Such information may be processed in order to associate a keyword, category and/or other information with a request. In at least one embodiment, a structured query which conforms to a specific context may be indicated in the request content field 510. For example, a user and/or a guide may select a structured query which is associated with a request, or a structured query may be associated with a request automatically. A succinct query may be used to assist in indexing stored responses to a request. Information such as audio recordings, images, etc. which are associated with a search request may be indicated in the request content field 510. A request may include information that is not explicitly entered by a user. For example, location information, profile information, user device information etc. may be associated with a search query or request and may be indicated in the request content field 510. Using the example illustrated in FIG. 5, the query ‘What is the best That restaurant in Indy?’ is the query content associated with ‘Request1’.

The request user ID field 515 may include information of a user that submitted a query to the search system 130 (FIG. 1). The request user ID field 515 (FIG. 5) may be used to associate a user with a query. Information indicated in the request user ID field 515 may be used to obtain information of a user using a record such as the user record 700 illustrated in FIG. 7. Using the example illustrated in FIG. 5, ‘User1’ is associated with the request ‘Request1’.

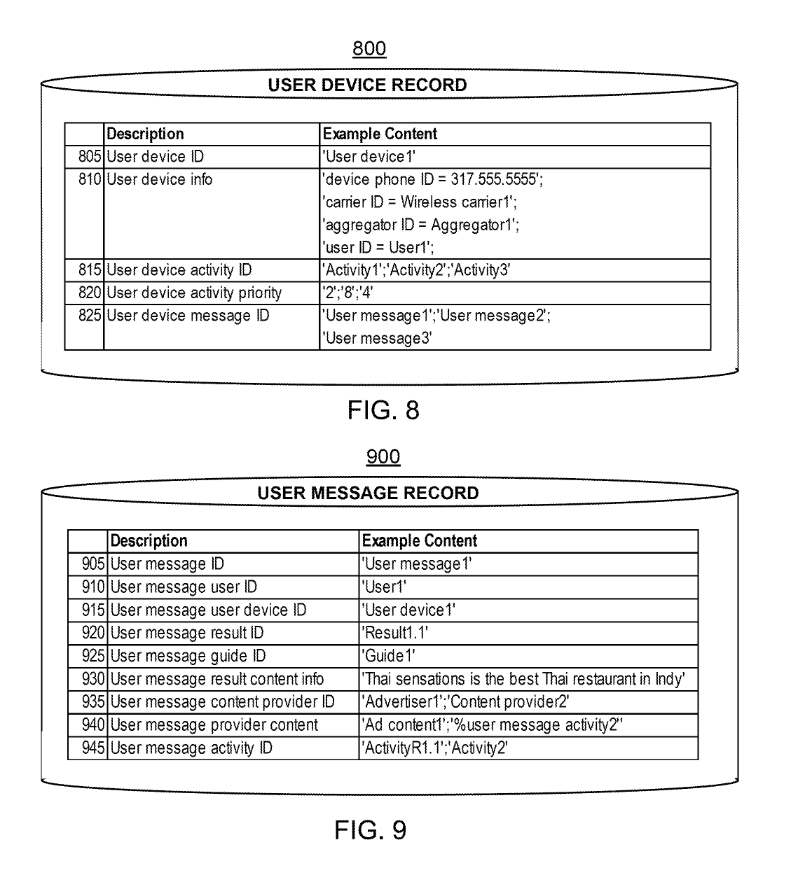

The request user device ID field 520 may include information of a user device associated with a request. Information indicated in the request user device ID field 520 may be used to obtain information of a user device using a record such as the user device record 800 illustrated in FIG. 8. Using the example illustrated in FIG. 5 the user device ‘User device1’ is associated with the request ‘Request1’.

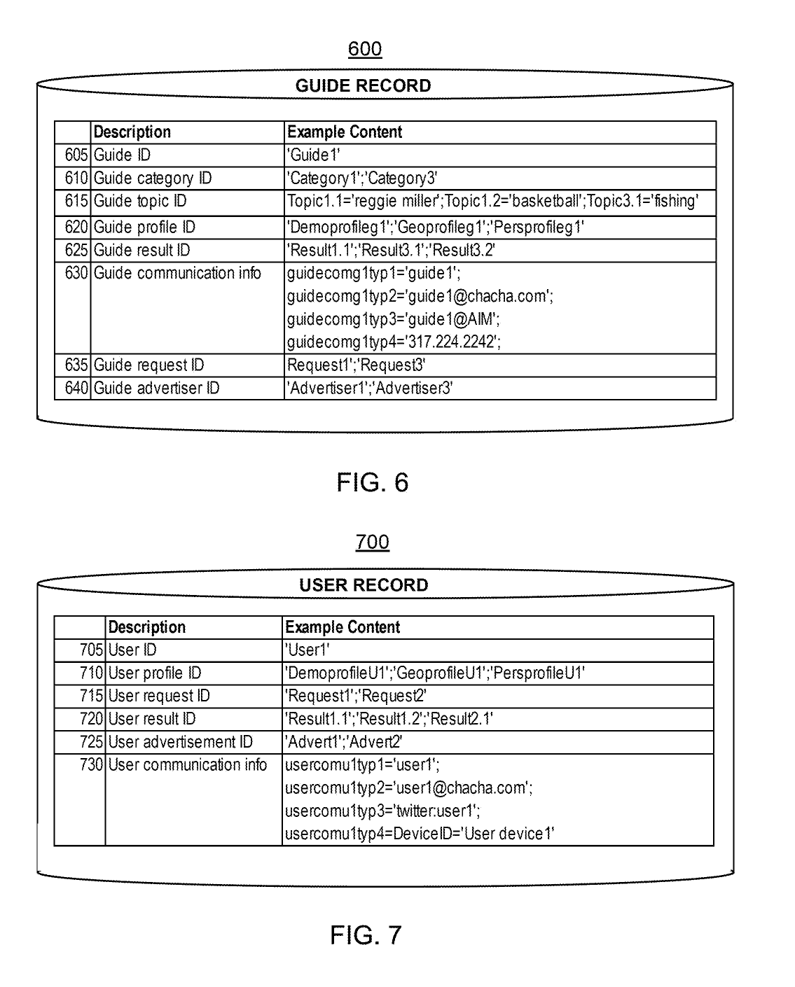

The request guide ID field 525 may include information of a guide associated with a search request. For example, if a guide obtains a search result which is presented responsive to ‘Request1’, an identifier of the guide may be indicated in the request guide ID field 525. Likewise, if a guide was selected to respond to a search request, an identifier of the guide may be indicated in the request guide ID field 525. Information indicated in the request guide ID field 525 may be used to obtain information associated with a guide using a record such as the guide record 600 illustrated in FIG. 6. Using the example illustrated in FIG. 5 ‘Guide1’ and ‘Guide2’ are associated with the request ‘Request1’, which may indicate that ‘Guide1’ and ‘Guide2’ have responded to ‘Request1’.

The request user message ID field 530 includes information of a message which may be delivered to a user responsive to a request. Information indicated in the request user message ID field 530 may be used to obtain information associated with a user message using a record such as the user message record 900 illustrated in FIG. 9. Any number of request user messages may be associated with a request. For example, an interstitial advertisement, and a response message may be indicated in the request user message ID field 530. As will be further described herein a user message may be composed of elements which are combined in order to create a user message.

The request result ID field 535 includes information of a result which is associated with a search request. For example, a result may be associated with a search request when a guide obtains the search result responsive to the search request. For example, if a search request is submitted to the search system 130 (FIG. 1), a guide may be selected, and the guide may provide a search result responsive to the request. Alternately, a search result may be associated with a search request if the search request is submitted to a resource such as a search engine, or other resource system. Any number of search results may be associated with a search request. Using the example illustrated in FIG. 5, the result ‘Result1.1’ is associated with the request ‘Request1’. A search result may include text, an image, a URL, video, audio, or any other form of media. In at least one embodiment, a result may be text which has been selected by a guide and/or a URL any or all of which may be provided to a user. A result may include information which is not transmitted to a user.

The request advertisement ID field 540 includes information of an advertisement which is associated with a search request. For example, an advertisement may be associated with a search request when a guide selects the advertisement to be presented to a user responsive to the search request. For example, if a search request is submitted to the search system 130 (FIG. 1), a guide may be selected, and the guide may provide an advertisement responsive to the request. An advertisement may be associated with a search request automatically such as when a category and/or a keyword, or a profile is associated with the search request, an advertisement associated with the category, etc. may be associated with the request. Any number of advertisements may be associated with a search request. Using the example illustrated in FIG. 5, the advertisement ‘Advert1’, and ‘Advert2’ are associated with the request ‘Request1’. An advertisement may be included in a request user message as described further herein below. Delivery of an advertisement to a user may cause an activity to be associated with the user.

As illustrated in FIG. 6, an exemplary guide record 600 is provided, of which one or more may be associated with or resident in the search database 120 (FIG. 1). The guide record 600 may include a guide ID field 605, a guide category ID field 610, a guide topic ID field 615, a guide profile ID field 620, a guide result ID field 625, a guide communication info field 630, a guide request ID field 635, and a guide advertiser ID field 640.

The guide ID field 605 preferably contains a unique identifier of a guide, which is preferably used consistently. For example, in at least one embodiment, the guide ID field 605 can include a randomly generated numerical code, and/or a text string indicating a name associated with a guide. A guide ID serves to distinguish the guide record associated with a guide from a guide record associated with other guides. Other unique identifiers of a guide may be utilized without departing from the spirit and scope of the embodiments. Using the example illustrated in FIG. 6, ‘Guide1’ is the guide ID associated with the guide record 600.

The guide category ID field 610 includes information of a category associated with a guide. The content of the guide category ID field 610 may be modified based on actions of a guide. A person may select a category and/or keyword which is associated with a guide. A category may be associated with a guide based on testing of a guide. A category may be associated with a guide based on an affiliate group associated with a guide. For example, if a guide has chosen to be affiliated with affiliate groups associated with a type of music, a category associated with the type of music might be associated with the guide. A category associated with a guide may be used to select items which are to be presented to a guide. A guide may be selected to vote regarding an item based on the association of a guide with a category. If a keyword of an item such as a query, an advertisement, etc. is associated with a category, the category may be associated with the item. Using the example illustrated in FIG. 6, the categories ‘Category1’ and ‘Category3’ are associated with the guide ‘Guide1’. A ranking of a guide associated with a category may affect the probability that a guide will be selected to respond to a task associated with the item.

The guide topic ID field 615 includes information of a topic or interest or keyword associated with a guide. The content of the guide topic ID field 615 may be modified based on actions of a guide. A person may select a topic or “interest” which is associated with a guide. For example, a guide may select a topic or keyword to be associated with the guide during a registration process. A topic may be associated with a guide based on testing of a guide. For example, a guide may be required to demonstrate knowledge of a category and/or topic in order to be associated with the topic. Content of the guide topic ID field 615 may be compared to the content of a search request in order to determine a ranking of a guide for responding to a search request. Using the example illustrated in FIG. 6, the topics ‘reggie miller’, ‘basketball’ and ‘fishing’ are associated with ‘Guide1’. This may for example indicate that ‘Guide1’ has indicated an interest in those topics. A rating and/or ranking of a guide associated with a topic may affect the probability that a guide will be selected to respond to a task associated with the item. For example, if a guide is associated with a keyword and a category associated with a request, the guide may be more likely to be selected to respond to the request

The guide profile ID field 620 includes information of a profile associated with a guide. Content of the guide profile ID field 620 may be modified based on actions of a guide. A person may select a profile which is associated with a guide. For example, a guide may select a profile to be associated with the guide during a registration process. A profile may be associated with a guide based on testing of a guide. For example, a guide may be required to demonstrate knowledge relevant to a profile in order to be associated with the profile, or a guide may take a test which is used to generate a profile, or a guide may provide information such as demographic, geographic, personality or other information which may be indicated in a profile associated with the guide. Information indicated in the content of the guide profile ID field 620 may be compared to information indicated in the content of a profile associated with search request in order to determine a ranking of a guide for responding to a search request. Likewise, a profile associated with a guide may be used to select and/or rank a guide for voting, and/or any tasks associated with any item. Using the example illustrated in FIG. 6, the profiles ‘Demoprofileg1’, ‘Geoprofileg1’ and ‘Persprofileg1’ are associated with ‘Guide1’. This may indicate that ‘Guide1’ has indicated and/or generated the profiles ‘Demoprofileg1’ which may be a demographic profile, ‘Geoprofileg1’ which may be a geographic profile and ‘Persprofileg1’ which might indicate personality information regarding the guide ‘Guide1’.

The guide result ID field 625 includes information of a result associated with a guide. Content of the guide result ID field 625 may be modified based on actions of a guide. If a guide produces a search result responsive to a search request, an identifier of the search result may be included in the guide result ID field 625. A rating and/or ranking associated with a search result associated with a guide may affect compensation for a guide. Likewise a usage indicator associated with a search result provided by a guide may affect a rating or ranking associated with a guide. Using the example illustrated in FIG. 6, the results ‘Result1.1’, ‘Result3.1’ and ‘Result3.2’ are associated with ‘Guide1’. This may indicate that ‘Guide1’ has provided the results ‘Result1.1’, ‘Result3.1’, and ‘Result3.2’ responsive to a number of search requests.

The guide communication info field 630 includes information of a device and/or service associated with a guide. The content of the guide communication info field 630 may be modified based on actions of a guide. If a guide establishes communications using a device and/or service information regarding the device and/or service may be included in the guide communication info field 630. Any type of communication service and/or system may be indicated in the guide communication info field 630. For example, a username and/or password associated with a guide may be indicated in the guide communication info field 630. Communication services such as Instant Messaging (IM), e-mail, SMS, MMS, EMS, telephone, wireless or wired communication, etc. may be indicated in the guide communication info field 630. A telephone number, an email address, an IM provider and login ID, a keyword associated with a service, an IP address, a MAC address, etc. may be indicated in the guide communication info field 630. Using the example illustrated in FIG. 6, the login ‘guide1’, the email ‘guide1@chacha.com’, the IM credential ‘guide1@AIM’ and the phone number ‘317.224.2242’ are associated with the guide ‘Guide1’. This may indicate that ‘Guide1’ may be contacted using the login ID ‘guide1’, via email at ‘guide1@chacha.com’, via IM as ‘guide1@AIM’ and via voice, text, and/or other service associated with the phone number ‘317.224.2242’.

The guide request ID field 635 includes information of a number of requests associated with a guide. Content of the guide request ID field 635 may be modified based on actions of a guide. If a guide produces a search result responsive to a search request, an identifier of the search request may be included in the guide request ID field 635. A rating and/or ranking associated with a search request associated with a guide may affect compensation of a guide. Likewise a usage indicator associated with a search request and a guide may affect a rating or ranking associated with the guide. A request may be associated with a guide based on a vote cast by a guide regarding items associated with the search request. Using the example illustrated in FIG. 6, the requests ‘Request1’ and ‘Request3’ are associated with ‘Guide1’. This may indicate that ‘Guide1’ has responded to, been selected to respond to, and/or has voted regarding a number of items associated with ‘Request1’ and ‘Request3’.

The guide advertiser ID field 640 includes information of an advertiser and/or a content provider associated with a guide. A content provider or advertiser may be associated with a guide who may be more likely to respond to a request associated with an advertiser. Content of the guide advertiser ID field 640 may be modified based on actions of a guide. If a guide produces a search result responsive to a search associated with an advertiser, an identifier of the advertiser may be included in the guide advertiser ID field 640. A rating and/or ranking associated with an advertiser associated with a guide may affect compensation for a guide. An advertiser may be associated with a guide based on a vote cast by a guide regarding items associated with the advertiser. For example, if a guide prefers advertising materials, results, categories, etc. which are associated with an advertiser, the guide may be associated with the advertiser. In at least one embodiment, a guide may elect to be associated with an advertiser. In at least one embodiment, an advertiser may select a guide associated with the advertiser. For example, if a guide is highly ranked in a category associated with an advertiser, the advertiser may pay to be associated with the guide. In at least one embodiment, the search system 130 may associate a guide with an advertiser. Using the example illustrated in FIG. 6, the advertisers ‘Advertiser1’, ‘Advertiser3’ and others are associated with the guide ‘Guide1’. This may indicate that ‘Guide1’ has participated in an activity associated with a number of items associated with ‘Advertiser1’ and ‘Advertiser3’.

As illustrated in FIG. 7, an exemplary user record 700 is provided, of which one or more may be associated with or resident in the search database 120 (FIG. 1). The user record 700 may include a user ID field 705, a user profile ID field 710, a user request ID field 715, a user result ID field 720, a user advertisement ID field 725, and a user communication info field 730.

The user ID field 705 preferably contains a unique identifier of a user, which is preferably used consistently. For example, in at least one embodiment, the user ID field 705 can include a randomly generated numerical code, and/or a text string indicating a name associated with a user. A user ID serves to distinguish a user record associated with a user from a user record associated with other users. Other unique identifiers of a user may be utilized without departing from the spirit and scope of the embodiments. In at least one embodiment, a user ID may include a phone number associated with a user. Using the example illustrated in FIG. 7, ‘User1’ is the user ID associated with the user record 700.

The user profile ID field 710 may include information of a profile associated with a user. The content of the user profile ID field 710 may be modified based on actions of a user. A person may select a profile which is associated with a user. For example, a user may select a profile to be associated with the user during a registration process. A profile may be associated with a user based on testing of a user. For example, a user may be required to demonstrate knowledge relevant to a profile in order to be associated with the profile, or a user may take a test which is used to generate a profile, or a user may provide information such as demographic, geographic, personality or other information which may be indicated in a profile associated with the user. A profile associated with a user may be used to select and/or rank a user for voting. An item may be ranked based on a profile associated with the item and a user. For example, an advertisement and/or a result which is associated with a profile may be more likely to be provided to a user associated with the profile. Using the example illustrated in FIG. 7, the profiles DemoprofileU1′, ‘GeoprofileU1’ and ‘PersprofileU1’ are associated with the user ‘User1’. This may indicate that ‘User1’ has indicated and/or generated the profiles DemoprofileU1′ which may be a demographic profile, ‘GeoprofileU1’ which may be a geographic profile and ‘PersprofileU1’ which might indicate personality information regarding the user ‘User1’.

The user request ID field 715 may include information of a request associated with a user. Content of the user request ID field 715 may be modified based on actions of a user. If a user submits a request to the search system 130 (FIG. 1) an identifier of the request may be included in the user request ID field 715. Using the example illustrated in FIG. 7, the requests ‘Request1’, ‘Request2’ are associated with the user ‘User1’. This may indicate that ‘User1’ has submitted ‘Request1’ and ‘Request2’

The user result ID field 720 may include information of a result associated with a user. Content of the user result ID field 720 may be modified based on actions of a user, a guide, an advertiser and/or the search system 130 (FIG. 1). If a user receives a search result responsive to a search request, an identifier of the search result may be included in the user result ID field 720. A usage indicator associated with a search result provided to a user may affect a rating or ranking associated with a guide. Using the example illustrated in FIG. 7, the results ‘Result1.1’, ‘Result1.2’ and ‘Result2.1’ are associated with ‘User1’. This may indicate that ‘User1’ has been presented with ‘Result1.1’, ‘Result1.2’, and ‘Result2.1’ responsive to a request.

The user advertisement ID field 725 may include information of an advertisement associated with a user. The content of the user advertisement ID field 725 may be modified based on actions of a user, a guide, an advertiser and/or the search system 130 (FIG. 1). If a user receives an advertisement responsive to a search request, an identifier of the advertisement may be included in the user advertisement ID field 725. A usage indicator associated with an advertisement provided to a user may affect a rating or ranking associated with a guide, compensation for the search system, and/or rating and/or ranking of an advertisement. Using the example illustrated in FIG. 7, the advertisements ‘Advert1’, ‘Advert2’ are associated with the user ‘User1’. This may indicate that ‘User1’ has been presented with the advertisements ‘Advert1’, ‘Advert2’. While a few examples of associating an advertisement ID with a user are discussed herein, the present invention is not limited to any particular way of linking an advertisement to information of a user. For example, an advertisement may be associated with a user based on a determination of the user's likely interest in a product/service referred to in the advertisement using any of the information stored in the system 100 (FIG. 1) and/or submitted by the user.

The user communication info field 730 includes information of a device and/or service associated with a user. Content of the user communication info field 730 may be modified based on actions of a user. If a user establishes communications with the search system using a device and/or service, information regarding the device and/or service may be included in the user communication info field 730. Any type of communication service and/or system may be indicated in the user communication info field 730. For example, a username and/or password associated with a user may be indicated in the user communication info field 730. Communication services such as Instant Messaging (IM), e-mail, SMS, MMS, EMS, telephone, wireless or wired communication, etc. may be indicated in the user communication info field 730. A telephone number, an email address, an IM provider and login ID, a keyword associated with a service, etc. may be indicated in the user communication info field 730. Using the example illustrated in FIG. 7, the login ‘user1’, the email ‘user1@chacha.com’, the twitter account ‘twitteruser1’ and the device ‘User device1’ are associated with the user ‘User1’. This may indicate that ‘User1’ may be contacted using the login ID ‘user1’, via email at ‘user1@chacha.com’, via Twitter as ‘user1’ and via voice, text, or other service associated with the device ‘User device1’.

As illustrated in FIG. 8, an exemplary user device record 800 is provided, of which one or more may be associated with or resident in the database 120 (FIG. 1). The user device record 800 and may include a user ID field 805, a user device info field 810, a user device activity ID field 815, a user device activity priority field 820 and a user device message ID field 825.

The user device ID field 805 preferably contains a unique identifier of a user device, which is preferably used consistently. For example, in at least one embodiment, the user device ID field 805 can include a randomly generated numerical code, and/or a text string indicating a name associated with a user device. A user device ID serves to distinguish a user device record associated with a user device from a user device record associated with other user devices. Other unique identifiers of a user device may be utilized without departing from the spirit and scope of the embodiments. In at least one embodiment, a user device ID may include a description associated with a user device. Using the example illustrated in FIG. 8, ‘User device1’ is the user device ID associated with the user device record 800.

The user device info field 810 may include information associated with a user device such as information required to establish communication with the user device, geographic information associated with a user device, capabilities of a user device, etc. Using the example illustrated in FIG. 8, the subscriber ID number 317.555.5555, carrier ID ‘Wireless carrier1’, aggregator ID ‘Aggregator1’, and user ID ‘User1’ are associated with the user device ‘User device1’. Information indicated in the user device info field 810 may be used for various purposes, including matching an activity with a user device. For example, an activity may be selected with a higher priority based at least in part on information indicated in the user device info field 810.

The user device activity ID field 815 may include information associated with an activity associated with a user device. For example, a unique identifier of one or more activities such as that defined in the activity record 400 (FIG. 4) may be indicated in the user device activity ID field 815. If a message is received from a user device, information indicated in the message may be compared to trigger actions associated with activities indicated the user device activity ID field 815 in order to determine if a match exists between content of the message and trigger actions associated with a user device as described for example in operation 310 (FIG. 3). Using the example illustrated in FIG. 8, the activities ‘Activity1’, ‘Activity2’ and ‘Activity3’ are associated with the user device ‘User device1’.

The user device activity priority field 820 may include information of a priority associated with an activity associated with a user device. Any type of priority indication may be used to indicate a priority associated with an activity. In at least one embodiment, the user device activity ID field 815 and the user device activity priority field 820 may be linked by for example a pointer. Using the example illustrated in FIG. 8, the priority ‘2’ is associated with the activity ‘Activity1’, the priority ‘8’ is associated with the activity ‘Activity2’, and the priority ‘4’ is associated with the activity ‘Activity3’. As previously noted with respect to FIG. 4, priority of an activity may be determined at least in part based on a type associated with an activity. An activity associated with a message delivered to a user may take precedence over an activity associated with the top-level system.

Priority information of an activity associated with a user device may be used to resolve a conflict between trigger actions which are to be associated with a user device. If an activity which is to be associated with a user device includes one or more trigger actions which conflict with trigger actions of an activity which is currently associated with a user device, the priority associated with the activities may be used at least in part to determine system actions which may resolve the trigger action conflict. For example, if an additional activity (e.g. ‘Activity7’ with priority ‘6’ is to be associated with ‘User device1’, and there is a conflict of trigger actions between ‘Activity7’ and ‘Activity1’, the higher priority value associated with ‘Activity7’ may cause ‘Activity7’ to be associated with ‘User device1’ and ‘Activity1’ to be disassociated with ‘User device1’.

The user device message ID field 825 may include information of a messages transmitted to a user device. For example information indicated in the user device message ID field 825 may be used to obtain information regarding a user message using a record such as the user message record 900 illustrated in FIG. 9. Using the example illustrated in FIG. 8, the use messages ‘User message1’, ‘User message2’, and ‘User message3’ are associated with ‘User device1’. This may indicate that ‘User message1’, ‘User message2’, and ‘User message3’ have been provided to ‘User device1’.

As illustrated in FIG. 9, an exemplary user message record 900 is provided, of which one or more may be associated with or resident in the search database 120 (FIG. 1). The user message record 900 may include a user message ID field 905, a user message user ID field 910, a user message user device ID field 915, a user message result ID field 920, a user message guide ID field 925, a user message result content info field 930, a user message content provider ID field 935, a user message provider content ID field 940, and a user message activity ID field 945.

The user message record ID field 905 contains an identifier of a user message, which is preferably unique and preferably used consistently. For example, in at least one embodiment, the user message record ID field 905 can include a randomly generated numerical code and/or a character string indicating a user message. A user message record ID serves to distinguish a user message record associated with a user message from a user message record associated with other user messages. Although particular examples of identifiers are described herein, other types of identifiers uniquely indicating a user message may be utilized without departing from the spirit and scope of the embodiments herein.

The user message user ID field 910 may include one or more identifiers associated with a user. The content of the user message user ID field 910 may be used to obtain information of a user using a record such as the user record 700 (FIG. 7). Using the example illustrated in FIG. 9, the user ‘User1’ is associated with ‘User message1’. This may for example indicate that ‘User message1’ has been transmitted to ‘User1’.

The user message user device ID field 915 may include information of a user device associated with a user message. Content of the user message user device ID field 915 may be used to obtain information of a user device using a record such as the user device record 800 (FIG. 8). Using the example illustrated in FIG. 9, the user device ‘User device1’ is associated with the user message ‘User message1’.

The user message user result ID field 920 may include information of a result associated with a user message. Content of the user message result ID field 920 may be used to indicate a search result which is to be included in a user message. A search result may include an activity which is to be associated with a user device if the search result is transmitted to the user device. For example, an initial message may be delivered to a user device, which may cause an activity to be associated with a user device which may allow a user to obtain further information associated with the search result based on a trigger action associated with the activity. Using the example illustrated in FIG. 9, the result ‘Result1.1’ is associated with the user message ‘User message1’.

The user message guide ID field 925 may include information of a guide associated with a user message. For example, an indicator of a guide associated with a search result, an advertisement, and/or other content included in a user message may be indicated in the user message guide ID field 925. Using the example illustrated in FIG. 9, the guide ‘Guide1’ is associated with the user message ‘User messge1’.

The user message result content field 930 may include information of content associated with a search result which is to be included in a user message. Text, a URL, media such as an image, audio, video, etc. associated with a search result may be indicated in the user message result content field 930. Using the example illustrated in FIG. 9, the text ‘That sensations is the best That restaurant in Indy’ is the result content associated with the user message ‘User message1’. This may indicate that the user message ‘User message1’ may include the text ‘That sensations is the best That restaurant in Indy’. Further, a type of the user message may be selected based on the device using which the request is received. For example, a text message may be sent when a request to is received from device A while the same request may receive a URL as a response if the request was received from device B.

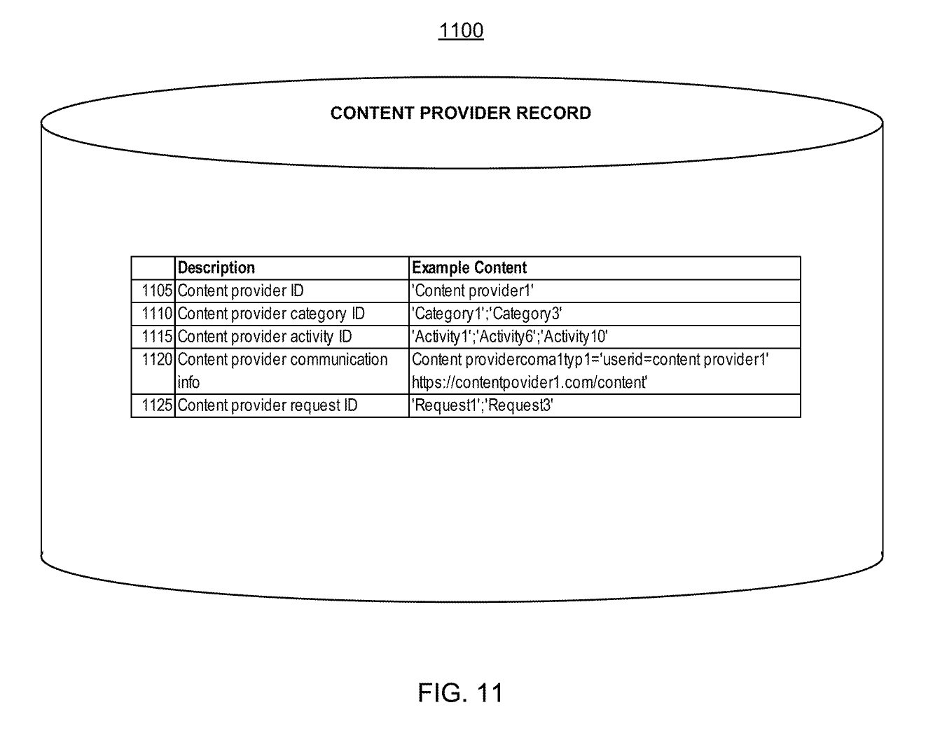

The user message content provider ID field 935 may include information of a content provider associated with a user message. For example an identifier of a content provider associated with content included in a user message may be indicated in the user message content provider ID field 935. The content of the user message content provider ID field may be used to determine compensation information or other information associated with a content provider using a record such as the content provider record 1100 (FIG. 11). Using the example illustrated in FIG. 9, the content providers ‘Advertiser1’ and ‘Content provider2’ are associated with ‘User message1’ this may indicate that content associated with ‘Content provider1’ and the content provider associated with ‘Activity2’ have provided content included in the user message ‘User message1’.

The user message provider content field 940 may include information of content provided by a number of content providers which is to be included in a user message. Text, a URL, media such as an image, audio, video, etc. may be indicated in the user message result content field 940. A user message may include information indicated in the user message provider content field 940. For example, an advertising message, or a message associated with an activity provided by a content provider indicated in the user message provider content field 940 may be included in a user message. Using the example illustrated in FIG. 9, the content ‘Ad content1’ and ‘% user message activity2’ are associated with the user message ‘User message1’ this may indicate that ‘User message1’ may include information associated with ‘Ad content1’ and information indicated in the activity user message field 410 (FIG. 4) of the activity record associated with ‘Activity2’.

The user message activity ID field 945 may include information of an activity which may be associated with a user device if the user message is transmitted to the user device. For example, an activity which is associated with a search result and/or an activity which is associated with a content provider may be indicated in the user message activity ID field 945. Using the example illustrated in FIG. 9, the activity ‘ActivityR1.1’ and the activity ‘Activity2’ are associated with the user message ‘User message1’.

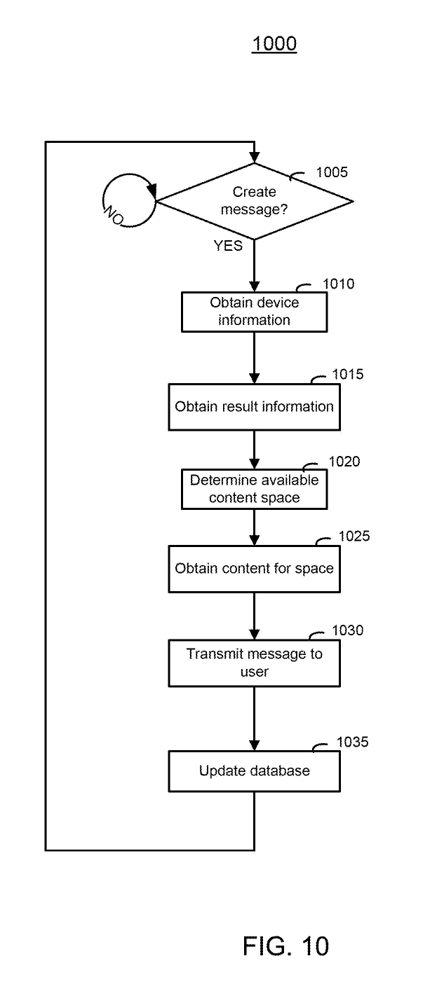

As illustrated in FIG. 10, a process 1000 for creating a user message is provided. The process 1000 may be operative on any or all elements of the system 100 (FIG. 1).

In operation 1005, a determination is made as to whether a user message is to be created. The determination at operation 1005 may be made based on various conditions. For example, a search result may be provided by a guide and/or the search system 130 (FIG. 1) which is to be delivered to a user device as a user message, or a user action may cause a message to be sent to a user device. If it is determined in operation 1005 that a user message is not to be created control remains at operation 1005 and process 1000 continues. If it is determined in operation 1005 that a user message is to be created, control is passed to operation 1010 and process 1000 continues.

In operation 1010, information of a user device to which a user message is to be transmitted is obtained. For example, device capabilities, information of a carrier, an aggregator, etc. associated with a user device may be obtained. Information of activities associated with a user device is obtained. Control is passed to operation 1015 and process 1000 continues.

In operation 1015, information of a result is obtained. For example, information of text, media, and/or an activity associated with a search result may be obtained. In at least one embodiment, a user message may not include a search result. The present invention is not limited to providing a user message that only includes data which results from a search. For example, content may be automatically generated by the system 100 (FIG. 1), created by a guide without requiring a user request to be received, etc. Further, the result information obtained at operation 1015 may also be accompanied by content that may not a result of a search. As described in detail herein, a message provided to a first user may not be identical to a message provided to a second user submitting a substantially similar request as the first user. As such, a message is modified or customized based on information of the user to which the message is sent. Control is passed to operation 1020 and process 1000 continues.

In operation 1020, available content space is determined. For example, a number of characters in a text message which may be used to deliver sponsored content, and/or a type of content which may be delivered to a user device may be determined. In at least one embodiment, a number of characters remaining in an SMS message after a search result has been included are determined. In at least one embodiment, a number of characters which may be included in a number of SMS messages which may include information of a search result may be determined. Control is passed to operation 1025 and process 1000 continues.

In operation 1025, content is obtained which is able to fit in the available content space determined in operation 1020. For example, content which meets the available space may be obtained from content indicated in the database 120. In at least one embodiment, content providers may provide an activity and/or content which has a one or more predetermined numbers of characters associated with the activity. For example, content with a length of 20, 40 or 60 characters might be defined. If available content is associated with an activity, trigger actions associated with the content may be compared to trigger actions associated with a user device based on the information of the device. In at least one embodiment, content of a user message may be modified to eliminate any trigger action conflict. In at least one embodiment, content may be selected based at least in part on trigger action conflicts. In at least one embodiment, content is selected based on a ranking of available content. For example, advertising content might be ranked in order to optimize advertising revenue, or entertainment content might be ranked based on characteristics of a user, etc. As previously noted with respect to FIG. 4, a system response to an activity may be modified without revising the trigger activities associated with a user device. This may for example allow different advertising and/or entertainment responses to be provided responsive to a trigger based on various considerations. Control is passed to operation 1030 and process 1000 continues.

In operation 1030, a user message is transmitted to a user device. In at least one embodiment, an SMS message is transmitted to a user device. Any type of message may be transmitted to any user device. In at least one embodiment, multiple messages may be transmitted to a user device, which may be associated with any number of activities. Control is passed to operation 1035 and process 1000 continues.

In operation 1035, information of the process 1035 is recorded. For example, information of a user message transmitted to a user device, information of activities associated with a user device, etc. may be recorded in the database 120 (FIG. 1). For example, information of an activity associated with a user device based on a user message transmitted to the user device, information of content provided to a user device, information of a search result delivered to a user device, information of a guide associated with a search result provided to a user device, or information of a user, etc. may be recorded in the database 120 (FIG. 1). Control is passed to operation 1005 and process 1000 continues.

A content provider may provide various types of content for various purposes. For example, a content provider might be a database owner which provides interactive services such as navigation directions, weather forecasts, etc. which are directed to a user responsive to a request. A content provider might supply various forms of entertainment such as an interactive game, a poll, a contest, etc. A content provider might be an advertiser who may provide interactive advertisements. A content provider might be an operator of a wireless network, an aggregator, etc. who may provide information to users of the network. Because an activity may be modified by changing the response associated with a trigger action, response of the system to a first user may be modified without affecting other users. Likewise, groups of users associated with an activity may observe personalized changes to system behavior while other users observe no change. For example, a group of users associated with a location (e.g. zip code 40220) might receive a local weather forecast (i.e. weather for 40220) responsive to the keyword “W” while a different group of users associated with a different location (e.g. zip code 90210) might receive a different local forecast (i.e. weather for 90210) responsive to the keyword “W”. Various other forms of personalization and localization such as news, traffic, directions, language preference, etc. may be associated with an activity which may be associated with a user at any grouping level which is distinct.

Further an information provider may elect to be associated with particular actions. For example, a keyword such as “MUSIC” or “PIZZA” or “FUN” might be attractive to a provider of content, who might desire to be associated with the keyword. A customized response to a keyword based on location, time, user profile, etc. may be provided which may increase personalization of content delivered. Likewise, a provider of information services may modify a system response in order to optimize revenue, and/or other system parameters as a content provider may bid on placement associated with a keyword.

As illustrated in FIG. 11, an exemplary content provider record 1100 is provided, of which one or more may be associated with or resident in the search database 120 (FIG. 1). The content provider record 1100 may include a content provider ID field 1105, a content provider category ID field 1110, a content provider activity ID field 1115, a content provider communication info field 1120, and a content provider request ID field 1125.

The content provider ID field 1105 preferably contains a unique identifier of a content provider, which is preferably used consistently. For example, in at least one embodiment, the content provider ID field 1105 can include a randomly generated numerical code, and/or a text string indicating a name associated with a content provider. A content provider ID serves to distinguish a content provider record associated with a content provider from a content provider record associated with other content providers. Other unique identifiers of a content provider may be utilized without departing from the spirit and scope of the embodiments. In at least one embodiment, a content provider ID may include a URL associated with a content provider. Using the example illustrated in FIG. 11, ‘Content provider1’ is the content provider ID associated with the content provider record 1100.

The content provider category ID field 1110 may include information of a category associated with a content provider. The content of the content provider category ID field 1110 may be modified based on actions of a content provider. A person may select a category and/or a keyword which is associated with a content provider. A category may be associated with a content provider based on testing of a content provider. A category may be associated with a content provider based on an affiliate group associated with a content provider. For example, if a content provider has chosen to be affiliated with affiliate groups associated with a type of music, a category associated with the type of music might be associated with the content provider. A category associated with a content provider may be used to select an activity to be associated with a user. For example a category associated with a user request may be used to select an activity provided by a content provider which is associated with the category to be provided to a user responsive to the request. Using the example illustrated in FIG. 11, the categories ‘Category1’ and ‘Category3’ are associated with the content provider ‘Content provider1’.

The content provider activity ID field 1115 may include information of an activity associated with a content provider. For example, if a content provider creates a number of activities, the activities created by the content provider may be indicated in the content provider activity ID field 1115. Information indicated in the content provider activity field 1115 may be used to obtain information of an activity using a record such as the activity record 400 (FIG. 4). Using the example illustrated in FIG. 11, the activities ‘Activity1’, ‘Activity6’ and ‘Activity10’ are associated with the content provider ‘Content provider1’, which may indicate that ‘Content provider1’ has control of ‘Activity1’, ‘Activity6’ and ‘Activity10’.

The content provider communication info field 1120 includes information of a device and/or service associated with a content provider. Content of the content provider communication info field 1120 may be modified based on actions of a content provider. If a content provider establishes communications with the search system 130 using a device and/or service, information regarding the device and/or service may be included in the content provider communication info field 1120. Any type of communication service and/or system may be indicated in the content provider communication info field 1120. For example, a username and/or password associated with a content provider may be indicated in the content provider communication info field 1120. Communication services such as Instant Messaging (IM), e-mail, SMS, MMS, EMS, telephone, wireless or wired communication, etc. may be indicated in the content provider communication info field 1120. A telephone number, an email address, an IM provider and login ID, a keyword associated with a service, etc. may be indicated in the content provider communication info field 1120. Using the example illustrated in FIG. 11, the login ‘content provider1’, and the URL ‘https://contentpovider1.com/content’ are the communication info associated with ‘Content provider1’.

The content provider request ID field 1125 includes information of a request associated with a content provider. Using the example illustrated in FIG. 11, the requests ‘Request1’, ‘Request3’ are associated with the content provider ‘Content provider1’. This may indicate that ‘Content provider1’ has provided content associated with the requests ‘Request1’ and ‘Request3’.

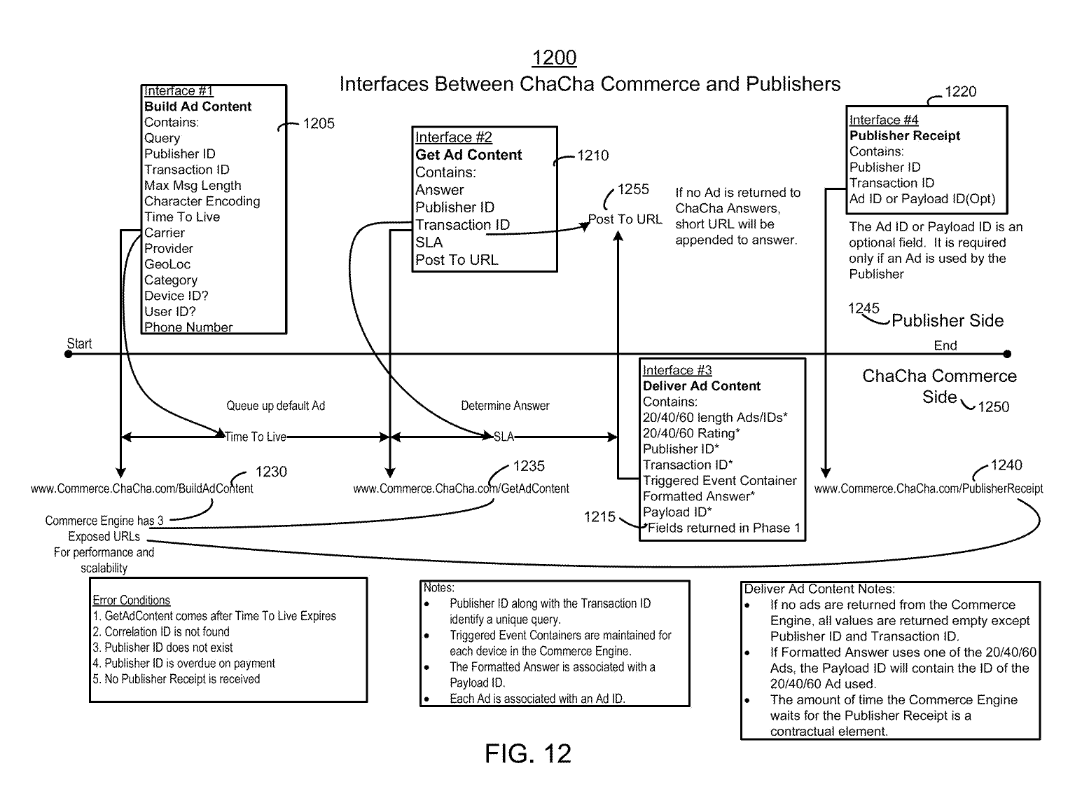

An exemplary interface 1200 between content providers and the search system 130 (FIG. 1) is illustrated in FIG. 12. A content provider may interface to the ‘Build Ad Content’ content creation URL 1230 whereby advertising and/or other types of interactive activities may be defined by the content provider. The content definition may conform to the content definition API 1205. If content provided by a content provider is selected during the time period defined for supplying the content to users, the ‘publisher side’ 1245 of the search system 130 (FIG. 1) may request content from the ‘ChaCha Commerce Side’ 1250 of the search system 130. Content which conforms to the ‘Get Ad Content’ API 1210 may be provided by the ‘GetAdContent’ content URL 1235. If content is provided within the SLA (Service Level Agreement) time interval, the content may be incorporated with a search result or answer and may be provided to the search system 130 and transmitted to the user via the user publishing URL 1255.

Content which is to be provided to a user may conform to the ‘Deliver Ad Content’ API 1215 may include an activity definition, as well as a user message, which are associated with the information provided from the ‘Get Ad Content’ API 1210. In order to provide delivery information and confirmation of content delivered to a user, the ‘Publisher Receipt’ API is exposed to a content provider via the ‘PublisherReceipt’ URL 1240. If content is delivered to a user via the user publishing URL 1255, information is provided to indicate the transaction ID of the request which provided the content to the user and the ID of the content which is provided to the user. While specific conditions are illustrated in FIG. 12, the present invention is not limited thereto.

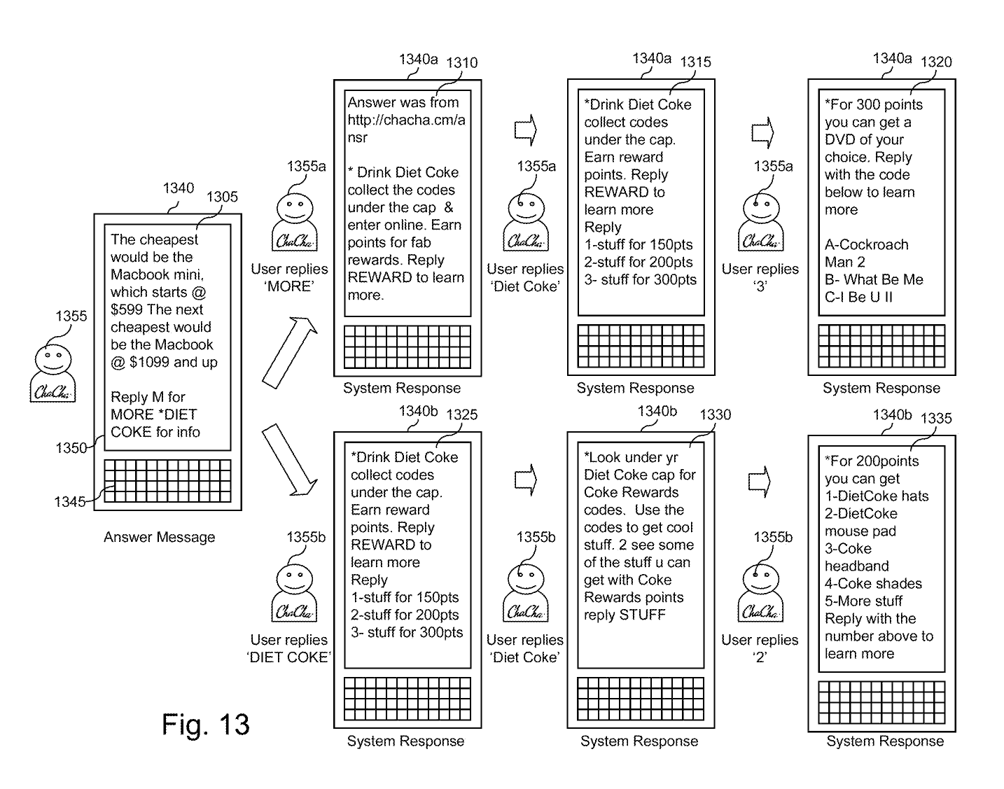

An exemplary interaction of a user with a system using a triggered activity is illustrated in FIG. 13. A user device 1340, which may for example be a text-enabled mobile phone or other user system, may include a display device 1350, and user controls 1345. For example, the display device may be an LCD, OLED, LED or other type of display device which is well known in the relevant art. The user controls 1345 may be any controls which allow a user to indicate actions selected via the mobile device such as a keypad, a touch screen, a pen input device, or other controls well known in the art.

A user of the user system 1340 may receive one or more messages which may be associated with trigger actions, and/or trigger actions may be associated with the user based on information of the user device, etc. Using the example in FIG. 13, the user device 1340 may receive a message associated with a trigger action such as an answer message 1305. The answer message 1305 may include an answer to a user query as well as an advertising message associated with trigger actions. As illustrated in FIG. 13, the trigger actions ‘M’ and ‘Diet Coke’ are associated with the answer message 1340. If the user 1355a replies with ‘M’ an extended answer message 1310 may be presented. The extended answer message 1310 may be associated with the additional trigger action ‘REWARD’ which may be associated with the user device 1340a. In this example, the actions ‘M’, ‘Diet Coke’ and ‘Reward’ may now produce a defined system response which may be uniquely associated with the user device 1340a.

If the user 1355b replies to the answer message 1305 with the action ‘Diet Coke’, a ‘Stuff’ message 1325 may be presented. The ‘Stuff’ message 1325 may be associated with the trigger actions ‘Reward’, ‘1’, ‘2’ and ‘3’. In this instance, the user device 1340b may now be associated with the actions ‘M’, ‘Diet Coke’, ‘Reward’, ‘1’, ‘2’ and ‘3’. Receipt of a message from the user device 1340b including any or all trigger actions may cause a response by the search system 130 associated with the trigger action. For example, the user 1355b might reply with ‘Reward’ which might cause a ‘Stuff’ message 1330 to be presented, or the user 1355b might reply with ‘2’ which might cause a ‘2’ message 1335 to be presented. While the messages to the user 1355b are depicted in a sequence for the purposes of illustration, the messages might be presented at any time responsive to the trigger action associated with the message.

As there may be a list of trigger actions and responses associated with a user device based on historical messages the user device 1340a and the user device 1340b may cause a different response by the search system 130 when the same trigger action is received from the different devices. For example, if the user 1355b replies to the ‘2’ message 1335 with the trigger action ‘1’, ‘2’ or ‘3’ a different system response may occur than if the user 1355a replies to the ‘Stuff’ message 1325 with the trigger action ‘1’, ‘2’ or ‘3’. Likewise, the response of the search system 130 to the action ‘A’ when received from the user device 1340a which has received a ‘points’ message 1320 may be different than the response of the search system 130 to the action ‘A’ when received from the user device 1340b which has not received the ‘points’ message 1320. Any type of message might be received by a user device and the messages illustrated in FIG. 13 are used for the purposes of simplicity and explanation. The use of an activity object associated with a user device allows different users to obtain different responses even if the same user action is taken. This may improve context of interactions with the search system 130 (FIG. 1).

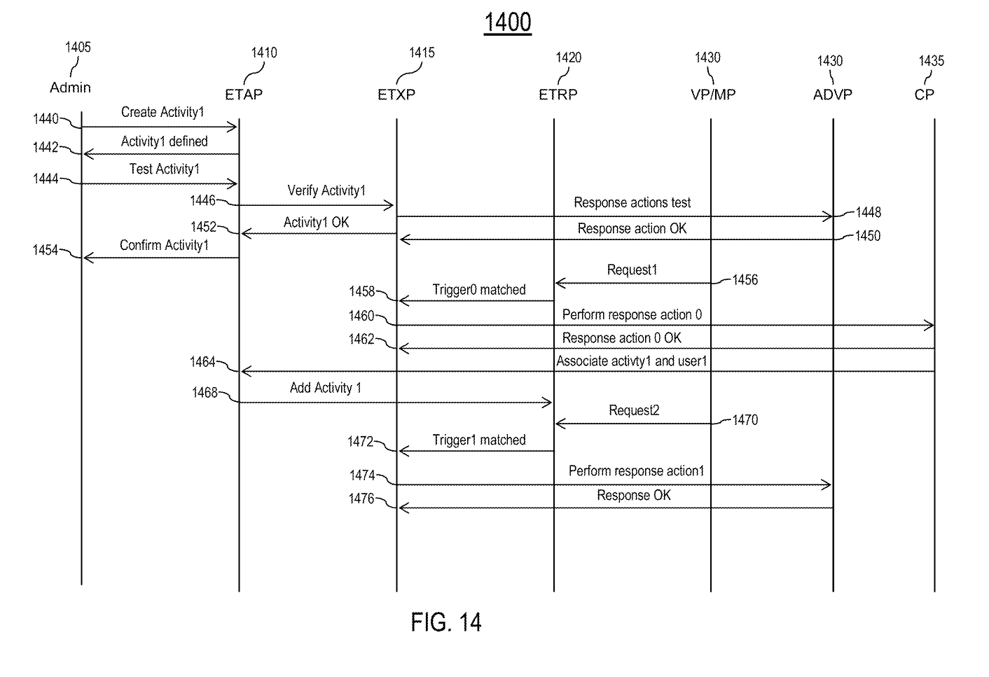

An exemplary message flow 1400 for an embodiment of the system 100 (FIG. 1) is illustrated in FIG. 14. While a specific architecture and message flow are illustrated, other ways of implementing an equivalent processing of the messages as are well known in the art may be applied, and the structures and groupings of functionalities are used for the purposes of illustration and simplicity, without limitation.

The system may include an Administrator (Admin) process 1405, an event triggers admin process (ETAP) 1410, an event triggers execution process (ETXP) 1415, an event triggers recognition process (ETRP) 1420, a voice/messaging process (VP/MP) 1425, an advertiser developed process (ADVP) 1430, and a control process (CP) 1435. The administrator process 1405 may be an external web service which allows an external system to define an activity object using a defined API. The ETAP 1410 obtains, verifies and tracks the content of activities which are currently available to be associated with a user device. The ETXP 1415 manages execution of response actions when an event trigger has been detected. In at least one embodiment, the ETXP 1415 may transmit a Universal Resource Indicator (URI) defined in an activity object to at least one external process such as the ADVP 1430. The ETRP 1420 analyzes incoming messages to determine if an event trigger has been detected. In at least one embodiment a default event trigger is associated with every message which causes the message to be forwarded to the CP 1435 which may perform processing of the request such as obtaining a search result associated with the query. The VP/MP 1425 receives messages from various systems such as the messaging service aggregator 165 (FIG. 1) and/or a voice server, etc. which may be provided in a format suitable for the ETRP 1420. The ADVP 1430 may be a process associated with a content provider which may provide a response to a user. The CP 1435 may receive a message from the ETRP 1420 and may further process a request to provide a result to a user.

In order to create an activity a content provider using the Admin process 1405 may submit a ‘create activity1’ message 1440. Responsive to the ‘create activity1’ message 1440, the ETAP may determine whether suitable information has been provided, and may respond with an ‘activity1 defined’ message 1442. The ETAP 1410 may require that an activity definition be tested and verified. For example, in order to avoid system disruptions if a server associated with the ADVP 1430 is unable to process a request, the search system 130 (FIG. 1) may require verification of any or all elements of an activity. The Admin process 1405 may generate a ‘test activity1’ message 1444. Responsive to the ‘test activity1’ message 1444, the ETAP may send a ‘verify activity1’ message 1446 to the ETXP 1415. The ETXP 1415 may send a ‘response actions test’ message 1448 to the ADVP responsive to the ‘verify activity1’ message 1446. The ADVP 1430 may respond with a ‘response action OK’ message 1450. It should be noted that while a single message is illustrated for simplicity any number of messages may be utilized in the verification process. The ETXP 1415 may provide information of a verification session to the ETAP using an ‘activity1 OK’ message 1452. The ETAP 1410 may designate an activity (i.e. Activity1) as active if a test result is acceptable, and may send a ‘confirm activity1’ message 1454 to the Admin process 1405.

If a user request is received, the VP/MP 1425 may send a ‘request1’ message 1456 to the ETRP 1420. If it is found that an action associated with the ‘request1’ message matches a trigger (e.g. trigger0), a ‘trigger0 matched’ message 1458 may be transmitted to the ETXP 1415. In at least one embodiment, the ETRP 1420 may use a hierarchical matching order. The ETXP 1415 may transmit a ‘perform response action 0’ message to the CP 1435. The CP 1435 may respond with a ‘response action0 OK’ message 1462. For example, the CP 1435 may provide a message to a user which is associated with an activity. An ‘associate activity1 and user1’ message 1464 may be provided to the ETAP 1410. The ETAP 1410 may deliver an ‘add activity1’ message to the ETRP 1420 which may cause ‘activity1’ to be added to an activity list associated with ‘user1’.

Subsequently a ‘request2’ message 1470 may be delivered by the VP/MP 1425 to the ETRP 1420. If the ‘request2’ message 1470 includes a trigger action associated with ‘activity1’ a ‘trigger1 matched’ message 1742 may be transmitted by the ETRP 1420 to the ETXP 1415. The ETXP 1415 may send a ‘perform response action1’ message 1474 to the ADVP 1430. The ADVP 1430 may execute any operations available to respond to the trigger action or event. A ‘response OK’ message 1476 may be sent from the ADVP 1430 to the ETXP 1415 which may report the status of a response.

In general, search systems are designed to search publicly available information. Such systems are generally limited in their access to personal and private information. In addition, existing search systems designed to search and/or facilitate transactions or activities based on personal and/or private information lack a sufficient system structure to provide human-assisted services without revealing the personal and private information to the human assistant.

Many types of user requests may require the use of personal data. For example, if a user desires to make a purchase through a website, the user may supply financial information, fulfillment information, etc. as needed to complete a transaction. A user may select any number of items which are to be purchased. Such data may be stored on a secure server of a supplier of goods and/or services in order that future purchases may be made more rapidly and easily. However, such systems are limited to machine to machine interactions. If a user does not have access to such a system, or a supplier does not have facilities to permit such purchases, the user may be unable to complete the desired transaction.

A further problem for transactions involving private data such as credit card information, personal information such as email address, home address, phone numbers, etc, is that of security of a supplier's database. Reputable Fortune 500 companies have been the targets of theft of personal information including banking data, etc. As a consequence, many people are reluctant to store such sensitive information with suppliers of goods and services. Each added location where such data is stored increases the risk that the information could be accessed by unauthorized parties. The need to provide personal information repeatedly may present an obstacle to use. This is particularly challenging for small businesses. A user is unlikely to allow a pizza shop, restaurant, repair, or other small business to obtain and store personal data.

In order to overcome these issues, it would be desirable to have a single location wherein various types of personal information might be recorded and shared on an as needed basis with persons and/or entities which require the information. However, such a service may face difficulties. Transactions which require personal data may be required sporadically, which may require a high capacity of certified people to be available, which may be under utilized. For example, a secure call center may be costly. Likewise, a service which does not provide human assistance would likely not be able to interact with various different types of suppliers. Lastly, a dedicated concierge service might be perceived as a luxury. Personal concierge service is part of a package of benefits from credit card providers such as American Express or Visa which may have an annual fee of $495 or more.

A system is provided whereby a user may obtain help from a person with suitable access rights to confidential information when needed to fulfill a request of the user. A multi-layered approach is applied wherein human assistants with different levels of access rights to user data are provided. If a user request does not require a human assistant or ‘guide’ to directly handle sensitive information such as financial data, personally identifiable information of a user and/or other persons, etc. a low security guide who has limited access to such information is provided. If a higher level of security and/or privacy is required in order to fulfill a request, a guide who has met specific security requirements is provided. In at least one embodiment, guides who are in an environment required by industry audits such as PCI-DSS may be provided.

A server is provided which receives user requests and routes the requests to human assistants as needed. If it is determined that a request requires handling of sensitive data of a user, a guide with suitable security certifications is selected. Information associated with a user may be private or redacted unless otherwise indicated. A user may designate any or all information associated with the user to be accessible as obscured or ‘redacted’ information in order to reduce the cost of handling the information. Some information may be accessible and/or viewable only to a trustee guide. Various ways of determining that a request requires access to sensitive information may be applied which may be used to prevent unauthorized disclosure and to select a suitable guide and/or trustee to handle a request.

A method and system is provided which includes a user system, a guide system, a trustee system, a resource system, a search system server, and a database. The database may be distributed among the search system and any other system within the overall system. The system may allow a user to utilize a human guide to search data and allow the guide to provide a search result and conduct an activity without viewing various elements of the data associated with the information. This may allow a user to obtain information from a repository without revealing or consenting to reveal private and/or personally identifying information, and/or without revealing various elements of content of the repository to a guide. A user may need to utilize a guide who can provide a higher level of confidentiality and/or data security; who may be referred to as a ‘trustee’ or trustee guide. A trustee may be required to meet security standards and/or achieve other qualifications in order to be permitted to perform a search request and/or perform, facilitate, and/or manage a secure transaction for a user. By providing a trustee at the request of a user, the requirement for a large number of trustees may be reduced. Trustees or trustee guides may be assigned alternate tasks if a level of activity associated with secure transaction tasks is low compared to the number of available trustees.

A repository of information regarding a user which is not to be explicitly revealed to a guide may be made accessible to a guide. Access to any or all elements of a repository may be restricted, which may result in information being encrypted or otherwise hidden when presented to a guide. If a user elects to request a search of encrypted information, a guide who is permitted access to the elements of the repository which are not redacted may be selected. A selected guide may be a guide who has met requirements designated by a user and/or a search service to access and search restricted information.

A user may discover that information the user would like to access is in a blocked and/or hidden (i.e., redacted) portion of a database or repository and may need to be revealed for example in order to fulfill a request and/or perform other activities. Such information may not be accessible to a guide due to restrictions and/or other privacy settings designated, for example, by a user. In such a case, a trustee guide who has been designated to handle the information required may be selected to interact with a user and/or a provider of an item and/or service. In at least one embodiment, a trustee may be selected based on information associated with a user. A user may elect that more than one trustee or type of trustee is required to handle a request based on access privileges which are granted to a trustee.

A human assistant is provided to respond to a user request. If a request includes a request for information which is identified as restricted, the human assistant or guide may be provided with redacted or edited information of a search result which may in turn be provided to the user, and/or may be provided to a third party under suitable conditions. If it is determined that a request requires access to user information which is hidden or blocked, a trustee, who may be required to meet predetermined security requirements, is provided. A user may create, select and maintain information which may be available to the user, which in turn may be provided responsive to a request. To process a request and/or provide a service or transaction, a search system may select a guide with a required level of security approval (i.e. a trustee) may be selected if restricted information is to be revealed.

By providing a way to allow access to personal or private information based on user designations, a seamless interface may be provided to a user. A user may manage personal information which may be arranged according to privacy settings selected (customized) by the user. A guide may be allowed to perform a search which does not require particular access rights to the user repository of personal data; while a trustee who has been permitted to access any or all elements of a repository may be provided if a request is determined to require specialized access. A trustee may further be permitted to view personal and private information for a search request, or process such information while performing a service or other activity on behalf of a user. Utilization of system resources may be optimized, user experience may be improved, and use of a service and/or product may be enhanced due to more efficient access to the service and/or product by a user.

A system is provided which allows a user or InfoSeeker™ who may be any person to submit a search request, query or other request to a search service and receive a response to the search request or ‘result’. A system which allows communication to occur between a user, a guide, trustee, or human assistant, a resource, a database, a repository a third party system and/or a search system allows requests to be processed and transactions to be performed. A database comprising information of a user, a guide, a trustee, a provider of goods and/or services, a resource, a document, private information, redacted data, a request, an advertisement, a category, a keyword, a tag, etc., is provided.

A request submitted by a user may receive a response which is produced automatically and/or by utilizing assistance of one or more human searchers or guides. In at least one embodiment, a request submitted by a user is compared to a database of request in order to determine if a matching request is found in the database. If a matching request is found, a result, link, and/or advertisement associated with the matching request may be presented to a user responsive to a request.

A user may elect to register with a search system in order that a user may access information which may include personal information of the user which is accessible to the search system. For example, a user may create a login ID and/or username and password which may be used to verify the identity of the user. A user may choose to associate any number of communication services and/or devices with the user in order that the user may access information associated with the user and/or be contacted utilizing the communication services and/or devices.

A user may elect to identify an item which is to be included in a database or other such repository of information which is associated with the user. A user may designate all or any elements of the item which are to have restricted access, which may include hidden, encrypted and/or redacted elements. Such elements may be indexed and may be used to identify an item which includes the element, however the content of the element of the item and/or other information associated with the element may not be explicitly revealed without requisite access permissions. A guide may search for items or elements which may include a search term, keyword and/or meet one or more search criteria. Content of the hidden, encrypted, and/or redacted element may not be revealed to the guide. A user may be provided with information indicated in any redacted elements of an item as a search result. Elements included in a database or repository of redacted data may be referred to as items and/or objects. The term ‘object’ is commonly used in programming systems. An ‘object’ is an instance of a ‘class’ which has defined attributes (e.g., fields and properties). A record may be used to describe fields associated with an exemplary instance of an object. Methods or processes may operate on an object within a class. Objects and information which may be included in a repository of redacted information associated with a user might include email, documents, contact lists, personal notes, pictures, videos, music, financial or legal records, presentations, and/or any type of electronic files.

A user may submit a request for information which may be indicated in a database or repository of information associated with the user and/or otherwise compiled. In such an instance, a guide may be provided with information of the request and may submit the request to a search facility associated with the repository. For example a custom search engine might compile an index of a repository which might allow a guide to perform a search of the repository as further described in the related U.S. application Ser. No. 12/500,327 previously mentioned. A search result obtained from the repository may be obfuscated in whole or in part when viewed by a guide. For example, if results are identified as associated with a person's name, the results may be provided to a guide as encrypted text while a user might be presented with the person's actual name. A user would then for example be able to respond with a related request in which case a guide might select information to be provided based on instructions of the user without being explicitly aware of the content of the results. For example, a spoken list of names might be provided to a user, who in turn might select a number or other identifier associated with a name by verbally replying with the identifier that is associated with the user's desired request.

A user request may require various types of processing to be performed. A user request might include a request to assign a guide to perform a transaction and/or other service on the user's behalf. A user request may require one or more processes and/or types of processes or activities to be performed. An activity may be assigned to a guide or a trustee based on the indication of the level of security of the request as identified by the user or otherwise.

A “user” is any person or entity which may submit a request or search request. A “request” or “search request” or “query” is any request for information which may be originated by a person and/or a device or system. A user may be referred to as a “requester”, information seeker or InfoSeeker™.

A “guide” is any person who may be compensated and/or may be a volunteer who may respond to and/or assist with a request. An “ambassador” is a guide who may perform processing of a request and/or a search result. A “searcher” is a guide who may perform an information search responsive to a request. A “transcriber” who may also be a guide may convert a spoken portion of a request into text, and/or may otherwise convert information of a request from one form to another. A guide may be referred to as a “human assistant” or “human searcher” or “searcher”. A guide may perform any type of task. Any guide may act in any defined guide role. However, a human assistant who performs a task and a guide who conducts a search may not necessarily be the same. For example, a human assistant may perform a task to facilitate a search which is conducted by another person who is registered as a guide. A “guided request” is a request which uses the assistance of one or more guides.

An “identifier” or ID may include character, number and/or other type of information which may be used to identify an item including with respect to an item of a database. Items may include but are not limited to a guide, a user, a resource, an advertisement, a keyword, a category, a search result, a search request, a query, a rating, ranking, a message and/or a profile.

A “result” or “search result” or “answer” is any information which may be provided responsive to a request. A result includes, but is not limited to, any of an advertisement, a link to a web page, a message of any sort, image, audio, text, games, interactive media and/or software of any sort.

A “search resource” or “resource” is any source of information which may be used to obtain data including a search result. A search resource includes automated and/or human-assisted systems, any repository of information, and any type of media and/or systems which may provide information. A resource may be a provider or source of item and/or service. For example, a resource might provide an item such as a ringtone, a media file (e.g., audio, video, images, games, etc.), information such as news, lyrics, song titles, translations or any other type of information. A resource may be automated, and/or may utilize the assistance of a person.

A “profile” is one or more characteristics which may be associated with a person. Profile characteristics include but are not limited to demographic, geographic, personality, affiliations, areas of interest, historical actions, preferences, memberships, associations, etc.

An “advertisement” is any information which may be delivered to a user including to promote a provider, a product, a service, etc. An advertisement may include text, links, audio, video, images, printed materials, interactive media such as a game, or other forms of media which may be provided to a user device.

A “category” or “taxonomy branch” or “categorization” is a unique node within an index which may be associated with any number of items. If a request is associated with a category, items associated with the category may be more likely to be selected responsive to the request.

A “provider” or “vendor” or “supplier” who may also be referred to as a “third party” is a person and/or entity which may provide an item, service, and/or information. A third party may receive information of a user from a search system and/or a trustee guide.

A “trustee’ or trustee guide, or “concierge” is a person who has been authorized to access and use information which is designated as redacted or restricted information. Different trustees may have access to different types of information. In at least one embodiment, communications associated with a user may be intentionally allocated to different trustees, which may help to prevent revealing personal information of a user.

The terms voice and speech are used interchangeably herein. A user, a resource, and/or a guide may establish a communication session using a voice service, a messaging service such as Short Messaging Service (SMS), Enhanced Messaging Service (EMS), Multi-media Messaging Service (MMS), Instant Messaging (IM), email, an internet portal or web page, a web service, an API, regular mail or any other type of communication. A connection may be established using any device which is capable of utilizing a communication service. For example, a wireless device such as a cell phone, PDA, smart phone, etc. might be used to establish a communication session using voice, SMS, IM, email and/or internet protocols. A desktop, laptop or server system might be used to establish a communication session. A landline phone, a specialized communication terminal, or any other communication device might be used to establish a communication session.

Communication between a guide, a trustee, a user, a third party, a resource and/or a search system may include conversion of text to speech and speech to text. Any type of media which can be sent or received using a communication system may be part of a communication session. A communication session may be conducted using any or all communication service and/or devices associated with a user, a resource and/or a guide. A communication session may involve any number of guides, trustees, users, resources, advertisements, and/or database or repository elements associated with the search system. Any communication session may include communication via multiple service and/or device. For example, a request may be submitted as a voice query, which might indicate an image located on a resource accessible to a user and/or a guide, the voice query might be converted to a text message, the image might be processed in order to associate a tag and/or other images with the image, and a response might be provided as a spoken reply to a mobile phone associated with a user, and a video presentation which is accessible via a high-speed connection, which might be delivered to a browser functionality of a different user device.

An advertisement may be transmitted including during any or all communication sessions between a user, a guide, a trustee, a resource, a third party and/or a search system. A resource, a guide, a trustee, a third party, and/or an advertisement may be rated. Rating information may be obtained from a user, a guide, a trustee, a resource, a third party, and/or a search system. Rating information may be used to select a resource, a guide, an advertisement and/or any item based on information associated with an item indicated in a database. A search service may be compensated by advertising revenue, and/or by payments from a user, a guide, and/or a third party.

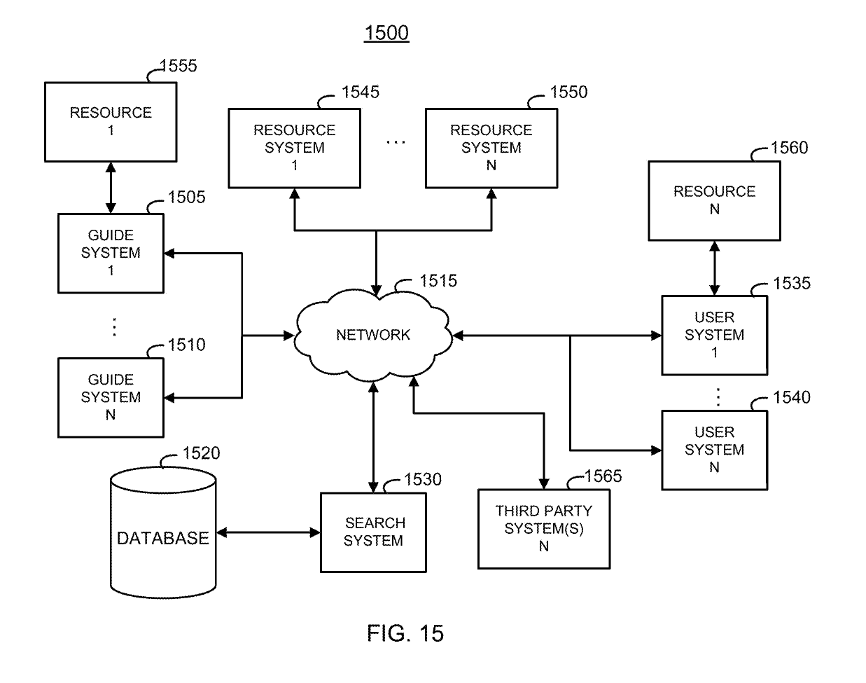

As illustrated in FIG. 15, system 1500 includes guide systems 1505, 1510, a network 1515 such as the Internet, a search system 1530, user systems 1535, 1540, third party system 1565, a database 1520, which may comprise various records, resource systems 1545, 1550, and resources 1555, 1560.

While only a limited number of systems associated with a guide, resource, user, third party (also referred to as a provider or supplier) and a search system are depicted in FIG. 1, it is within the scope of the disclosure for any number of systems for guide, resource, user, third party and search systems to be utilized.

Any user system (e.g., the user systems 1535, 1540) can be operated by an information seeker, who may be a person, to submit a request to the search system 1530 and/or receive a search result and/or other information. Any guide system (e.g., the guide systems 1505, 1510) can be operated by a human searcher to obtain a search result and/or provide other services to an information seeker located at a user system (e.g., the user systems 1535, 1540). Any of the guide systems 1505, 1510 may be operated by a trustee or trustee guide as determined by the search system 1530. Any third party system (e.g., the third party system 1565) can be operated by a third party, who may be a supplier, a provider, an entity, a company, a person, etc., to obtain information and/or facilitate requests for services or transactions initiated by a user, a guide, and/or the search system 1530 via the guide systems 1505, 1510, the resources 1555, 1560 and/or the resource systems 1545, 1550, and/or the network 1515. Any resource system (e.g., the resource systems 1545, 1550) may be operated by a human provider of information and/or may be an automated system which may provide a result and/or other information to a guide and/or a user. For example, a resource may be a search engine, a database, a system which may perform tasks such as image recognition, voice recognition, translation, transcription, or other forms of information processing, a local information source of a guide system such as a disk or removable memory, an application and/or database accessible from a user system, and/or a guide system, etc. A resource may not be accessible using the network 1515. For example, a resource such as the resource 1555 may be accessible to a guide operating a guide system such as the guide system 1505, or a resource such as the resource 1560 may be accessible to a user operating a user system such as the user system 1535. A resource might include printed materials, images, video, and/or audio information, a software application, any information accessible to a guide, and/or a user, a database, and/or any combination thereof.

The network 1515 (FIG. 15) may be a global public network of networks (the Internet) and/or consist in whole or in part of one or more private networks and communicatively couples the guide systems 1505, 1510, the third party system 1565, the resource systems 1545, 1550 and the user systems 1535, 1540 with the other components of the system such as the search system 1530, and the database 1520. The network 1515 may include one or more wireless networks which may enable wireless communication between the various elements of the system 1500. For example, a mobile phone carrier network might be used to connect a user device to the search system 1530.

The search system 1530 allows interaction to occur among the guide systems 1505, 1510, the third party system 1565, the resource systems 1545, 1550 and the user systems 1535, 1540. For example, an information search query can be transmitted from the user systems 1535, 1540 to the search system 1530, where a search query can be accessed by the guide systems 1505, 1510 and/or the resource systems 1545, 1550. Similarly, a result produced from the resource systems 1545, 1550 including results produced using the guide systems 1505, 1510 in response to a search query submitted by the user systems 1535, 1540 may be transmitted to the search system 1530, where it may be stored by the search system 1530 and/or may be transmitted to the user systems 1535, 1540 or the third party system 1565.

The search system 1530 is communicatively coupled with the database 1520. As will be described herein in further detail below, the database 1520 includes data that is processed in association with operation of the embodiments. Although FIG. 15 illustrates the database 1520 as a separate component of the system, the database 1520 may be integrated with the search system 1530. Further, the records maintained in the database 1520 may be stored in any typical manner, including in a Network Attached Storage (NAS), a Storage Area Network (SAN), etc., using any typical or proprietary database software such as DB2®, Informix®, Microsoft® SQLServer™, MySQL®, Oracle®, etc., and may also be a distributed database on more than one server. Elements of the database 1520 may reside in any suitable elements of the system 1500.

The user systems 1535, 1540, the guide systems 1505, 1510, the third party systems 1565, the search system 1530 and the resource systems 1545, 1550 may include equipment, software, systems and personnel required to send and/or receive messages between a user system, a guide system, a third party, a resource system and/or the search system using the network 1515. The database 1520 includes information which may allow the search system 1530 to establish communication between the other elements of the system 1500.

A user system, a guide system, a third party system and/or a resource system may be a desktop or laptop PC or Mac®, a mobile phone, a smart phone, a PDA, a server system, a landline phone, a specialized communication terminal, a terminal connected to a mainframe, or any other communication device. The search system 1530 may include one or more servers, computers, etc. For example, servers such as the PowerEdge® 2900 by Dell, or the BladeCenterJS22 by IBM, or equivalent systems might be used to implement elements of the search system 1530. The search system 1530 may utilize an operating system (OS) such as Microsoft Windows XP, or Linux, etc. Voice routing and packet switching may be accomplished using well established technologies such as those provided by Cisco, or other networking companies. After being presented with the disclosure herein, one of ordinary skill in the relevant art will immediately realize that any viable computer system or communication device in the art may be used as user systems, guide systems, third party systems, resource systems, and/or to implement the search system 1530.

A guide may be required to register with the search system 1530. As part of a registration process, at least one communication method is associated with a guide. In at least one embodiment, a guide may register with the search system 1530 and establish a username and password which are associated with the guide. A guide may login to the search system 1530 using a web browser functionality of guide system 1505 in order to communicate with the search system 1530. Multiple communication services may be associated with a guide and may allow a communication session to be established between a guide system such as the guide system 1505 and a user system, a third party system, a resource system and/or the search system 1530. Multiple identifiers of a guide may be associated with each other. Information such as IM credentials, an email address, a phone number, a URL, a username, etc. of a guide may be identified which may allow the search system 1530 to establish a communication session between a guide system and a user system, a third party system, a resource system, and/or the search system 1530.

When a guide registers with the search system 1530 the guide may be associated with one or more keywords, categories, and/or other information. For example a keyword or category may be selected by a guide, or may be associated with a guide based on a test administered to a guide and/or other information provided or collected during and/or after a registration process. Information associated with a guide may be stored in the database 1520 and may be used for purposes such as matching a guide to a user request, determining and/or assigning security permissions associated with a guide, determining and/or providing compensation for a guide, communicating with a guide, etc., as will be described further herein below. Association with a category and/or keyword and/or other information may be used to select a guide for a task.

A user may be identified by the search system 1530. When a user system such as the user system 1535 establishes a communication session with the search system 1530, an identifier of a user system is determined. An identifier of a user system may be associated with other information regarding a user. A user system may be identified using an email address, a telephone number, an IM credential, a username, or any other identifier which may be used to associate information with a user. Multiple identifiers of a user may be associated with each other. Using information of communication services associated with a user, a communication session may be established between a user system such as the user system 1535 and a guide system, a resource system and/or the search system 1530. Information such as a keyword, a category, a user profile, a previous search request, a search result, etc., may be associated with a user. Information of a user may be stored in the database 1520.

A third party system may be associated with the search system 1530. If a third party system such as third party system 1565 conducts a communication session with the search system 1530 established at the request of a user system such as user system 1535, a guide system such as guide system 1505, and/or the search system 1530, a third party system may communicate directly or indirectly with any number of these systems. A third party system may be identified by an ID within the system, and/or the third party system may be contacted on a per request basis. Information associated with a third party may be stored in the database 1520 and may be used for purposes such as matching a user request to a third party, determining and/or providing secure transactions via the search system 1530, and/or communicating with a guide, trustee or concierge, etc. In at least one embodiment, a third party system is registered with the search system 1530. A third party system may be associated with indexing information such as a category, a keyword, a profile, etc. which may be used to select a third party and/or a guide or a trustee to respond to a request associated with the third party.

A resource, which may be a person, an entity, a search engine, a database, a software application, a corpus of one or more types of media such as text or printed information, images, audio, video, etc. or a combination thereof, may be identified by the search system 1530. Information of at least one method of communication is associated with a resource system which allows a communication session to be established between the search system 1530, a user system and/or a guide system and a resource system such as the resource systems 1545, 1550. An identifier of a resource system may be associated with other information regarding a resource. A resource system may be identified using an email address, a telephone number, an IM credential, a resource username, a URL or other persistent identifier which may be used to associate information with a resource. Multiple identifiers of a resource may be associated with each other. Using the information of communication services associated with a resource, a communication session may be established between a resource system such as the resource system 1545 and a user system, a guide system, and/or the search system 1530. Information such as a keyword, a category, a profile, or other information may be associated with a resource. Information of a resource may be stored in the database 1520.

A resource such as the resource 1555 and/or resources accessible via the resource systems 1545, 1550 may include any system, software, hardware, personnel and/or other facility which may provide information to a guide, a user, and/or the search system 1530. For example, a resource may be a search engine, a database system, a library, a personal hard drive and/or other local storage, printed materials, recordings of any sort, a software program, a person or person, an organization, etc. A resource may be freely accessible to any user and/or guide and/or may be available on a restricted basis. The resource system 1545, 1550 may include resources which are available on an unrestricted and/or restricted basis. A resource may not be accessible using the network 1515, but may be accessible to a guide and/or a user. For example, a resource such as the resource 1555 may be accessible to one or more guides operating a guide system such as the guide system 1505 using any type of communication. For example, a guide may obtain information of an event to provide a search result. Information in any form, such as printed media, audio and/or visual information, software, hardware, etc., which may be accessible to a guide, a user and/or an operator of a resource system may be a resource. Similarly, a resource such as the resource 1560 may be accessible to a user at the user system 1535. For example, the resource 1560 may be a software application and/or database which may in whole or in part be accessible by the user system 1535.

The search system 1530 may establish a communication session between any user system, guide system, third party system, or resource system using information indicated in the database 1520. For example, the user system 1535 may establish a voice communication session with the search system 1530, the search system 1530 may establish a voice communication session between the user system 1535 and the guide system 1505, and the search system 1530 may establish a voice communication session between the guide system 1505 and the third party system 1565 or between the user system 1535 and the resource system 1545. While a voice communication session is used in this example, any type of communication session using one or more services such as SMS, EMS, MMS, email, IM, chat, web-based communication, etc., may be established between any user system, guide system, third party system, and/or resource system and/or the search system 1530.

Information associated with a user, a guide, third party and/or a resource may be obtained in various ways. For example, a registration process may be performed using a web form provided by the search system 1530, information may be obtained from an external database, and/or information may be obtained based on analysis of information indicated by a user, a guide, and/or a resource. A ‘profile’ is one or more characteristics which may be associated with one or more individuals. A profile may include geographic data such as a street address, latitude and longitude, etc., may include demographic information such as age, gender, race, income, family size, political affiliations, etc., may include personality information such as results of psychometric testing, subjective evaluations of an individual, etc., may include affiliation information such as employment, club, activity, societal membership information, information of a device, service, transaction or any other information which might be associated with a user and/or a guide.

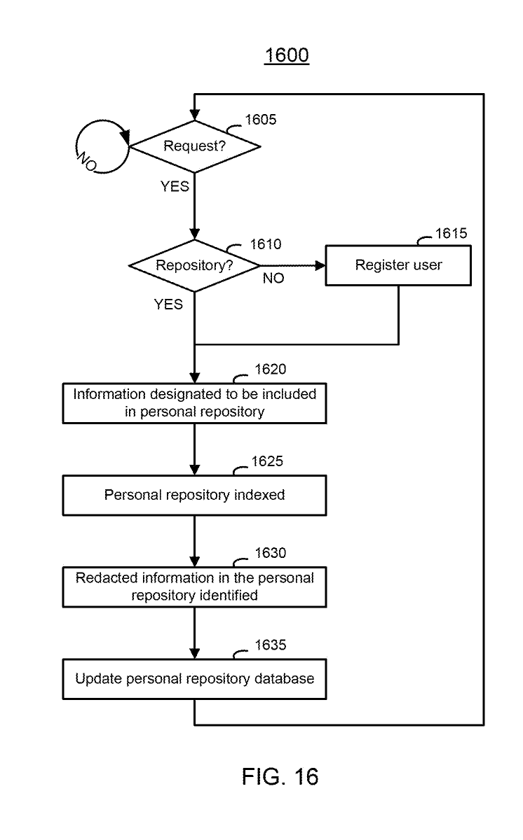

As illustrated in FIG. 16, a process 1600 for creating and updating a repository of redacted information is provided. The process 1600 may be operative on a server associated with the search system 1530, and/or a user system such as the user system 1535.

In operation 1605 (FIG. 16) a determination is made as to whether a request is received. If it is determined in operation 1605 that a request is not received control remains at operation 1605 and process 1600 continues. If it is determined in operation 1605 that a request is received, control is passed to operation 1610 and process 1600 continues.

The determination in operation 1605 may be made based on various criteria. It may be determined that a request is received based on receiving a message at any device. For example, a voice message might be received at a telephone number, a text message might be received, an IM might be received, an email might be received, a web request might be received, and/or a message using any services and/or devices associated with the search system 1530 (FIG. 15) might be received and processed to determine whether a request has been received. In at least one embodiment, if a user provides personal information to a trustee, it may be determined that a request to create and/or update a repository of redacted information has been received.

In operation 1610 (FIG. 16) a determination is made as to whether a repository of redacted information is associated with a user submitting the request. If it is determined in operation 1610 that a repository of redacted information is not associated with a user, control is passed to operation 1615 and process 1600 continues. If it is determined in operation 1610 that a repository of redacted information is associated with a user, control is passed to operation 1620 and process 1600 continues.

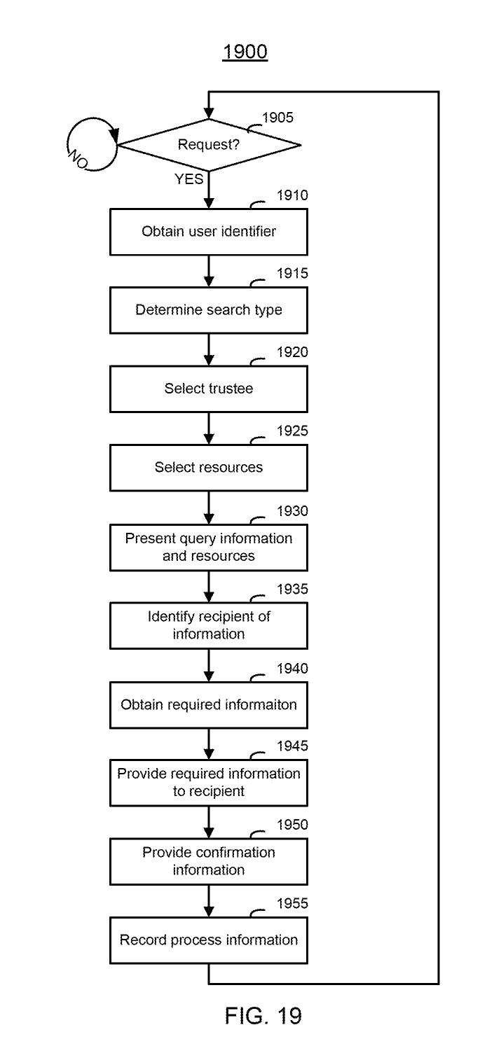

The determination in operation 1610 may be made based on various criteria. In at least one embodiment, information indicated in a user record such as the user record 1900 (FIG. 19) may be used to determine if a repository of redacted information is associated with a user. For example, a username associated with a user may be utilized in accessing information in a corresponding user record. Likewise, a communication service associated with a user may be used to determine whether a repository of redacted information is associated with a user.

In operation 1615, a user is registered with the system. A user may, for example, be required to provide personal information, which may be used to verify the identify of the user, and may be used to associate a communication service with the user which may be used to access information associated with the user. In at least one embodiment, a web form may be provided by the search system 1530 (FIG. 15) in order that a user may register with the search system 1530. In at least one embodiment, a user may be able to register by a voice, text, IM or email service. Control is passed to operation 1620 and process 1600 continues.

In operation 1620, a user designates information which is to be included in a repository of redacted information. For example, a user may designate various items which are to be indexed in order to allow a searcher or guide to locate information in the repository of redacted information. Alternatively, items may be automatically included in a repository of redacted information based on any number of factors. For example, a number or other information that associated with payment information such as information associated with a bank account, credit card, debit card, etc. may automatically be designated as personal or private information to be included in a user's repository of redacted information by the search system 1530. Items designated by a user or identified by the search system 1530 may or may not be stored in the database 1520 (FIG. 15). Some or all items designated or identified may remain in local storage associated with a user system. Likewise, a user may elect to identify items which are currently included in a repository of redacted information which are to be removed from the repository index. In such an instance, the item itself is not necessarily deleted, but associations between the item and the index of a redacted information repository may be deleted. Control is passed to operation 1625 and process 1600 continues.

In operation 1625 an index of items indicated in the repository of redacted or personal information is updated. Items which are included in a repository may be scanned using a search facility which may create various types of indexes of information indicated in the repository. For example, structured documents such as a .pst file, which may include email data, contacts, calendar data, etc., may be indexed based on content of any or all elements or fields which are included in a database structure associated with a file. Information associated with any sort of object may be indexed based on the content of an element of the object. For example, the body, the title, etc. of a document such as a spreadsheet, a text file, etc. may be scanned for keywords. Media files such as image, audio and video files may be scanned to locate tags and/or other metadata associated with the files, or music files may be scanned and/or analyzed to associate metadata with the content of a file, etc. In addition, in operation 1620, or at another stage in process 1600, a user may have the option to designate and/or define an index entry for a particular file, element, or other information designated to be included in a personal repository. For example, user designated information that may be scanned to create various types of indexes of information which have been automatically indexed may be identified by a user to be more desirably indexed based on any designation that a user provides. If no index exists associated with a user repository, a new index may be created. An index of the repository may be used for various purposes as further describe herein. Control is passed to operation 1630 and process 1600 continues.

In operation 1630, redacted information associated with information and items included in the repository is identified. For example, fields associated with a particular type of information in structured data may default to being redacted, such as content of any or all fields in a .pst file. Content may be identified as redacted by a user, may be automatically redacted based on any of the search service settings, and/or any new content added to the repository may default to having such fields redacted. Alternately, an unstructured document may be indexed and a user may be allowed to select information which is to be redacted. For example, a text document might be scanned and a list of keywords located in the document might be created. A user might designate that any names and/or named entities included in a group of contacts, and/or other information associated with the group of contacts should be redacted from unstructured documents. For example, meeting notes might be redacted to prevent the names of persons in a business contact list from being revealed to a guide. Content of a redacted record index element is illustrated in FIG. 23. Control is passed to operation 1635 and process 1600 continues.

In operation 1635 the database of information associated with the redacted information repository is updated. For example, if an item is removed from the index, any fields which contain a pointer to the item may have that pointer removed, information of an item and indexing information associated with the item may be recorded, information regarding conditions under which content of an item may be provided to a guide and/or trustee may be recorded, and/or information of fields associated with a type of item may be recorded. Any or all information which may be modified based on the designation, identification, and/or indexing conducted as part of the process 1600 may be recorded. Control is passed to operation 1605 and process 1600 continues.

The process 1600 may be applied to any type of item which an indexing facility may be capable of processing. An item which has been added to a resource which may for example be the resource 1560 (FIG. 15) which is accessible to a user may be identified and presented to a user to determine whether a user wishes to add the item to the redacted information repository. A user may, for example, designate that any or all items of a given type should be added to the redacted information repository and that the index of the repository should be updated if a user accesses and/or modifies any items associated with the repository. Alternatively, the search system 1530 may designate that any or all items of a given type should be added to the redacted information repository and that the index of the repository should be updated if the search system automatically modifies any of the items associated with the repository.

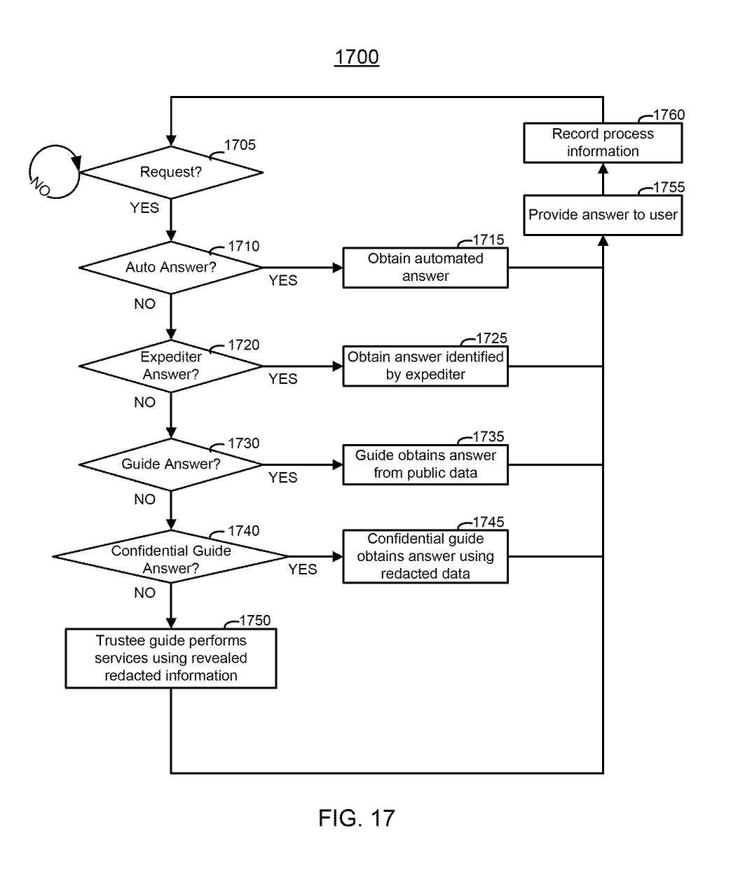

As illustrated in FIG. 17, a process 1700 for processing a request is provided. The process 1700 may be operative on a server associated with the search service 1530 (FIG. 15).

In operation 1705 (FIG. 17) a determination is made as to whether a request for information indicated is received. If it is determined in operation 1705 that a request for information is not received control remains at operation 1705 and process 1700 continues. If it is determined in operation 1705 that a request for information is received, control is passed to operation 1710 and process 1700 continues.

The determination in operation 1705 may be made based on various criteria. It may be determined that a request is received based on receiving a message at a device or system. For example, a voice message might be received at a telephone number, an SMS message might be received, an IM might be received, an email might be received, a web request might be received, and/or a message using any services and/or devices associated with the search system 1530 might be used to determine that a request for information is received. In at least one embodiment, a condition which has been identified based on information indicated in the database 1520 (FIG. 15) may be used to determine whether a request for information is received. In at least one embodiment, a transfer of a request by a guide may determine whether a request is received.

In operation 1710 a determination is made as to whether an automated response to a request is available. If it is determined in operation 1710 that an automated response to a request is available control is passed to operation 1715 and process 1700 continues. If it is determined in operation 1710 that an automated response to a request is not available, control is passed to operation 1720 and process 1700 continues.

The determination in operation 1710 may be made using various criteria. For example, if a matching of a request to a database of prior requests meets a pre-determined confidence level, it may be determined that an automated response to a request is available. Various forms of processing may be applied to a request in order to determine whether an automated response to a request is available.

In operation 1715 an automated response to a request is obtained. For example, a previous response to a request which is determined to be identical to the request may be provided as result. Similarly, if a request is found to be suitable for a response from an automated resource such as a database, a news feed, a Really Simple Syndication (RSS) feed, a software program, or other resource which may be accessible via an API, a result may be provided based on information from the automated resource. Any resource available may be used to obtain a response to a request. Control is passed to operation 1755 and process 1700 continues.

In operation 1720 a determination is made as to whether an expediter response to a request is available. If it is determined in operation 1720 that expediter response to a request is available control is passed to operation 1725 and process 1700 continues. If it is determined in operation 1720 that expediter response to a request is not available, control is passed to operation 1730 and process 1700 continues.

The determination in operation 1720 may be made using various criteria. For example, an expediter or ambassador guide who may be provided with tools which allow the expediter to rapidly process, categorize, formulate, and respond using automated resources may determine whether an expediter response is available. For example, a method and system such as those described in the related U.S. application Ser. No. 12/275,864 and/or U.S. application Ser. No. 12/434,385 previously mentioned may be utilized. In at least one embodiment, automated processing of a request may be used to determine whether an expediter response to a request is available. For example, historical information associated with a user submitting a request may be used to determine whether an expediter answer is available. For example, if a previous request has required a confidential guide and/or a trustee, it may be determined that an expediter response to a request is not available.

In operation 1725 an expediter response to a request is obtained. For example, a previous response to a request which is determined to be equivalent to the request by an expediter may be provided as result. Similarly, if a request is found to be suitable for a response from an automated resource such as a database, a news feed, a Really Simple Syndication (RSS) feed, a software program, or other resource which may be accessible via an API, a result may be provided based on information from the automated resource. Control is passed to operation 1755 and process 1700 continues.

In operation 1730 a determination is made as to whether a guide response to a request is appropriate. If it is determined in operation 1730 that guide response to a request is appropriate control is passed to operation 1735 and process 1700 continues. If it is determined in operation 1730 that a guide response to a request is not appropriate, control is passed to operation 1740 and process 1700 continues.

The determination in operation 1730 may be made using various criteria. For example, an expediter or ambassador guide who may be provided with tools which allow the expediter to rapidly process, categorize, formulate, and respond using automated resources may determine whether a guide response is appropriate. For example, a method and system such as those described in the related U.S. application Ser. No. 12/275,864 and/or U.S. application Ser. No. 12/434,385 previously mentioned may be utilized. In at least one embodiment, automated processing of a request may be used to determine whether a guide response to a request is appropriate. For example, historical information associated with a user submitting a request may be used to determine whether a guide answer is possible to obtain. For example, if a previous request has required a confidential guide and/or a trustee, it may be determined that a guide response to a request is not likely to be obtained.

In operation 1735 a guide response to a request is obtained. For example, a guide may be selected, and provided with resources and/or other information of a request as further described herein. Control is passed to operation 1755 and process 1700 continues.

In operation 1740 a determination is made as to whether a confidential guide response to a request is appropriate for the request. If it is determined in operation 1740 that confidential guide response to a request is appropriate control is passed to operation 1745 and process 1700 continues. If it is determined in operation 1740 that a confidential guide response to a request is not appropriate, control is passed to operation 1750 and process 1700 continues.

The determination in operation 1740 may be made using various criteria. For example, an expediter or ambassador guide who may be provided with tools which allow the expediter to rapidly process, categorize, formulate, and respond using automated resources may determine whether a confidential guide response is appropriate. For example, a method and system such as those described in the related U.S. application Ser. No. 12/275,864 and/or U.S. application Ser. No. 12/434,385 previously mentioned may be utilized. In at least one embodiment, automated processing of a request may be used to determine whether a confidential guide response to a request is appropriate or likely to be available. For example, historical information associated with a user submitting a request may be used to determine whether a guide answer is possible to obtain. For example, if a previous request has required a confidential guide and/or a trustee, it may be determined that a guide response to a request is not likely to be obtained. Similarly, if a guide has requested to transfer a request to a confidential guide, it may be determined that a confidential guide response to a request is appropriate.

In operation 1745 a confidential guide response to a request is obtained. For example, a confidential guide may be selected, and provided with resources and/or other information of a request as further described herein. For example, a confidential guide may be provided with limited access to a repository of redacted information associated with a user submitting a request. Control is passed to operation 1755 and process 1700 continues.

In operation 1750 a trustee guide response to a request is obtained. For example, a trustee guide may be selected, and provided with resources and/or other information of a request as further described herein. For example, a trustee guide may be provided with selective access to a repository of redacted information associated with a user submitting a request. Control is passed to operation 1755 and process 1700 continues.

In operation 1755 a search result or response is provided to a user. A result may include any number of messages, may include any number of advertisements, and may be delivered using any communication device and/or service associated with a user. Control is passed to operation 1760 and process 1700 continues.

In operation 1760 information of the process 1700 is recorded. In at least one embodiment, information indicated in the database 1520 (FIG. 15) may be recorded, modified, and/or deleted. Information of a guide, a user, a request, an expediter, a supplier, a resource, a trustee, a keyword, a category, a profile, and associations thereof maybe recorded and/or modified. As previously mentioned herein above, elements of the database 1520 may be resident in any suitable systems within the system 1500 and any storage comprised in whole or in part within a resource system, a user system and/or a guide system may be considered to be an element of the database 1520 in at least one embodiment. Control is passed to operation 1705 and process 1700 continues. Alternatively, a user may request that information be retrieved by a guide instead of being provided an automated answer at operation 1705, in which case process 1700 does not require operation 1710 of providing an automated answer.

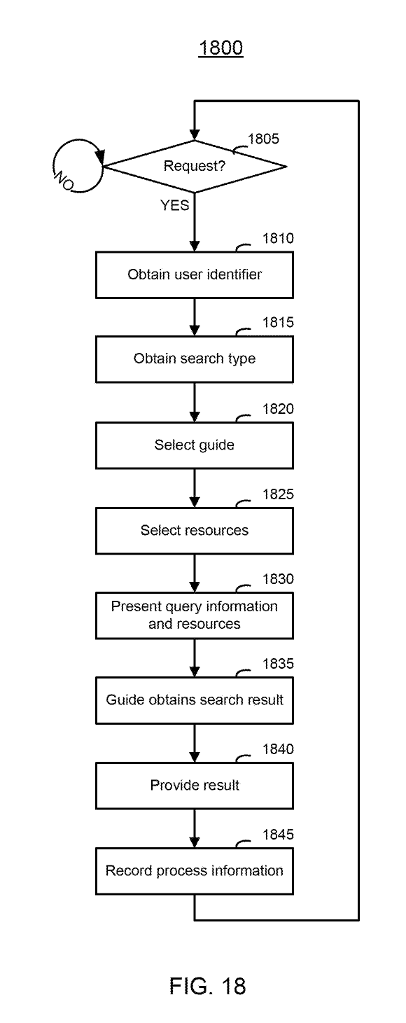

As illustrated in FIG. 18, a process 1800 for performing a search utilizing a guide who may be able to access redacted information is provided. The process 1800 may be operative on a server associated with the search service 1530 (FIG. 15) and/or on a guide system such as the guide system 1505 (FIG. 15).

In operation 1805 (FIG. 18) a determination is made as to whether a request for a search by a guide is received. If it is determined in operation 1805 that a request for a search by a guide is not received control remains at operation 1805 and process 1800 continues. If it is determined in operation 1805 that a request for a search by a guide is received, control is passed to operation 1810 and process 1800 continues.

The determination in operation 1805 may be made based on various criteria. It may be determined that a request is received based on receiving a message at a device or system associated with the search system 1530 (FIG. 15). For example, a voice message might be received at a telephone number, an SMS message might be received, an IM might be received, an email might be received, a web request might be received, and/or a message using any services and/or devices associated with the search system 1530 might be used to determine that a request for a search by a guide has been received. In at least one embodiment, a condition which has been identified based on information indicated in the database 1520 (FIG. 15) may be used to determine whether a request for information indicated in a redacted information repository is received. In at least one embodiment, a message provided by a process such as the process 1700 (FIG. 17) may be used to determine that a request for a search using a guide has been received.

In operation 1810, an identifier of a user associated with a request is obtained. In at least one embodiment, a persistent identifier of a user is obtained such as a telephone number, or a login ID or username, or an identifier associated with a communication service and/or devices associated with a user may be obtained. A user identifier may be used to identify information associated with a user, such as an index of a redacted information repository. A user may be required to provide security and/or identity verification information in order to gain access to a search result obtained from information indicated in a redacted information repository. Any type of security systems such as a CAPTCHA, biometrics, etc., may be used for verification of user identity. Control is passed to operation 1815 and process 1800 continues.

In operation 1815 information of a type of search required is obtained. In at least one embodiment, a message received is analyzed to determine whether a guided search requires access to a repository of redacted information. A type of search requested may be used to select a guide to respond to the request.

In operation 1820 a guide (a searcher) is selected. A guide (searcher) may be selected in various ways. Information associated with a request may be used to rank searchers to respond to the request. In at least one embodiment, any guide who is not authorized to access and respond to a request associated with a type of information, a user, a location, or other criteria may be excluded from a ranking of guides to respond to a request which requires access to the designated information such as redacted information of a user. A guide may be ranked based on a profile, a keyword and/or category, a user, historical information, advertisements, etc. A searcher ranked to respond to a request may be notified of a request in an order based on a ranking of the searcher, and a first searcher to respond to a notification may be selected. In embodiments, a searcher may be selected based on availability and/or priority of tasks associated with the searcher. Methods for selection of a searcher are further described in the related U.S. application Ser. No. 12/109,776 previously mentioned. Control is passed to operation 1825 and process 1800 continues.

In operation 1825 resources to be provided to a searcher are selected including based on a rank of the resources. A resource may be ranked in various ways. In at least one embodiment, if it is determined that a search request requires redacted access to a repository of private information, a search resource associated with a repository of private information may be ranked highest. A search resource may be ranked based on a keyword and/or category, a profile, payment information, etc. which is associated with a request. Methods for selection of a resource are further described in the related U.S. application Ser. No. 12/109,776 previously mentioned. Control is passed to operation 1830 and process 1800 continues.

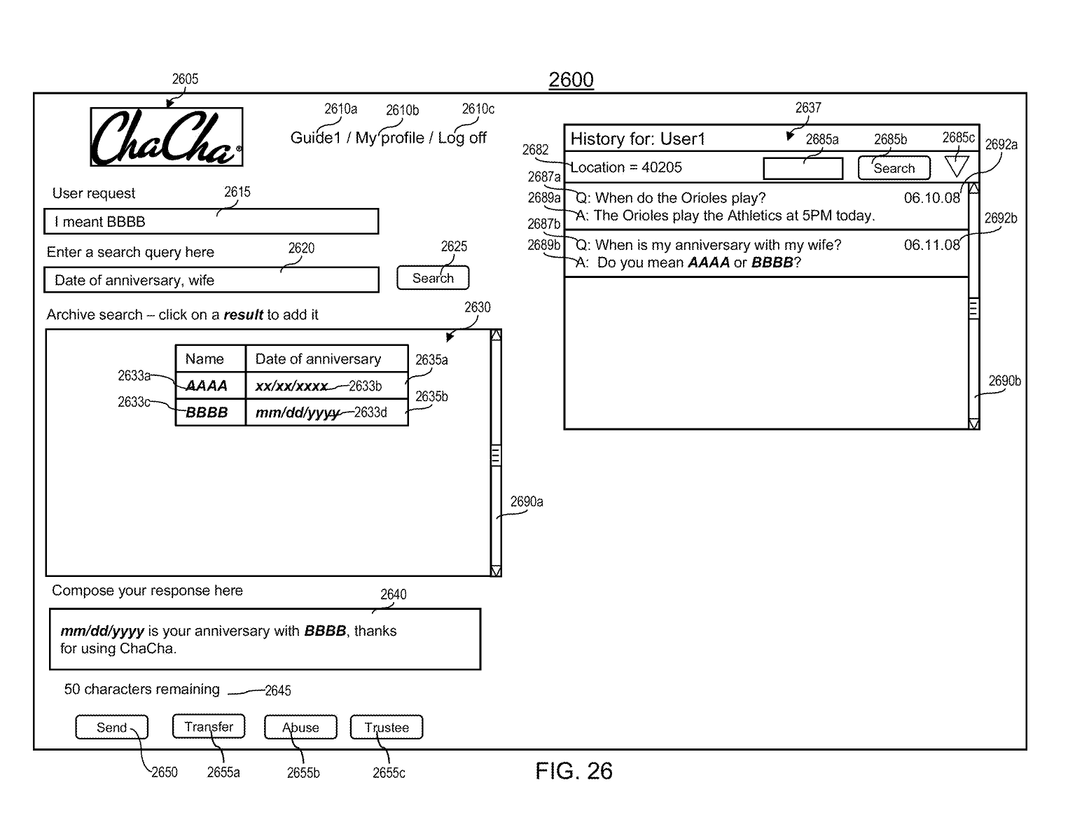

In operation 1830 information of a request, resources and/or other information related to a request are provided to a selected searcher. Any type of information may be provided to a searcher, which may be used to respond to a user request. In at least one embodiment a GUI such as the GUI's described in FIG. 26 to FIG. 28 herein may be provided to a searcher. Control is passed to operation 1835 and process 1800 continues.

In operation 1835, a guide obtains a search result. A search may be performed utilizing any information provided in operation 1830 and/or other resources. For example, a searcher may query a database, perform a search using a search engine, review web pages, etc. A guide may query a database associated with an index of a repository of redacted and/or private information, etc. A search result may include any suitable media and/or type of information. Control is passed to operation 1840 and process 1800 continues.

In operation 1840 a search result is provided. For example, a searcher may select information of one or more items indicated in a search result obtained in operation 1830 which may be presented to a user. The actual content of a search result may not be presented to a searcher; however, the searcher may identify a pointer to information indicated in a redacted information record which may cause the redacted information which is not revealed to the guide to be presented to a user. An exemplary GUI for conducting a search using redacted indicators is illustrated in FIG. 26. A search result may be provided to the search system 1530 (FIG. 15) which may store information of a search result in the database 1520. Control is passed to operation 1845 and process 1800 continues.

In operation 1845 information of the process 1800 is recorded. In at least one embodiment, information indicated in the database 1520 (FIG. 15) may be recorded, modified, and/or deleted. Information of a guide, a user, a request, an expediter, a supplier, a resource, a trustee, a keyword, a category, a profile, and associations thereof may be recorded and/or modified. As previously mentioned herein above, elements of the database 1520 may be resident in any suitable systems within the system 1500 and any storage comprised in whole or in part within a resource system, a user system and/or a guide system may be considered to be an element of the database 1520 in at least one embodiment. Control is passed to operation 1805 and process 1800 continues.

As illustrated in FIG. 19, a process 1900 for performing a search utilizing a guide who may be able to reveal redacted information is provided. The process 1900 may be operative on a server associated with the search service 1530 (FIG. 15) and/or on a guide system such as the guide system 1510 (FIG. 15).

In operation 1905 (FIG. 19) a determination is made as to whether a request for a search by a trustee is received. If it is determined in operation 1905 that a request for a search by a trustee is not received control remains at operation 1905 and process 1900 continues. If it is determined in operation 1905 that a request for a search by a trustee is received, control is passed to operation 1910 and process 1900 continues.

The determination in operation 1905 may be made based on various criteria. It may be determined that a request is received based on receiving a message at a device or system associated with the search system 1530 (FIG. 15). For example, a voice message might be received at a telephone number, an SMS message might be received, an IM might be received, an email might be received, a web request might be received, and/or a message using any services and/or devices associated with the search system 1530 might be used to determine that a request for a search by a trustee has been received. In at least one embodiment, a condition which has been identified based on information indicated in the database 1520 (FIG. 15) may be used to determine whether a request for information indicated in a redacted information repository is received. In at least one embodiment, a message provided by a process such as the process 1700 (FIG. 17) may be used to determine that a request for a search using a trustee has been received.

In operation 1910, an identifier of a user associated with a request is obtained. In at least one embodiment, a persistent identifier of a user is obtained such as a telephone number, or a login ID or username, or an identifier associated with a communication service and/or devices associated with a user may be obtained. A user identifier may be used to identify information associated with a user, such as an index of a redacted information repository. A user may be required to provide security and/or identity verification information in order to gain access to a search result obtained from information indicated in a redacted information repository. Any type of security systems such as a CAPTCHA, biometrics, etc., may be used for verification of user identity. Control is passed to operation 1915 and process 1900 continues.

In operation 1915 information of a type of search required is obtained. In at least one embodiment, a message received is analyzed to determine whether a trustee search requires revealing information indicated in a repository of redacted information. A type of search requested may be used to select a guide to respond to the request. In at least one embodiment, a type of information which is to be revealed may be used to select a guide and/or trustee.

In operation 1920 a trustee is selected. A trustee may be selected in various ways. Information associated with a request may be used to rank trustees to respond to the request. In at least one embodiment, any trustee who is not authorized to reveal information associated with a type of information, a user, a location, or other criteria may be excluded from a ranking of trustees to respond to a request which requires access to the designated information such as financial, medical, legal, etc. information of a user. A trustee may be ranked based on a profile, a keyword and/or category, a user, historical information, advertisements, etc. A trustee ranked to respond to a request may be notified of a request in an order based on a ranking of the trustee, and a first trustee to respond to a notification may be selected. In embodiments, a trustee may be selected based on availability and/or priority of tasks associated with the searcher. Methods for selection of a searcher are further described in the related U.S. application Ser. No. 12/109,776 previously mentioned. Control is passed to operation 1925 and process 1900 continues.

In operation 1925 resources to be provided to a trustee are selected including based on a rank of the resources. A resource may be ranked in various ways. In at least one embodiment, if it is determined that a search request requires revealing information indicated a repository of private information, a search resource associated with a repository of private information may be ranked highest. A search resource may be ranked based on a keyword and/or category, a profile, payment information, etc. which is associated with a request. Methods for selection of a resource are further described in the related U.S. application Ser. No. 12/109,776 previously mentioned. Resources may include information of providers who may be ranked based on performance, location, commercial considerations, etc. Control is passed to operation 1930 and process 1900 continues.

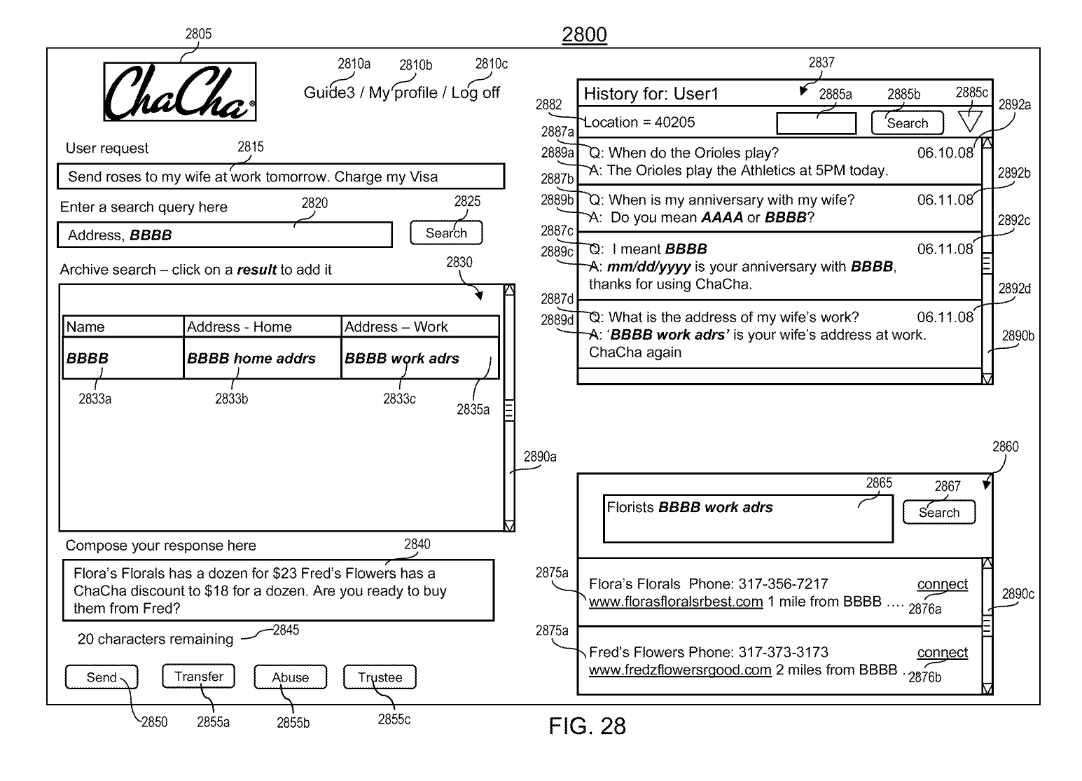

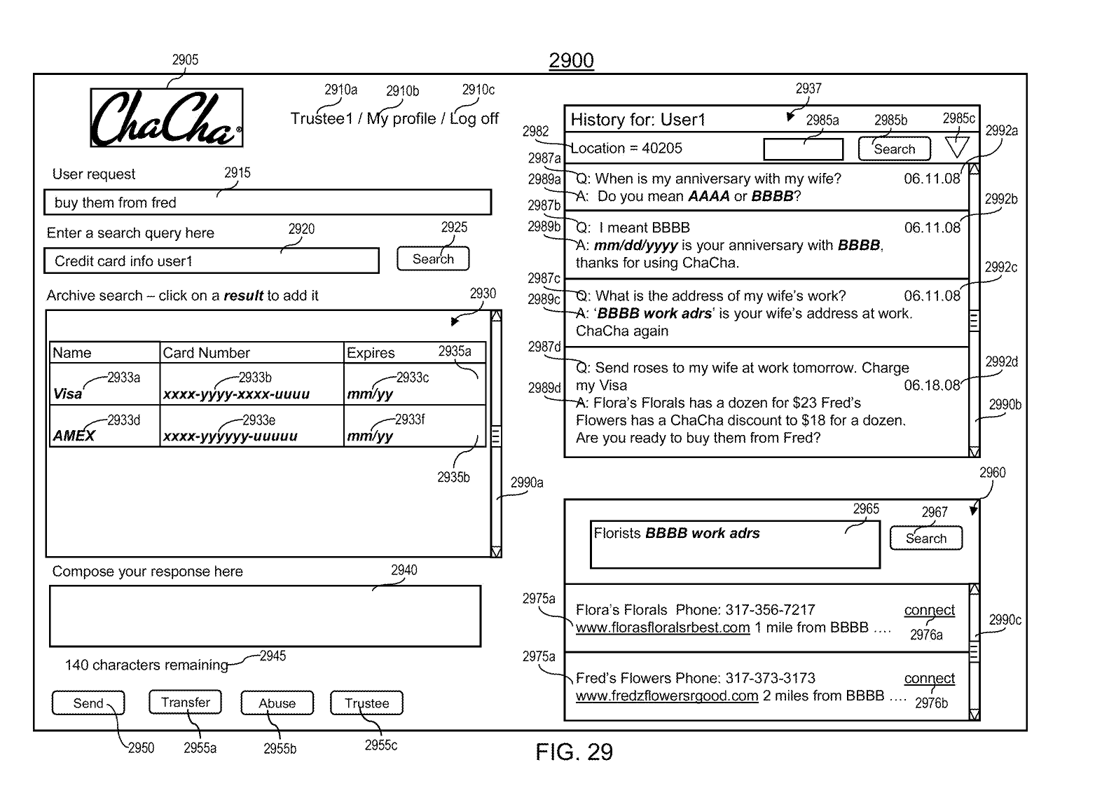

In operation 1930 information of a query (request), resources and/or other information related to a request are provided to a selected trustee. Any type of information may be provided to a guide or trustee, which may be used to respond to a request. In at least one embodiment a GUI such as the GUI's described in FIG. 28 and FIG. 29 herein may be provided to a trustee. Control is passed to operation 1935 and process 1900 continues.

In operation 1935, a recipient of revealed information is identified. A search may be performed utilizing any information provided in operation 1930 and/or other resources. For example, a searcher may query a database, may perform a search using a search engine, may review web pages, etc. For example a trustee may select a provider of information and/or services using a resource provided. In at least one embodiment, a trustee may be a recipient of the revealed information. In at least one embodiment, a third party designated in content of a request maybe a recipient of the revealed information. In at least one embodiment, a third party previously selected, such as a provider selected by the search system, a guide, a resource, etc. may be a recipient of the revealed information. Control is passed to operation 1940 and process 1900 continues.

In operation 1940 any information required to respond to a request is obtained. For example, a trustee may reveal information of one or more items indicated in a search result obtained from a repository of redacted information. The actual content of a search result may be provided to a trustee. Information in a redacted record may be revealed when explicitly requested by a trustee, which may allow tracking of which information has been revealed and provided for audit purposes. Additionally, data which has been revealed to a trustee may affect a ranking of a trustee when responding to a request. An exemplary GUI for conducting a search which may reveal redacted information is illustrated in FIG. 28. A trustee may interact with an intended recipient of revealed information and/or a user associated with the redacted information in order to determine information to be revealed and permission to reveal the information. Control is passed to operation 1945 and process 1900 continues.

In operation 1945 any information which is required to fulfill a request with a recipient is provided. Information required may include revealed information, pointers to redacted information and/or information obtained from public and/or private resources, etc. For example, a trustee may provide financial, personal, and/or other information required in spoken, written, etc. forms. A trustee may obtain confirmation information from a recipient. Control is passed to operation 1950 and process 1900 continues.

In operation 1950 confirmation information is provided. For example, revealed information and/or pointers to information indicated in a repository of redacted information may be provided. In at least one embodiment, confirmation information from a provider may be provided to a user and/or the search system 1530 (FIG. 15). Control is passed to operation 1955 and process 1900 continues.

In operation 1955 information of the process 1900 is recorded. In at least one embodiment, information indicated in the database 1520 (FIG. 15) may be recorded, modified, and/or deleted. Information of a guide, a user, a request, an expediter, a supplier, a resource, a trustee, a keyword, a category, a profile, and associations thereof may be recorded and/or modified. As previously mentioned herein above, elements of the database 1520 may be resident in any suitable systems within the system 1500 and any storage comprised in whole or in part within a resource system, a user system and/or a guide system may be considered to be an element of the database 1520 in at least one embodiment. Control is passed to operation 1905 and process 1900 continues.

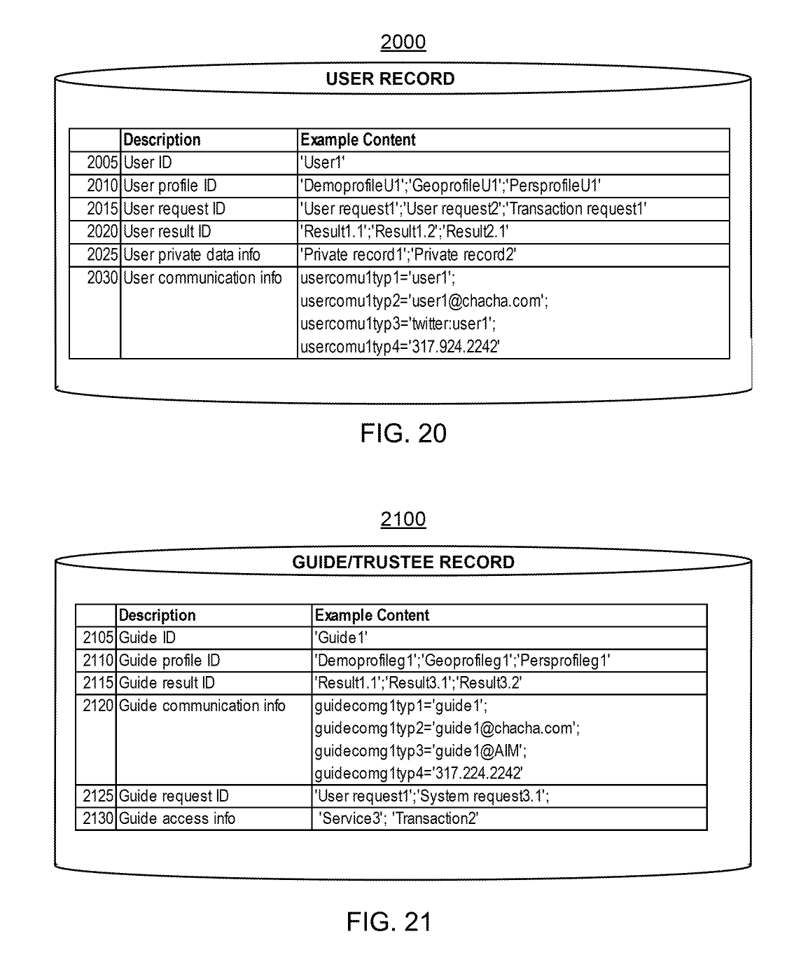

As illustrated in FIG. 20, an exemplary user record 2000 is provided, of which one or more may be associated with or resident in the search database 1520 (FIG. 15). The user record 2000 may include a user ID field 2005, a user profile ID field 2010, a user request ID field 2015, a user result ID field 2020, a user private data info field 2025, and a user communication info field 2030.

The user ID field 2005 preferably contains a unique identifier of a user, which is preferably used consistently. For example, in at least one embodiment, the user ID field 2005 can include a randomly generated numerical code, and/or a text string indicating a name associated with a user. A user ID serves to distinguish a user record associated with a user from a user record associated with other users. Other unique identifiers of a user may be utilized without departing from the spirit and scope of the embodiments. In at least one embodiment, a user ID may include a phone number associated with a user. Using the example illustrated in FIG. 20, ‘User1’ is the user ID associated with the user record 2000.

The user profile ID field 2010 may include information of a profile associated with a user. The content of the user profile ID field 2010 may be modified based on actions of a user. A person may select a profile which is associated with a user. For example, a user may select a profile to be associated with the user during a registration process. A profile may be associated with a user based on testing of a user and/or information from users. For example, a user may be required to demonstrate knowledge relevant to a profile in order to be associated with the profile, or a user may take a test which is used to generate a profile, or a user may provide information such as demographic, geographic, personality and/or other information which may be indicated in a profile associated with the user. Information indicated in a user profile may be obtained from an external database. A profile associated with a user may be used to select and/or rank a user for voting. Using the example illustrated in FIG. 20, the profiles ‘DemoprofileU1’, ‘GeoprofileU1’ and ‘PersprofileU1’ are associated with the user ‘User1’. This may indicate that ‘User1’ has indicated and/or generated the profiles ‘DemoprofileU1’ which may be a demographic profile, ‘GeoprofileU1’ which may be a geographic profile and ‘PersprofileU1’ which might indicate personality information regarding the user ‘User1’.

The user request ID field 2015 may include information of a request associated with a user. Content of the user request ID field 2015 may be modified based on actions of a user. If a user submits a search request to the search system 1530 (FIG. 15) an identifier of the search request may be included in the user request ID field 2015. Using the example illustrated in FIG. 20, the requests ‘User request1’, ‘User request2’ and ‘Transaction request1’ are associated with the user ‘User1’. This may indicate that ‘User1’ has submitted the search requests ‘User request1’ and ‘User request2’ and the transaction request ‘Transaction request1’ to the search system 1530 (FIG. 15).

The user result ID field 2020 may include information of a result associated with a user. Content of the user result ID field 2020 may be modified based on action of a user and/or a guide. If a user receives a search result responsive to a search request, an identifier of the search result may be included in the user result ID field 2020. A usage indicator associated with a search result provided to a user may affect a rating or ranking associated with a guide. Using the example illustrated in FIG. 20, the results ‘Result1.1’, ‘Result1.2’ and ‘Result2.1’ are associated with the user ‘User1’. This may indicate that ‘User1’ has been presented with the results ‘Result1.1’, ‘Result1.2’, and ‘Result2.1’ responsive to a search and/or transaction request.

The user private data info field 2025 may include information of items which may be included in a repository of redacted information. Content of the user private data info field 2025 may be modified based on actions of a user and/or the search system 1530 (FIG. 15). If a user designates and/or the search system 1530 determines an item to be included in a repository of redacted information, information of the item may be indicated in the user private data info field 2025. The content of the user private data info field 2025 may include any type of information which identifies an item. For example, a URL which allows access to an item, a pointer to an item in a database, or any other indicator of an item may be included in the user private data info field 2025. Any number of items may be indicated in the user private data info field 2025. Using the example illustrated in FIG. 20, the files ‘Private record1’and ‘Private record2’ are associated with the user ‘User1’. This may indicate that ‘User1’ has designated the items ‘Private record1’ and ‘Private record2’ to be included in a repository of redacted data.

The user communication info field 2030 may include information of a device and/or service associated with a user. Content of the user communication info field 2030 may be modified based on actions of a user. If a user establishes communications with the search system 1530 (FIG. 15) using a device and/or service, information regarding the device and/or service may be included in the user communication info field 2030. Any type of communication service and/or system may be indicated in the user communication info field 2030. For example, a username and/or password associated with a user may be indicated in the user communication info field 2030. Communication services such as Instant Messaging (IM), email, SMS, MMS, EMS, telephone, wireless or wired communication, etc., may be indicated in the user communication info field 2030. A telephone number, an email address, an IM provider and/or login ID, a keyword associated with a service, etc. may be indicated in the user communication info field 2030. Using the example illustrated in FIG. 20, the login ‘user1’, the email ‘user1@chacha.com’, the Twitter™ service account ‘twitteruser1’ and the phone number ‘317.924.2242’ are associated with the user ‘User1’. This may indicate that ‘User1’ may be contacted using the login ID ‘user1’, via email at ‘user1@chacha.com’, via Twitter as ‘user1’ and/or via voice, text, and/or other service associated with the phone number ‘317.924.2242’. Security information associated with a user account may be indicated in the user communication info field 2030. For example, a PIN number, etc. may be indicated in the user communication info field 2030.

As illustrated in FIG. 21, an exemplary guide record 2100 is provided, of which one or more may be associated with or resident in the search database 1520 (FIG. 15). The guide record 2100 may include a guide ID field 2105, a guide profile ID field 2110, a guide result ID field 2115, a guide communication info field 2120, a guide request ID field 2125, and a guide access ID field 2130. A guide record may be used to indicate information of a guide and/or a trustee, who may be a guide.

The guide ID field 2105 preferably contains a unique identifier of a guide, which is preferably used consistently. For example, in at least one embodiment, the guide ID field 2105 can include a randomly generated numerical code, and/or a text string indicating a name associated with a guide. A guide ID serves to distinguish the guide record associated with a guide from a guide record associated with other guides. Other unique identifiers of a guide may be utilized without departing from the spirit and scope of the embodiments. Using the example illustrated in FIG. 21, ‘Guide1’ is the guide ID associated with the guide record 2100.

The guide profile ID field 2110 includes information of a profile associated with a guide. Content of the guide profile ID field 2110 may be modified based on action of a guide. A person may select a profile which is associated with a guide. For example, a guide may select a profile to be associated with the guide during a registration process. A profile may be associated with a guide based on testing of a guide. For example, a guide may be required to demonstrate knowledge relevant to a profile in order to be associated with the profile, or a guide may take a test which is used to generate a profile, or a guide may provide information such as demographic, geographic, personality or other information which may be indicated in a profile associated with the guide. Information indicated in a guide profile may be obtained from an external database. Information indicated in the content of the guide profile ID field 2110 may be compared to information indicated in the content of a profile associated with a search request, a secure transaction request, and/or any request in order to determine a ranking of a guide for responding to a request. Likewise, a profile associated with a guide may be used to select and/or rank a guide. Using the example illustrated in FIG. 21, the profiles ‘Demoprofileg1’, ‘Geoprofileg1’ and ‘Persprofileg1’ are associated with the guide ‘Guide1’. This may indicate that ‘Guide1’ has indicated and/or generated the profiles ‘Demoprofileg1’ which may be a demographic profile, ‘Geoprofileg1’ which may be a geographic profile and ‘Persprofileg1’ which might indicate personality information regarding the guide ‘Guide1’. Any or all information indicated in the profile associated with a guide may be used to determine a rating and/or ranking of a guide.

The guide result ID field 2115 includes information of a result associated with a guide. Content of the guide result ID field 2115 may be modified based on actions of a guide and/or the search system 1530 (FIG. 15). If a guide produces a search or transaction result responsive to a request, an identifier of the result may be included in the guide result ID field 2115. A rating and/or ranking associated with a search result associated with a guide may affect compensation for a guide. Likewise, a usage indicator associated with a search result provided by a guide may affect a rating or ranking associated with a guide. Using the example illustrated in FIG. 21, the results ‘Result1.1’, ‘Result3.1’ and ‘Result3.2’ are associated with the guide ‘Guide1’. This may indicate that ‘Guide1’ has provided and/or reviewed the results ‘Result1.1’, ‘Result3.1’, and ‘Result3.2’ responsive to a request.

The guide communication info field 2120 includes information of a device and/or service associated with a guide. Content of the guide communication info field 2120 may be modified based on an action of a guide. If a guide establishes communications with the search system 1530 (FIG. 15) using a device and/or service, information regarding the device and/or service may be included in the guide communication info field 2120. Any type of communication service, device and/or system may be indicated in the guide communication info field 2120. For example, a username and/or password associated with a guide may be indicated in the guide communication info field 2120. Communication services such as Instant Messaging (IM), email, SMS, MMS, EMS, telephone, wireless or wired communication, etc. may be indicated in the guide communication info field 2120. A telephone number, an email address, an IM provider and login ID, a keyword associated with a service, etc. may be indicated in the guide communication info field 2120. Using the example illustrated in FIG. 21, the login ‘guide1’, the email ‘guide1@chacha.com’, the IM credential ‘guide1@AIM’ and the phone number ‘317.224.2242’ are associated with the guide ‘Guide1’. This may indicate that ‘Guide1’ may be contacted using the login ID ‘guide1’, via email at ‘guide1@chacha.com’, via IM as ‘guide1@AIM’ and/or via voice, text, and/or other service associated with the phone number ‘317.224.2242’.

The guide request ID field 2125 includes information of a request associated with a guide. Content of the guide request ID field 2125 may be modified based on actions of a guide. If a guide produces a search and/or secure transaction result responsive to a request, an identifier of the search and/or secure transaction request may be included in the guide request ID field 2125. A rating and/or ranking associated with a request associated with a guide may affect compensation for a guide. Likewise, a usage indicator associated with a search request and a guide may affect a rating or ranking associated with the guide. A request may be associated with a guide based on a vote cast by a user and/or a guide regarding items associated with the search request. Using the example illustrated in FIG. 21, the requests ‘User request1’, ‘System request3.1’ are associated with the guide ‘Guide1’. This may indicate that ‘Guide1’ has responded to and/or been selected to respond to the requests ‘User request1’ and ‘System request3.1’.

The guide access info field 2130 may include information regarding access rights granted to a guide. For example, a trustee guide may be allowed to access only certain information associated with a repository of redacted information. Alternately, a user may designate a guide who is granted access to any or all information indicated in an item associated with a repository of redacted information. In addition, access rights may be designated and/or granted based on a guide's successful completion of a test, survey, training process, etc. Using the example, illustrated in FIG. 21, the access information ‘Service3’ and ‘Transaction2’ has been associated with the guide ‘Guide1’. This may indicate that ‘Guide1’ may have access to information indicated in a redacted data repository associated with performing and/or facilitating ‘Service3’ and ‘Transaction2’. An access right may be obtained for example, by a guide completing a test and/or other training provided by the search system 1530 (FIG. 15). For example, a guide may complete a training session associated with responding to a user request for completion of a secure transaction utilizing a user's payment information, ‘Transaction2’, and thus the guide access information, ‘Transaction2’ is included in the guide access info field 2130 to indicate that ‘Guide1’ is authorized to perform the secure transaction, ‘Transaction2’, on behalf of any or all users. In at least one embodiment, a guide may be required to work in a location which has passed a security audit in order to process a type of transaction. Access rights of a guide may include the ability to access a repository, but not to access redacted content, to access a subset of redacted content, etc. For example, if a guide has appropriate certifications, documents associated with privileges such as attorney-client or doctor-patient privileges might be enabled.

A guide may be associated with keywords, categories, tags, affiliations, etc. which may be used to rank a guide and to select a guide to respond to a request. For example, if a request includes s a keyword, a guide who has produced highly ranked results associated with the keyword might be ranked highly. Likewise, if a request is associated with a category of information, a guide who is registered to respond to requests associated with the category may be notified of the request with higher priority. In another example, if a request is associated with an employer, a guide associated with an affiliate group including employees of the employer might be excluded from responding to any query regardless of the subject matter. Any type of selection process may be used to determine a guide who may respond to a request. For example, a process for selecting a searcher such as a process described in the related U.S. application Ser. No. 12/109,776 may be used.

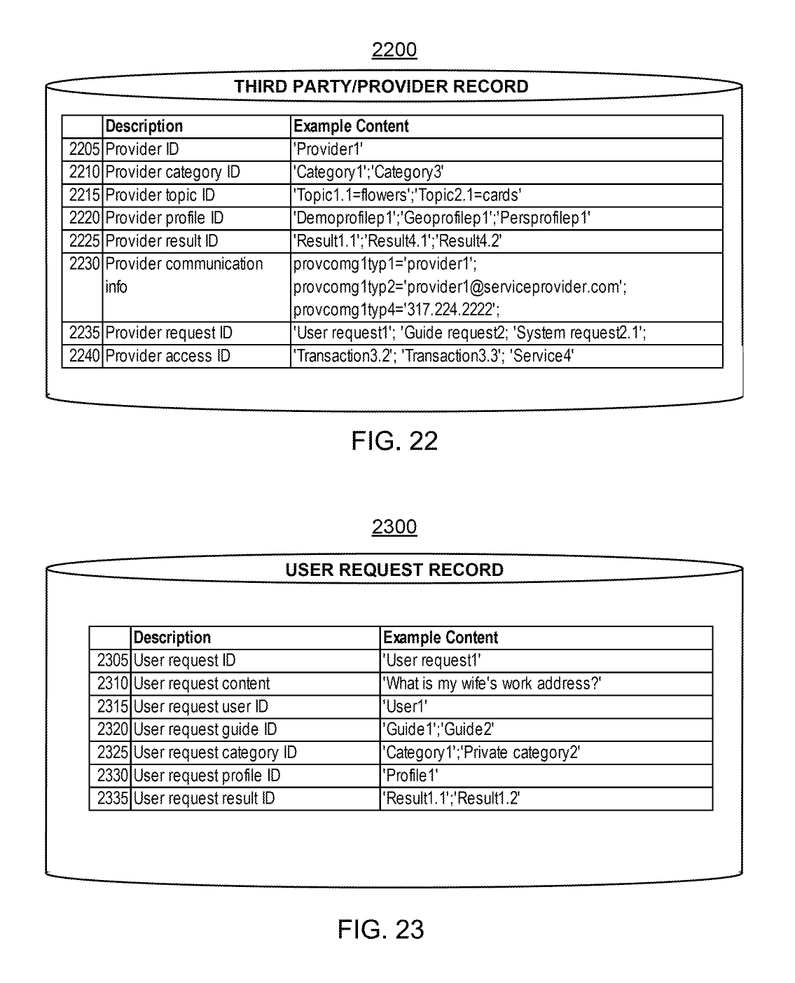

As illustrated in FIG. 22, an exemplary third party/provider record 2200 is provided, of which one or more may be associated with or resident in the search database 1520 (FIG. 15). The third party/provider record 2200 may include a provider ID field 2205, a provider category ID field 2210, provider topic ID field 2215, a provider profile ID field 2220, a provider result ID field 2225, a provider communication info field 2230, a provider request ID field 2235, and a provider transaction ID field 2240.

The provider ID field 2205 preferably contains a unique identifier of a provider, which is preferably used consistently. For example, in at least one embodiment, the provider ID field 2205 can include a randomly generated numerical code, and/or a text string indicating a name associated with a provider. A provider ID serves to distinguish the provider record associated with a provider from a provider record associated with other providers. Other unique identifiers of a provider may be utilized without departing from the spirit and scope of the embodiments. Using the example illustrated in FIG. 22, ‘Provider1’ is the provider ID associated with the provider record 2200.

The provider category ID field 2210 includes information of a category associated with a provider. Content of the provider category ID filed 2210 may be modified based on actions of a provider. For example, upon registration with the search system 1530 (FIG. 15), a provider may be allowed to select a category to be associated with the provider. In addition, a category may be associated with a provider based on a classification designated by the search system 1530, and/or based on suggestions, rankings, and/or reviews provided by a guide and/or a user. Using the example illustrated in FIG. 22, ‘Category1’ and ‘Category3’ are the categories associated with ‘Provider1’.

The provider topic ID field 2215 includes information of a topic associated with a provider. Content of the provider topic ID field 2215 may be modified based on actions of a provider. For example, upon registration with the search system 1530 (FIG. 15), a provider may be allowed to select a topic to be associated with the provider. In addition, a topic may be associated with a provider based on a classification designated by the search system 1530, and/or based on suggestions, rankings, and/or reviews provided by a guide and/or a user. Using the examples illustrated in FIG. 22, ‘Topic1.1=flowers’, ‘Topic2.1=cards’ are the topics associated with ‘Provider1’ of the provider record 2200. For example, the provider topic ID ‘Topic1.1=flowers’ could indicate that ‘Provider1’ may be a suggested provider in response to a user request and/or guide search indicating a keyword, category, and/or search term associated with the term ‘flowers’.

The provider profile ID field 2220 includes information of a profile associated with a provider. Content of the provider profile ID field 2220 may be modified based on an action of a provider. A provider may select a profile which is associated with a provider. For example, a provider may select a profile to be associated with the provider during a registration process. A profile may be associated with a provider based on a test or survey which is used to generate a profile, or a provider may provide information such as demographic, geographic, personality or other information which may be indicated in a profile associated with the provider. Information indicated in a provider profile may be obtained from an external database. Information indicated in the content of the provider profile ID field 2220 may be compared to information indicated in a profile associated with a search request, a secure transaction request, or any other request in order to determine a ranking and/or rating of a provider for suggesting a match in response to a user and/or guide request. Likewise, a profile associated with a provider may be used to select and/or rank a provider. Using the example illustrated in FIG. 22, the profiles ‘Demoprofilep1’, ‘Geoprofilep1’ and ‘Persprofilep1’ are associated with ‘Provider1’. This may indicate that ‘Provider1’ has indicated and/or generated the profiles ‘Demoprofilep1’ which may be a demographic profile, ‘Geoprofilep1’ which may be a geographic profile and ‘Persprofilep1’ which might indicate personality information regarding ‘Provider1’.

The provider result ID field 2225 includes information of a result associated with a provider. Content of the provider result ID field 2225 may be modified based on actions of a provider and/or the search system 1530 (FIG. 15) in response to a user request. If a search or secure transaction result is produced responsive to a user request, an identifier of the result which may include information associated with a provider may be included in the provider result ID field 2225. A rating and/or ranking associated with a search result associated with a provider may affect further use of a provider as a preferred and/or suggested third party or provider. Using the example illustrated in FIG. 22, the results ‘Result1.1’, ‘Result4.1’ and ‘Result4.2’ are associated with ‘Provider1’. This may indicate that ‘Provider1’ is associated with the transactions and/or results ‘Result1.1’, ‘Result4.1’, and ‘Result4.2’.

The provider communication info field 2230 includes information of a device and/or service associated with a provider. Content of the provider communication info field 2230 may be modified based on action of a provider. If a provider establishes communications with the search system 1530 (FIG. 15) using a device and/or service, information regarding the device and/or service may be included in the provider communication info field 2230. Any type of communication service and/or system may be indicated in the provider communication info field 2230. For example, a username and/or password associated with a provider may be indicated in the provider communication info field 2230. Communication services such as Instant Messaging (IM), email, SMS, MMS, EMS, telephone, wireless or wired communication, etc. may be indicated in the provider communication info field 2230. A telephone number, an email address, an IM provider and login ID, a keyword associated with a service, etc. may be indicated in the provider communication info field 2230. A provider may be registered with the search system 1530 (FIG. 15) using a registration process using a web form provided by the search system 1530. A guide may provide communication information associated with a provider. Using the example illustrated in FIG. 22, the login ‘provider1’, the email ‘provider1@serviceprovider.com’, and the phone number ‘317.224.2222’ are associated with the third party ‘Provider1’. This may indicate that ‘Provider1’ may be contacted using the login ID ‘provider1’, via email at ‘provider1@serviceprovider.com’, and/or via voice, text, and/or other service associated with the phone number ‘317.224.2222’.

The provider request ID field 2235 includes information of a request associated with a provider. Content of the provider request ID field 2235 may be modified based on actions of a provider. If a provider is indicated in a result responsive to a search and/or transaction request, an identifier of the request may be included in the provider request ID field 2235. A usage indicator associated with a request and a provider may affect a rating or ranking associated with the provider. A request may be associated with a provider based on a vote cast by a user and/or a guide regarding items associated with the search request. For example, an opinion regarding a best provider to respond to a request as expressed by a guide may associate a request with a provider. Using the example illustrated in FIG. 22, the requests ‘User request1’, ‘ Guide request2 and ‘System request2.1’ are associated with ‘Provider1’. This may indicate that ‘Provider1’ has been associated with and/or selected in response to the requests ‘User request1’, ‘Guide request2’ and ‘System request2.1’. The user request, ‘User request1’ may refer to a request by a user for a result and/or a transaction utilizing the third party ‘Provider1’. Likewise, the guide request, ‘Guide request2’ may indicate a guide request for utilizing ‘Provider1’ for performing and/or facilitating a secure transaction on behalf of a user request. The system request, ‘System request2.1’ may refer to a request by the search system for utilizing ‘Provider1’ for a search result and/or response to a transaction or other request by a user utilizing the search system 1530 (FIG. 15).

The provider access ID field 2240 may include information regarding any security rights and/or permissions associated with a provider. For example, a provider may be associated with a security permission that allows the provider to be a preferred provider of a certain transaction and/or service. Using the example, illustrated in FIG. 22, the access information ‘Transaction3.2’, ‘Transaction3.3’ and ‘Service4’ has been associated with the provider ‘Provider1’. This may indicate that ‘Provider1’ may have requisite security permissions to provide information, or perform services and/or transactions utilizing redacted data repository information associated with performing the specified transactions. The provider access ID, ‘Transaction3.2’ may indicate that provider ‘Provider1’ has completed a security clearance test and/or review, background check, survey or any other required assessment in order to achieve the required access information to provide a secure transaction ‘Transaction3.2’ for a user utilizing the search system 1530 (FIG. 15).

As illustrated in FIG. 23, an exemplary user request record 2300 is provided, of which one or more may be associated with or resident in the search database 1520 (FIG. 15). The user request record 2300 may include a user request ID field 2305, a user request content field 2310, a user request user ID field 2315, a user request guide ID field 2320, a user request category ID field 2325, a user request profile ID field 2330, and a user request result ID field 2335.

A user request record may be created when a query is received from a communication service and/or device associated with a user. A user request record may include information associated with multiple communications between a user and a guide. A user request record may record any information associated with a request, such as an originating device, time information, etc. in addition to the information illustrated.

The user request ID field 2305 preferably contains a unique identifier of a request, which is preferably used consistently. For example, in at least one embodiment, the user request ID field 2305 can include a randomly generated numerical code, and/or a text string indicating the content of a request. A user request ID serves to distinguish the request record associated with a request from a request record associated with other requests. Other unique identifiers of a request may be utilized without departing from the spirit and scope of the embodiments.

A unique identifier is assigned to a user request record when it is entered into the search database 1520. A user request record may include information that is not explicitly provided by a user or requester. For example, location information, profile information, etc. may be associated with a request automatically and/or based on actions of a guide. If a message received from a user is determined to be associated with a previous request associated with the user, information of the message may be added to a request record associated with the previous user request. The association of a request with a user may be used to provide context information to a guide based on previous requests associated with a user. As illustrated in FIG. 23, ‘User request1’ is the user request ID associated with the user request record 2300.

The user request content field 2310 may include information regarding content of a request. For example, text associated with a query submitted by a user may be indicated in the user request content field 2310. Such information may be processed in order to associate a keyword, category and/or other information with a request. In at least one embodiment, a structured query which conforms to a specific context may be indicated in the user request content field 2310. Information such as audio recordings, images, etc. which are associated with a request may be indicated in the user request content field 2310. Using the example illustrated in FIG. 23, the query ‘What is my wife's work address?’ is the content associated with the request record 2300. This may indicate that the query ‘What is my wife's work address?’ may be the content the request ‘User request1’. If a user request is determined to match a previous request, the user may be presented with a search result based on stored information associated with the matching request. Using this example, if a user had previously requested his wife's work address, the information may be provided from a personal data repository without the use of a guide.

The user request user ID field 2315 may include information of a user that submitted a query to the search system 1530 (FIG. 15). The user request user ID field 2315 may be used to associate a user with a query. Information indicated in the user request user ID field 2315 may be used to obtain information of a user using a record such as the user record 2000 (FIG. 20). Using the example illustrated in FIG. 23 the user ‘User1’ is associated with the user request ‘User request1’. This may indicate that ‘User1’ submitted the request ‘User request1’.

The user request guide ID field 2320 may include information of a guide who is associated with a request. For example, if a guide obtains a search result responsive to the user request ‘User request1’, an identifier of the guide may be indicated in the user request guide ID field 2320. Likewise, if a guide is selected by the search system 1530 (FIG. 15) to respond to a request and/or perform or facilitate a secure transaction, an identifier of the guide may be indicated in the user request guide ID field 2320. Information indicated in the user request guide ID field 2320 may be used to obtain information associated with a guide using a record such as the guide record 2100 (FIG. 21). Using the example illustrated in FIG. 23 the guides ‘Guide1’ and ‘Guide2’ have been associated with the user request ‘User request1’. For example, ‘Guide1’ and/or the search system 1530 may have reviewed ‘User request1’and determined that the request required access to information indicated in a repository of redacted information associated with ‘User1’. The guide ‘Guide2’ may have been selected and/or received a transfer request from ‘Guide1’ to respond to the request ‘User request1’ based at least in part on a ranking and/or rating of guides associated with ‘User request1’. Using the example illustrated, information indicated in ‘Profile1’, may be used to rank guides based on information indicated in a profile associated with the guides. A guide may be selected based at least in part on a ranking and/or rating of the guide associated with ‘Profile1’.

The user request category ID field 2325 may include information of a category and/or keyword associated with a request. Content of the user request category ID field 2325 may be modified by an automated and/or human assisted classification of a request. For example, if a user submits a request to a particular communication service address or to a particular third party or provider associated with the search system 1530 (FIG. 15), the request may be associated with a category. A human may select a category and/or a keyword which is associated with a request. A category may be associated with a resource such as a repository of redacted information. An item associated with a category may be presented to a guide and/or a user if a request associated with the category is submitted to the search system 1530 (FIG. 15). A category may be associated with a request based on any type of information associated with a request. Using the example illustrated in FIG. 23, the categories ‘Category1’ and ‘Private category2’ are associated with the user request ‘User request1’. The indication of ‘Private category2’ may indicate that ‘User request1’ requires a search and/or utilization of information indicated in a repository of redacted and/or private information.

The user request profile ID field 2330 may include information of a profile which is associated with a request. For example, a profile may be associated with a request based at least in part on a profile associated with a user associated with a request. For example, a geographic profile which is common to one or more users associated with a request may be associated with a request, or a guide may determine that a profile is to be associated with a request based on the content or subject matter of a request associated with a user. A resource, item, or guide selected to respond to a request or a third party or provider selected in response to a request may be selected at least in part based on a profile associated with the request. Using the example illustrated in FIG. 23, the profile ‘Profile1’ is associated with the user request ‘User request1’.

The user request result ID field 2335 may include information of a result which is associated with a request. For example, a search result may be associated with a request when a guide obtains the search result responsive to the request. Likewise, if a request is submitted to the search system 1530 (FIG. 15), a guide may be selected, and the guide may provide a result responsive to the request. Alternately, a result may be associated with a request if the request is submitted to a resource such as a search engine, or other resource or system. Any number of search results may be associated with a request. Using the example illustrated in FIG. 23, the result ‘Result1.1’ and the result ‘Result1.2’ have been associated with the user request ‘User request1’. This may indicate that ‘Result1.1’ and ‘Result1.2’ have been provided to a user responsive to ‘User request1’.

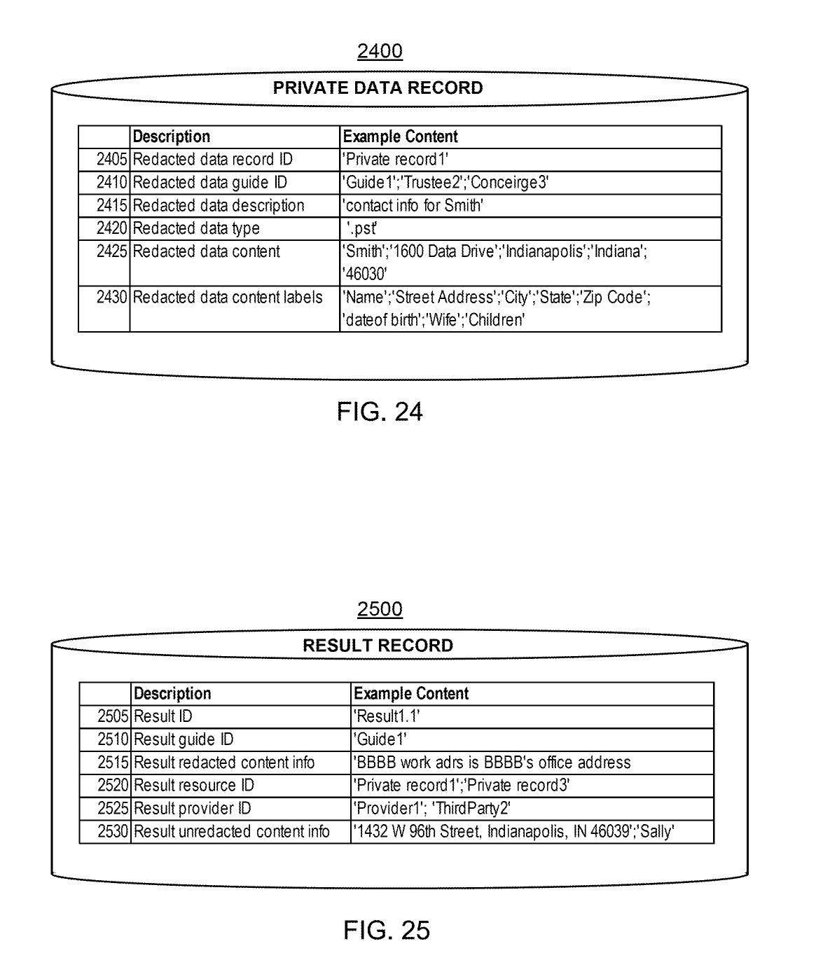

As illustrated in FIG. 24, an exemplary redacted data record 2400 is provided, of which one or more may be associated with or resident in the search database 1520 (FIG. 15). The redacted data record 2400 may include a redacted data record ID field 2405, a redacted data guide ID field 2410, a redacted data description field 2415, a redacted data type field 2420, a redacted data content field 2425, and a redacted data content labels field 2430.

The redacted data record ID field 2405 preferably contains a unique identifier of a redacted data object, which is preferably used consistently. For example, in at least one embodiment, the redacted data record ID field 2405 can include a randomly generated numerical code, and/or a text string indicating a name associated with a redacted data object. A redacted data record ID serves to distinguish the redacted data record associated with a redacted data object from a redacted data record associated with other redacted data objects. Other unique identifiers of a redacted data object may be utilized without departing from the spirit and scope of the embodiments. In at least one embodiment, a redacted data record ID may include a description associated with a redacted data object. Using the example illustrated in FIG. 24, ‘Private record1’ is the redacted data record ID associated with the redacted data record 2400. Information indicated in the redacted data ID field may be used to ‘look up’ information associated with a redacted data object. For example, if a redacted data record is identified based on search criteria associated with keywords and/or content labels associated with the redacted data record, information indicated in the redacted data content field 2425 associated with any or all content labels indicated a private data record may be provided to a user based on a label which is visible to a guide. An index associated with redacted data records may be used to identify a redacted data record ID which may be used to look up a location where the relevant data may be found. In at least one embodiment, a client/server architecture is implemented wherein a request for information indicated in a redacted data record is made by the search system 1530 to a user system and/or a resource system.

The redacted data guide ID field 2410 may include information of a guide associated with a redacted data object. For example, a guide who has provided a search result based on information indicated in a redacted data object may be indicated in the redacted data guide ID field 2410. In at least one embodiment a guide ID associated with a guide who may have permission to access redacted data indicated in a redacted data record may be indicated in the redacted data guide ID field 2410. Information contained in the redacted data guide ID field 2410 may be used to obtain information regarding a guide associated with a redacted data object based on records such as the guide record 2100 (FIG. 21). Using the example illustrated in FIG. 24, the guide IDs ‘Guide1’; ‘Trustee2’ and ‘Conceirge3’ are associated with the redacted data ‘Private record1’ which may indicate that the guides ‘Guide1’; ‘Trustee2’ and ‘Conceirge3’ may have produced a search result and/or provided a secure transaction which included and/or utilized information indicated in ‘Private record1’. A guide ID indicated in the redacted data guide ID field 2410 may contain data of a guide associated with varying permissions and/or security access or clearance designated to provide, perform and/or facilitate search and/or secure transaction services. For example, a guide, which may be a trustee guide, such as the guides associated with guide IDs ‘Trustee2’ and ‘Conceirge3’ may be permitted to perform secure transactions and/or searches revealing redacted data on behalf of a user, for example, by utilizing payment information indicated in the redacted repository of a user, whereas the guide associated with the guide ID ‘Guide1’ may have limited search access privileges regarding a user's redacted information repository.

The redacted data description field 2415 may include information of a description of a redacted data object. For example, a text snippet associated with a search resource may be indicated in the redacted data description field 2415. A URL and/or other information associated with a redacted data object may be indicated in the redacted data description field 2415. Information contained in the redacted data description field 2415 may be used to provide a description of a redacted data object to a user and/or a guide. Using the example illustrated in FIG. 24, the text snippet ‘contact info for Smith’ is associated with the redacted data record ‘Private record1’, which may indicate that ‘Private record1’ may include contact information associated with a person named ‘Smith’. The redacted data description field 2415 may be indexed by a search facility which is used to create an index of items and/or objects which are included in a repository of redacted information. For example, items associated with a particular user may reflect the name of the user in the redacted data description field 2415, so that heterogeneous types of data may be indexed.

The redacted data type field 2420 may include type information associated with redacted data. For example, a description and/or definition of an object may be indicated in the redacted data type field 2420. Information which may describe properties of redacted data may be indicated in the redacted data type field 2420. Information contained in the redacted data type field 2420 may be used to associate labels, and/or other information which may be exposed to a guide in order to utilize content of a redacted data object by the search system 1530 (FIG. 15). Using the example illustrated in FIG. 24, the data type ‘.pst’ is associated with the redacted data record ‘Private record1’. This may for example define one or more field labels which may be associated with content indicated in a redacted data record. While a specific description of a type of file has been used in FIG. 24 for the purposes of illustration and simplicity, no limitation is implied thereby. Any information required to provide information regarding a redacted data object may be indicated in the redacted data type field 2420. For example, an .xls, .ppt, .doc, .pdf, .csv, .png, .bmp, wmv, mp3, etc., file formats and/or web templates which may obtain information from a web page or web service such as a mail service, a networking service, etc. may be provided to index and associate labels with redacted information.

The redacted data content field 2425 may include information regarding the content of information which may be associated with content labels indicated in the redacted data content labels field 2430. For example, information indicated in a field name indicated in the redacted data content labels field 2430 may be indicated in the redacted data content field 2425. In at least one embodiment, the content of the redacted data content field 2425 may be a pointer to information which is located in a resource such as the resource 1560 (FIG. 15). Using the example illustrated in FIG. 24, the text ‘Smith’, ‘1600 Data Drive’, ‘Indianapolis’, ‘Indiana’, and ‘46030’ is the redacted data content associated with the redacted data record ‘Private record1’. In at least one embodiment, the content of the redacted data content field 2425 may be linked by, for example, a pointer to the redacted data content labels field 2430, as described further herein below. Information indicated in the redacted data content field 2425 may not be revealed to a guide or searcher, but may be provided and/or revealed to a user and/or a trustee or concierge.

The redacted data content labels field 2430 may include information of any labels associated with redacted data. For example, a label associated with a type of information which may be indicated in the redacted data content field 2425 may be indicated in the redacted data content labels field 2430. Using the example illustrated in FIG. 24, the labels ‘Name’, ‘Street Address’, ‘City’, ‘State’, ‘Zip Code’, ‘date of birth’, ‘Wife’, and ‘Children’ are associated with the redacted data record ‘Private record1’. This may for example indicate that ‘Name’ is associated with ‘Smith’, ‘Street Address’ is associated with ‘1600 Data Drive’, ‘City’ is associated with ‘Indianapolis’, ‘State’ is associated with ‘Indiana’, ‘Zip Code’ is associated with ‘46030’ and that null is associated with ‘date of birth’, ‘Wife’, and ‘Children’. The relationship between labels indicated in the redacted data labels field 2430 and the content indicated in the redacted data content field 2425 may be used to locate redacted information based on a search term which may identify matching records in a repository of redacted information.

As illustrated in FIG. 25, an exemplary result record 2500 is provided, of which one or more may be associated with or resident in the search database 1520 (FIG. 15). The result record 2500 may include a result ID field 2505, a result guide ID field 2510, a result redacted content info field 2515, a result resource ID field 2520, a result provider ID field 2525 and a result unredacted content field 2530.

The result ID field 2505 preferably contains a unique identifier of a result, which is preferably used consistently. For example, in at least one embodiment, the result ID field 2505 can include a randomly generated numerical code, and/or a text string indicating a name associated with a result. A result ID serves to distinguish the result record associated with a result from a result record associated with other results. Other unique identifiers of a result may be utilized without departing from the spirit and scope of the embodiments. In at least one embodiment, a result ID may include a description associated with a result. Using the example illustrated in FIG. 25, ‘Result1.1’ is the result ID associated with the result record 2500.

The result guide ID field 2510 may include information of a guide associated with a result. For example, a guide who obtained a search result or performed and/or facilitated a secure transaction may be indicated in the result guide ID field 2510. Information contained in the result guide ID field 2510 may be used to obtain information regarding a guide associated with a result based on records such as the guide record 2100 (FIG. 21). Using the example illustrated in FIG. 25, the guide ID ‘Guide1’ is associated with the result ‘Result1.1’ which may indicate that the guide ‘Guide1’ has provided partial or complete results associated with the result ‘Result1.1’.

The result redacted content info field 2515 may include information of content of a result which is exposed to a guide. For example, a text snippet associated with a result may be indicated in the result redacted content info field 2515. The result redacted content info field 2515 may indicate any type of information. In at least one embodiment, the content of the result redacted content info field 2515 may indicate pseudonymous labels associated with redacted content which is provided to a user. Information indicated in the result redacted content info field 2515 may be presented to a user and/or may be incorporated in a future request as a place-holder to represent redacted content. In at least one embodiment, the result redacted content info field 2515 and the result unredacted content info field 2530 may be linked by, for example, a pointer. Using the example illustrated in FIG. 25, the result redacted content info ‘BBBB work address’ and ‘BBBB’ are associated with the result ‘Result1.1’ which may have been provided by ‘Guide1’ responsive to the request, for example as illustrated in FIG. 23, ‘User request1’ provided from ‘User1’ as indicated in the user request record 2200 and result record 2500 (FIG. 25).

The result resource ID field 2520 may include information of a resource associated with a result. For example, a pointer to one or more records which indicate content of a redacted data record may be indicated in the result resource ID field 2520. Any type of information associated with a search resource may be indicated in the result resource ID field 2520. Information contained in the result resource ID field 2520 may be used to provide access to resource for a user, a guide and/or the search system 1530 (FIG. 15) using information indicated in a record such as the redacted data record 2400 (FIG. 24). Using the example illustrated in FIG. 25, the result resource IDs ‘Private record1’ and ‘Private record3’ are associated with the result ID ‘Result1.1’. This may for example indicate that the resource “Private record1’ may be used to obtain the address information ‘ BBBB work address’ and ‘Private record3’ may be used to obtain the information associated ‘BBBB’ which are included in the result ‘Result1.1’. While a simple example of a result is used for the purposes of illustration, if redacted information is revealed to a trustee, in order to process a request, a result which may include a confirmation of a purchase may indicate information provided and/or resources used to obtain the information provided.

The result provider ID field 2525 may include information of a third party and/or provider associated with a result. For example, if a guide obtained a search result or performed and/or facilitated a secure transaction, a provider or supplier associated with the search result or transaction may be indicated in the result provider ID field 2525. Information contained in the result provider ID field 2525 may be used to obtain information regarding a provider associated with a result based on a record such as the provider record 2200 (FIG. 22). Using the example illustrated in FIG. 25, the provider ID ‘Provider1’ and the third party ‘Third Party2’ are associated with the result ‘Result1.1’ which may indicate that ‘Result 1.1’ has been provided to ‘Provider1’ and ‘ThirdParty1’. For example, ‘Result1.1’ might be delivered to ‘Provider1’ as part of a request for a product, and might be delivered to ‘ThirdParty1’ to verify delivery of the product. If data from a repository of private or redacted information is provided to a third party, information indicated in the result provider ID field 2525 may provide traceability of use of the information.

The result unredacted content info field 2530 may indicate information of a result which may be presented to a user. In at least one embodiment, the content of the result unredacted content info field 2530 may be linked to the result redacted content info field 2515. Using the example illustrated in FIG. 25, the unredacted content ‘1432 W 96^{th} Str. Indianapolis, Ind. 46039’ and ‘Sally’ is associated with ‘Result1.1’. This may indicate that ‘1432 W 96^{th} Str. Indianapolis, Ind. 46039’ and ‘Sally’ will be provided to responsive to a request associated with the result ‘Result1.1’. Looking at the content of the result redacted content info field 2515, associations by pointers or otherwise within the search system 1530 (FIG. 15) may indicate that ‘BBBB work address may be used as a pseudonym for ‘1432 W 96^{th} Str. Indianapolis, Ind. 46039’ and/or that ‘BBBB’ may be used as a pseudonym for ‘Sally’.

As any repository of redacted information may include various types of files and objects and a search facility which may use cross-references among various files in order to assist a user in identifying information which may be redacted. For example, names which are associated with contacts included in a ‘.pst’ file might be identified within the body text of unstructured documents such as a ‘.doc’ file. In such an instance a user might be offered the option of redacting those names in all instances in order that text of a ‘.doc’ file might be presented to a guide while the names of individuals, companies, etc. might be obscured.

A user may be able to designate various types of redacted information which may be revealed to a trustee under various circumstances. For example, a user may elect to reveal credit card information more readily than checking account or brokerage account information. Likewise, a user might allow a trustee to review photos or recordings associated with an organization such as a club or company while limiting use of recordings of family members, or a personal residence.

A GUI 2600 for performing a search of a repository of redacted information is illustrated in FIG. 26. The GUI 2600 may be presented to a guide responsive to a user request. The GUI 2600 may be displayed on any suitable display device of any guide system such as the guide system 1505 (FIG. 15). The GUI 2600 may include an advertising window 2605, guide activity controls 2610, a request box 2615, a redacted search query box 2620, a redacted search button 2625, a redacted result window 2630, redacted result indicators 2635, a user information window 2637, a result window 2640, a result constraint indicator 2645, a result transmit button 2650, and action buttons 2655.

The advertising window 2605 may include an advertisement targeted to a guide and/or a user. The guide activity controls 2610 may be used by a guide to select an activity. For example, the ‘Guide1’ guide activity control 2610a may cause a GUI for viewing information associated with the guide ‘Guide1’ to be presented when selected. The ‘My profile’ guide activity control 2610b may be used to display personal and/or other information associated with a guide to be presented. The ‘Log off’ guide activity control 2610c may be used to log on or log off the search system 1540 (FIG. 15). The request box 2615 may be used to indicate information associated with a request. While a text or SMS message is used for the purposes of illustration, any type of information associated with a user request may be indicated in the user request box 2615. For example, media such as audio, images, etc. might be indicated in the request box 2615. Using the example in FIG. 26, the request ‘I meant BBBB’ is displayed to a guide, which may be related to a previous request and/or response provided to a user such as a request indicated in the user information window 2637.

The redacted search query box 2620 may be used to indicate information of a search query which has been created by a guide responsive to a request. Using the example illustrated in FIG. 26, the search query ‘Date of anniversary, wife’ which may have been entered by a guide responsive to a previous user request, such as the query indicated in the historical request indicator 2687a is presented in the redacted search query box 2620. The redacted search button 2625 may be used to execute a search responsive to a search query indicated in the redacted search query box 2620.

The redacted result window 2630 may be used to indicate a search result associated with a search request indicated in the redacted search box 2620. The redacted result indicators 2635 may be used to indicate information associated with a search result presented in the redacted result window 2630. For example, the redacted result indicator 2635a indicates that the result ‘AAAA’ and ‘xx/xx/xxxx’ has been returned, and the redacted result indicator 2635b indicates that the result ‘BBBB’ and ‘mm/dd/yyyy’ has been returned. Redacted data indicators 2633 may be used to allow a guide to transfer the content of a private record associated with the indicator to a search result without explicitly revealing the content of the private record. For example activation of the ‘BBBB’ redacted data indicator 2633b may transfer the label ‘BBBB’ to the result window 2640. This may enable a guide to construct a response including the information without the information being specifically revealed to the guide. As such, the system 1500 (FIG. 15) enables selective access to information of a user where some content pertaining to the user remains hidden from some users while being accessible by other users.

The user information window 2637 may be used to provide information which may be associated with a user. Such information may be provided to a guide in order that context associated with a search is available to a guide. For example a guide who may not have responded to a previous request from a user might benefit from context information. A location indicator 2682 may provide information of a location associated with a user. Filter controls 2685 may be provided to allow a guide to selectively view information such as previous requests, etc. associated with a user. The history search box 2685a may be used to indicate a search term for sorting user history information. The history search button 2685b may be used to execute a search of user information using a search term indicated in the history search box 2685a. The chronological button 2685c may be used to sort historical information chronologically. The filter controls 2685 described are used for the purposes of illustration, and other types of filtering controls which are well known in the art may be used to perform the equivalent function. Historical request indicators 2687 may be used to indicate information of a previous request. Historical result indicators 2689 may be used to indicate a previous search result. Time stamp indicators 2692 may be used to indicate time information associated with a request.

The result window 2640 may be used to indicate information associated with a search result which has been prepared by a guide. The result constraint indicator 2645 may be used to indicate any constraints which may be placed on a message which is indicated in the result window 2640. For example, as illustrated in FIG. 26, a guide is notified that there are ‘50 characters remaining’ in providing, for example, a result message limited by SMS character limits in response to a user's SMS request. The result transmit button 2650 may be used to transmit a search result indicated in the result window 2640 to a user. The action buttons 2655 may be used by a guide to take various actions. The ‘Transfer’ action button 2655a may be used to transfer a request to a different guide. The ‘Abuse’ button 2655b may be used to report inappropriate queries or actions to system administrators. The ‘Trustee’ button 2655c may be used to indicate that a trustee guide is needed to handle a request. For example, a guide might activate the ‘Trustee’ button 2655c if the guide determined that information required to fulfill a request requires redacted information to be revealed to the guide. Viewing controls 2690 may be used to navigate within a window. The viewing control 2690a and 2690b may be used to navigate within the redacted result window 2630 and the user information window 2637, respectively. A illustrated, information of a previous search session associated with a user may be persisted to provide context.

The GUI 2600 is an exemplary GUI for performing a search of a redacted information repository by guide may contain any number of additional windows, fields, boxes, banners and/or controls, etc.

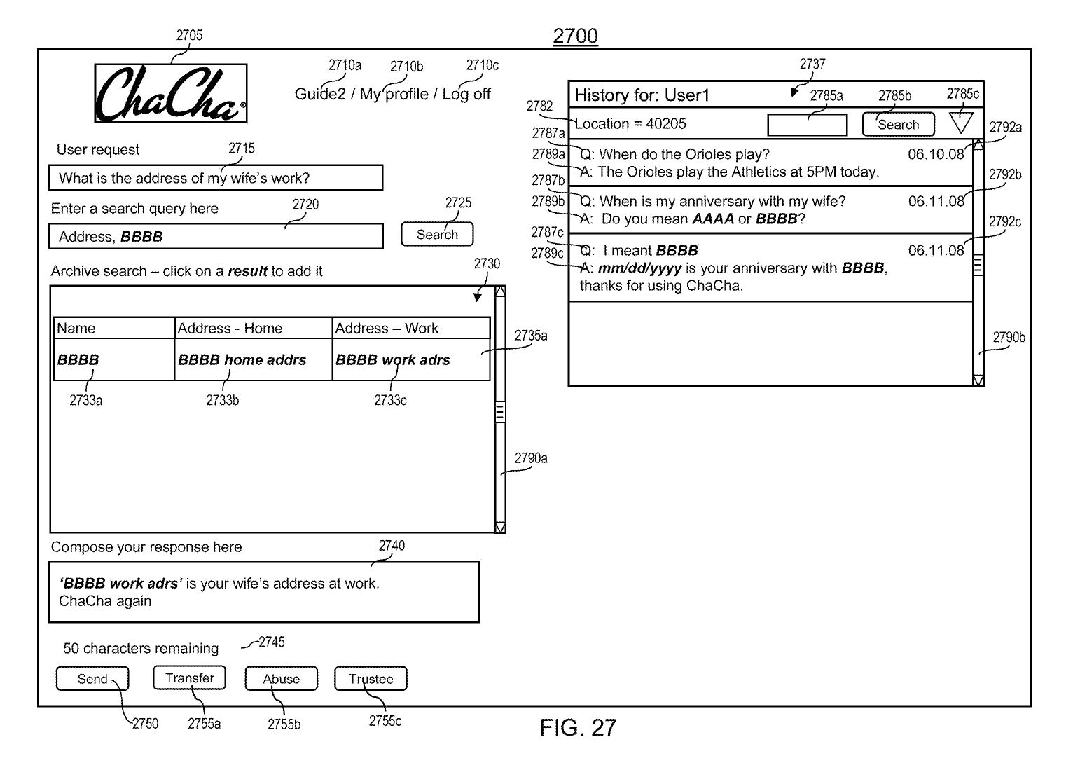

A GUI 2700 for performing a search of a repository of redacted information is illustrated in FIG. 27. The GUI 2700 may be presented to a guide responsive to a user request. The GUI 2700 may be displayed on any suitable display device of any guide system such as the guide system 1505 (FIG. 15). The GUI 2700 may include an advertising window 2705, guide activity controls 2710, a request box 2715, a redacted search query box 2720, a redacted search button 2725, a redacted result window 2730, redacted result indicators 2735, a user information window 2737, a result window 2740, a result constraint indicator 2745, a result transmit button 2750, and action buttons 2755.

The advertising window 2705 may include an advertisement targeted to a guide and/or a user. The guide activity controls 2710 may be used by a guide to select an activity. For example, the ‘Guide2’ guide activity control 2710a may cause a GUI for viewing information associated with the guide ‘Guide2’ to be presented when selected. The ‘My profile’ guide activity control 2710b may be used to display personal and/or other information associated with a guide to be presented. The ‘log off’ guide activity control 2710c may be used to log on or log off the search system 1530 (FIG. 15). The request box 2715 may be used to indicate information associated with a request. While a text or SMS message is used for the purposes of illustration, any type of information associated with a user request may be indicated in the user request box 2715. For example, media such as audio, images, etc. might be indicated in the request box 2715. Using the example in FIG. 27, the request ‘what is the address of my wife's work?’ is displayed to a guide, which may be related to a previous request and/or response provided to a user such as a request indicated in the user information window 2737.

The redacted search query box 2720 may be used to indicate information of a search query which has been created by a guide responsive to a request. Using the example illustrated in FIG. 27, the search query ‘Address, BBBB’ which may have been entered by a guide responsive to a current request is indicated in the redacted search query box 2720. The redacted search button 2725 may be used to execute a search responsive to a search query indicated in the redacted search query box 2720.

The redacted result window 2730 may be used to indicate a search result associated with a search request indicated in the redacted search box 2720. The redacted result indicators 2735 may be used to indicate information associated with a search result presented in the redacted result window 2730. For example, the redacted result indicator 2735a indicates that a result associated with contact information of ‘BBBB’ (i.e. the user's wife) has been returned. Redacted data indicators 2733 may be used to allow a guide to transfer the content of a private record associated with the indicator to a search result without explicitly revealing the content of the private record. For example activation of the ‘BBBB work adrs’ redacted data indicator 2733c may transfer the label ‘BBBB work adrs’ to the result window 2740.

The user information window 2737 may be used to provide information which may be associated with a user. Such information may be provided to a guide in order that context associated with a search is available to a guide. For example a guide who may not have responded to a previous request from a user might benefit from context information. A location indicator 2782 may provide information of a location associated with a user. Filter controls 2785 may be provided to allow a guide to selectively view information such as previous requests, etc. associated with a user. The history search box 2785a may be used to indicate a search term for sorting user history information. The history search button 2785b may be used to execute a search of user information using a search term indicated in the history search box 2785a. The chronological button 2785c may be used to sort historical information chronologically. The filter controls 2785 described are used for the purposes of illustration, and other types of filtering controls which are well known in the art may be used to perform the equivalent function. Historical request indicators 2787 may be used to indicate information of a previous request. Historical result indicators 2789 may be used to indicate a previous search result. Time stamp indicators 2792 may be used to indicate time information associated with a request.

The result window 2740 may be used to indicate information associated with a search result which has been prepared by a guide. The result constraint indicator 2745 may be used to indicate any constraints which may be placed on a message which is indicated in the result window 2740. For example, as illustrated in FIG. 27, a guide is notified that there are ‘50 characters remaining’ in providing, for example, a result message limited by SMS character limits in response to a user's SMS request. The result transmit button 2750 may be used to transmit a search result indicated in the result window 2740 to a user. The action buttons 2755 may be used by a guide to take various actions. The ‘Transfer’ action button 2755a may be used to transfer a request to a different guide. The ‘Abuse’ button 2755b may be used to report inappropriate queries or actions to system administrators. The ‘Trustee’ button 2755c may be used to indicate that a trustee guide is needed to handle a request. For example, a guide might activate the ‘Trustee’ button 2755c if the guide determined that information required to fulfill a request requires redacted information to be revealed to the guide. Viewing controls 2790 may be used to navigate within a window. The viewing control 2790a and 2790b may be used to navigate within the redacted result window 2730 and the user information window 2737, respectively. A illustrated, information of a previous search session associated with a user may be persisted to provide context.

A GUI 2800 for performing a search of a repository of redacted information is illustrated in FIG. 28. The GUI 2800 may be presented to a guide responsive to a user request. The GUI 2800 may be displayed on any suitable display device of any guide system such as the guide system 1505 (FIG. 15). The GUI 2800 may include an advertising window 2805, guide activity controls 2810, a request box 2815, a redacted search query box 2820, a redacted search button 2825, a redacted result window 2830, redacted result indicators 2835, a user information window 2837, a result window 2840, a result constraint indicator 2845, a result transmit button 2850, action buttons 2855, and a provider search window 2860,

The advertising window 2805 may include an advertisement targeted to a guide and/or a user. The guide activity controls 2810 may be used by a guide to select an activity. For example, the ‘Guide3’ guide activity control 2810a may cause a GUI for viewing information associated with the guide ‘Guide3’ to be presented when selected. The ‘My profile’ guide activity control 2810b may be used to display personal and/or other information associated with a guide to be presented. The ‘log off’ guide activity control 2810c may be used to log on or log off the search system 1530 (FIG. 15). The request box 2815 may be used to indicate information associated with a request. While a text or SMS message is used for the purposes of illustration, any type of information associated with a user request may be indicated in the user request box 2815. For example, media such as audio, images, etc. might be indicated in the request box 2815. Using the example in FIG. 28, the request ‘Send roses to my wife at work tomorrow. Charge my Visa” is displayed to a guide, which may be related to a previous request and/or response provided to a user such as a request indicated in the user information window 2837.

The redacted search query box 2820 may be used to indicate information of a search query which has been created by a guide responsive to a request. Using the example illustrated in FIG. 28, the search query ‘Address, BBBB’ which may have been entered by a guide responsive to a previous request is indicated in the redacted search query box 2820. The redacted search button 2825 may be used to execute a search responsive to a search query indicated in the redacted search query box 2820.

The redacted result window 2830 may be used to indicate a search result associated with a search request indicated in the redacted search box 2820. The redacted result indicators 2835 may be used to indicate information associated with a search result presented in the redacted result window 2830. For example, the redacted result indicator 2835a indicates that a result associated with contact information of ‘BBBB’ (i.e. the user's wife) has been returned. Redacted data indicators 2833 may be used to allow a guide to transfer the content of a private record associated with the indicator to a search result without explicitly revealing the content of the private record. For example activation of the ‘BBBB work adrs’ redacted data indicator 2833c may transfer the label ‘BBBB work adrs’ to the provider search query box 2865.

The user information window 2837 may be used to provide information which may be associated with a user. Such information may be provided to a guide in order that context associated with a search is available to a guide. For example a guide who may not have responded to a previous request from a user might benefit from context information. A location indicator 2882 may provide information of a location associated with a user. Filter controls 2885 may be provided to allow a guide to selectively view information such as previous requests, etc. associated with a user. The history search box 2885a may be used to indicate a search term for sorting user history information. The history search button 2885b may be used to execute a search of user information using a search term indicated in the history search box 2885a. The chronological button 2885c may be used to sort historical information chronologically. The filter controls 2885 described are used for the purposes of illustration, and other types of filtering controls which are well known in the art may be used to perform the equivalent function. Historical request indicators 2887 may be used to indicate information of a previous request. Historical result indicators 2889 may be used to indicate a previous search result. Time stamp indicators 2892 may be used to indicate time information associated with a request.

The result window 2840 may be used to indicate information associated with a search result which has been prepared by a guide. The result constraint indicator 2845 may be used to indicate any constraints which may be placed on a message which is indicated in the result window 2840. For example, as illustrated in FIG. 28, a guide is notified that there are ‘10 characters remaining’ in providing, for example, a result message limited by SMS character limits in response to a user's SMS request. The result transmit button 2850 may be used to transmit a search result indicated in the result window 2840 to a user. The action buttons 2855 may be used by a guide to take various actions. The ‘Transfer’ action button 2855a may be used to transfer a request to a different guide. The ‘Abuse’ button 2855b may be used to report inappropriate queries or actions to system administrators. The ‘Trustee’ button 2855c may be used to indicate that a trustee guide is needed to handle a request. For example, a guide might activate the ‘Trustee’ button 2855c if the guide determined that information required to fulfill a request requires redacted information to be revealed to the guide. Viewing controls 2890 may be used to navigate within a window. The viewing control 2890a, b, c may be used to navigate within the redacted result window 2830, the user information window 2837, and the provider search window 2860, respectively. A illustrated, information of a previous search session associated with a user may be persisted to provide context. For example, the previous search query in the redacted search query box 2820.

The provider search window 2860 may be used to indicate information of a search conducted using redacted information and/or other information to locate a provider responsive to a request. A provider search query box 2865 may be used to perform a search for a provider. For example, the query ‘Florists “BBBB work adrs’ which may include redacted information is indicated in the provider search query box 2865. A provider search button 2867 may be used to execute a search using a query indicated in the provider search query box 2865. Provider search result indicators may be used to provide information of a search result associated with a search performed using the provider search query box 2865 and the provider search button 2867. For example, the provider search result indicator 2875a indicates the provider ‘Flora's Flora's’. Provider connection controls 2876 may be used to connect to a provider. For example the provider connection control 2876b may be used to connect to the provider ‘Fred's Flowers’. A connection may be a voice, chat, email, or other communications. In at least one embodiment, the provider search window may search a database of providers using a custom search engine. A guide may be able to locate a product using a website and/or other resource associated with a provider.

A GUI 2900 for performing a search of a repository of redacted information is illustrated in FIG. 29. The GUI 2900 may be presented to a trustee responsive to a user request. The GUI 2900 may be displayed on any suitable display device of any guide system such as the guide system 1505 (FIG. 15). The GUI 2900 may include an advertising window 2905, guide activity controls 2910, a request box 2915, a redacted search query box 2920, a redacted search button 2925, a redacted result window 2930, redacted result indicators 2935, a user information window 2937, a result window 2940, a result constraint indicator 2945, a result transmit button 2950, action buttons 2955, and a provider search window 2960,

The advertising window 2905 may include an advertisement targeted to a guide and/or a user. The guide activity controls 2910 may be used by a guide to select an activity. For example, the ‘Trustee1’ guide activity control 2910a may cause a GUI for viewing information associated with the guide ‘Trustee1’ to be presented when selected. The ‘My profile’ guide activity control 2910b may be used to display personal and/or other information associated with a guide to be presented. The ‘log off’ guide activity control 2910c may be used to log on or log off the search system 1530 (FIG. 15). The request box 2915 may be used to indicate information associated with a request. While a text or SMS message is used for the purposes of illustration, any type of information associated with a user request may be indicated in the user request box 2915. For example, media such as audio, images, etc. might be indicated in the request box 2915. Using the example in FIG. 29, the request ‘buy them from Fred’ is displayed to a guide, which may be related to a previous request and/or response provided to a user such as a request indicated in the user information window 2937. For example, the query indicated in the historical query indicator 2987d and the historical answer indicator 2989d may be used to interpret the request ‘buy them from Fred’.

The redacted search query box 2920 may be used to indicate information of a search query which has been created by a guide responsive to a request. Using the example illustrated in FIG. 29, the search query ‘credit card info user1’ which may have been entered by a trustee responsive to a current request is indicated in the redacted search query box 2920. The redacted search button 2925 may be used to execute a search responsive to a search query indicated in the redacted search query box 2920.

The redacted result window 2930 may be used to indicate a search result associated with a search request indicated in the redacted search box 2920. The redacted result indicators 2935 may be used to indicate information associated with a search result presented in the redacted result window 2930. For example, the redacted result indicator 2935a indicates that a result associated with contact information of ‘Visa’ (i.e. the user's Visa) has been returned. Redacted data indicators 2933 may be used to allow a trustee to reveal content of a private record associated with the indicator. For example activation of the ‘xxxx-yyyy-xxxx-uuuu’ redacted data indicator 2933b may reveal content of the private data record associated with the card number of ‘Visa’.

The user information window 2937 may be used to provide information which may be associated with a user. Such information may be provided to a guide in order that context associated with a search is available to a guide. For example a guide who may not have responded to a previous request from a user might benefit from context information. A location indicator 2982 may provide information of a location associated with a user. Filter controls 2985 may be provided to allow a guide to selectively view information such as previous requests, etc. associated with a user. The history search box 2985a may be used to indicate a search term for sorting user history information. The history search button 2985b may be used to execute a search of user information using a search term indicated in the history search box 2985a. The chronological button 2985c may be used to sort historical information chronologically. The filter controls 2985 described are used for the purposes of illustration, and other types of filtering controls which are well known in the art may be used to perform the equivalent function. Historical request indicators 2987 may be used to indicate information of a previous request. Historical result indicators 2989 may be used to indicate a previous search result. Time stamp indicators 2992 may be used to indicate time information associated with a request.

The result window 2940 may be used to indicate information associated with a search result which has been prepared by a guide. The result constraint indicator 2945 may be used to indicate any constraints which may be placed on a message which is indicated in the result window 2940. For example, as illustrated in FIG. 29, a guide is notified that there are ‘140 characters remaining’ in providing, for example, a result message limited by SMS character limits in response to a user's SMS request. The result transmit button 2950 may be used to transmit a search result indicated in the result window 2940 to a user. The action buttons 2955 may be used by a guide to take various actions. The ‘Transfer’ action button 2955a may be used to transfer a request to a different guide. The ‘Abuse’ button 2955b may be used to report inappropriate queries or actions to system administrators. The ‘Trustee’ button 2955c may be used to indicate that a trustee guide is needed to handle a request. For example, a guide might activate the ‘Trustee’ button 2955c if the guide determined that information required to fulfill a request requires redacted information to be revealed to the guide. Viewing controls 2990 may be used to navigate within a window. The viewing control 2990a, b, c may be used to navigate within the redacted result window 2930, the user information window 2937, and the provider search window 2960, respectively. A illustrated, information of a previous search session associated with a user may be persisted to provide context. For example, the previous search query and result information indicated in the provider search window 2960.

The provider search window 2960 may be used to indicate information of a search conducted using redacted information and/or other information to locate a provider responsive to a request. A provider search query box 2965 may be used to perform a search for a provider. For example, the query ‘Florists “BBBB work adrs’ which may include redacted information is indicated in the provider search query box 2965. A provider search button 2967 may be used to execute a search using a query indicated in the provider search query box 2965. Provider search result indicators 2975 may be used to provide information of a search result associated with a search performed using the provider search query box 2965 and the provider search button 2967. For example, the provider search result indicator 2975a indicates the provider ‘Flora's Flora's’. Provider connection controls 2976 may be used to connect to a provider. For example the provider connection control 2976b may be used to connect to the provider ‘Fred's Flowers’. A connection may be a voice, chat, email, or other communications. In at least one embodiment, the provider search window may search a database of providers using a custom search engine. A trustee may be able to contact a provider as needed to fulfill a user request.

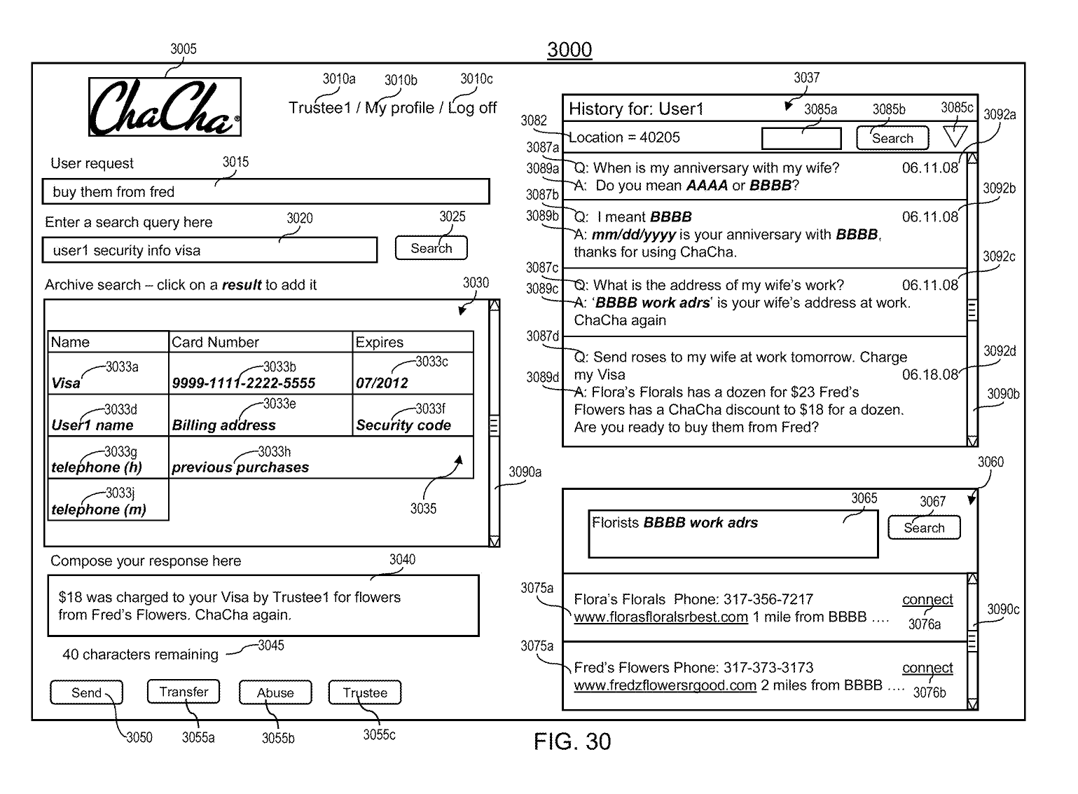

A GUI 3000 for performing a search of a repository of redacted information is illustrated in FIG. 30. The GUI 3000 may be presented to a trustee responsive to a user request. The GUI 3000 may be displayed on any suitable display device of any guide system such as the guide system 1505 (FIG. 15). The GUI 3000 may include an advertising window 3005, guide activity controls 3010, a request box 3015, a redacted search query box 3020, a redacted search button 3025, a redacted result window 3030, redacted result indicators 3035, a user information window 3037, a result window 3040, a result constraint indicator 3045, a result transmit button 3050, action buttons 3055, and a provider search window 3060,

The advertising window 3005 may include an advertisement targeted to a guide and/or a user. The guide activity controls 3010 may be used by a guide to select an activity. For example, the ‘Trustee1’ guide activity control 3010a may cause a GUI for viewing information associated with the guide ‘Trustee1’ to be presented when selected. The ‘My profile’ guide activity control 3010b may be used to display personal and/or other information associated with a guide to be presented. The ‘log off’ guide activity control 3010c may be used to log on or log off the search system 1530 (FIG. 15). The request box 3015 may be used to indicate information associated with a request. While a text or SMS message is used for the purposes of illustration, any type of information associated with a user request may be indicated in the user request box 3015. For example, media such as audio, images, etc. might be indicated in the request box 3015. Using the example in FIG. 30, the request ‘buy them from Fred’ is displayed to a guide, which may be related to a previous request and/or response provided to a user such as a request indicated in the user information window 3037. For example, the query indicated in the historical query indicator 3087d and the historical answer indicator 3089d may be used to interpret the request ‘buy them from Fred’.

The redacted search query box 3020 may be used to indicate information of a search query which has been created by a guide responsive to a request. Using the example illustrated in FIG. 30, the search query ‘user1 security information visa’ which may have been entered by a trustee responsive to a current request is indicated in the redacted search query box 3020. The redacted search button 3025 may be used to execute a search responsive to a search query indicated in the redacted search query box 3020. For example, in order to complete a transaction on behalf of a user, a trustee may be required to provide additional information to a provider such as a billing address, expiration date, security code, etc.

The redacted result window 3030 may be used to indicate a search result associated with a search request indicated in the redacted search box 3020. The redacted result indicators 3035 may be used to indicate information associated with a search result presented in the redacted result window 3030. For example, the redacted result indicator 3035 indicates that a result associated with security information of ‘Visa’ (i.e. the user's Visa) has been returned. Redacted data indicators 3033 may be used to allow a trustee to reveal content of a private record associated with the indicator. For example activation of the ‘Billing address’ redacted data indicator 3033e may reveal content of the private data record associated with the billing address associated with ‘Visa’. Activation of a redacted data indicator 3033 by a trustee may be tracked in order to determine what information has been revealed to a trustee and/or may affect a ranking of a trustee and/or may affect compensation, and/or other factors associated with a trustee.

The user information window 3037 may be used to provide information which may be associated with a user. Such information may be provided to a guide in order that context associated with a search is available to a guide. For example a guide who may not have responded to a previous request from a user might benefit from context information. A location indicator 3082 may provide information of a location associated with a user. Filter controls 3085 may be provided to allow a guide to selectively view information such as previous requests, etc. associated with a user. The history search box 3085a may be used to indicate a search term for sorting user history information. The history search button 3085b may be used to execute a search of user information using a search term indicated in the history search box 3085a. The chronological button 3085c may be used to sort historical information chronologically. The filter controls 3085 described are used for the purposes of illustration, and other types of filtering controls which are well known in the art may be used to perform the equivalent function. Historical request indicators 3087 may be used to indicate information of a previous request. Historical result indicators 3089 may be used to indicate a previous search result. Time stamp indicators 3092 may be used to indicate time information associated with a request.

The result window 3040 may be used to indicate information associated with a search result which has been prepared by a guide. The result constraint indicator 3045 may be used to indicate any constraints which may be placed on a message which is indicated in the result window 3040. For example, as illustrated in FIG. 30, a guide is notified that there are ‘40 characters remaining’ in providing, for example, a result message limited by SMS character limits in response to a user's SMS request. The result transmit button 3050 may be used to transmit a search result indicated in the result window 3040 to a user. The action buttons 3055 may be used by a guide to take various actions. The ‘Transfer’ action button 3055a may be used to transfer a request to a different guide. The ‘Abuse’ button 3055b may be used to report inappropriate queries or actions to system administrators. The ‘Trustee’ button 3055c may be used to indicate that a trustee guide is needed to handle a request. For example, a guide might activate the ‘Trustee’ button 3055c if the guide determined that information required to fulfill a request requires redacted information to be revealed to the guide. Viewing controls 3090 may be used to navigate within a window. The viewing control 3090a, b, c may be used to navigate within the redacted result window 3030, the user information window 3037, and the provider search window 3060, respectively. A illustrated, information of a previous search session associated with a user may be persisted to provide context. For example, the previous search query and result information indicated in the provider search window 3060 may be used to compose a response to a user as indicated in the result window 3040.

The provider search window 3060 may be used to indicate information of a search conducted using redacted information and/or other information to locate a provider responsive to a request. A provider search query box 3065 may be used to perform a search for a provider. For example, the query ‘Florists “BBBB work adrs’ which may include redacted information is indicated in the provider search query box 3065. A provider search button 3067 may be used to execute a search using a query indicated in the provider search query box 3065. Provider search result indicators 3075 may be used to provide information of a search result associated with a search performed using the provider search query box 3065 and the provider search button 3067. For example, the provider search result indicator 3075a indicates the provider ‘Flora's Flora's’. Provider connection controls 3076 may be used to connect to a provider. For example the provider connection control 3076b may be used to connect to the provider ‘Fred's Flowers’. A connection may be a voice, chat, email, or other communications. In at least one embodiment, the provider search window may search a database of providers using a custom search engine. A trustee may be able to contact a provider as needed to fulfill a user request.

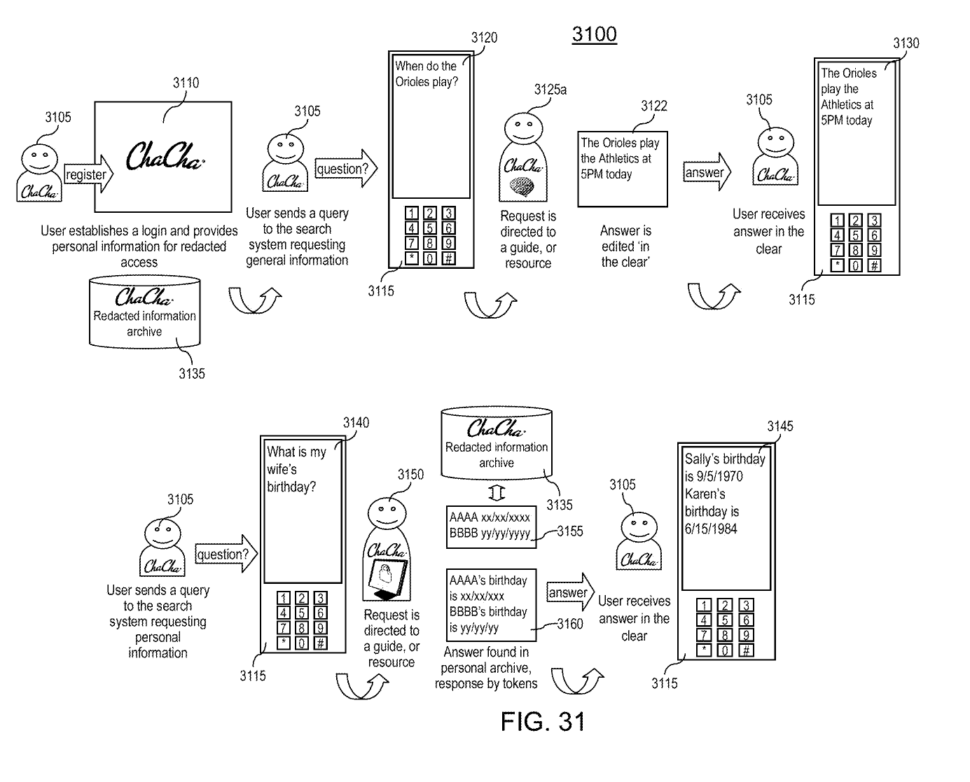

An exemplary sequence of messages 3100 between a user device and a guide device via the search system 1530 (FIG. 15) is illustrated in FIG. 31A. As previously described, a user may create and/or update a repository of redacted information. A user 3105 may register with the search system 1530 (FIG. 15) and may create the redacted information archive 3135. The user 3105 may transmit a request message 3120 to the search system 1530 using a user device 3115 by for example an SMS messaging. The search service 1530 may route the message to a guide 3125a who may create and send an answer message 3122. The answer message 3122 may be provided to the search system 1530 which may transmit the response message 3130 to the user device 3115. In such an instance, all information included in a result is revealed to a guide.

At some other time, the user 3105 may send a ‘birthday’ request message 3140 from the user device 3115 which may require access to information indicated in the redacted information archive 3135. The ‘birthday’ request message 3140 may be received by the search system 1530 (FIG. 15) and may be provided to a confidential guide 3150 automatically and/or using human assistance. The confidential guide 3150 may access the redacted information archive 3135 and may obtain redacted search results 3155. The confidential guide 3150 may compose a redacted response message 3160 which may be provided to the search system 1530. The search system 1530 may obtain the relevant information in the redacted information archive associated with ‘tokens’ indicated in the response message, and may replace the tokens with the redacted information. The search system 1530 may provide a decoded result message 3145 to the user device 3115. In this instance, the redacted data is only revealed to the user 3105.

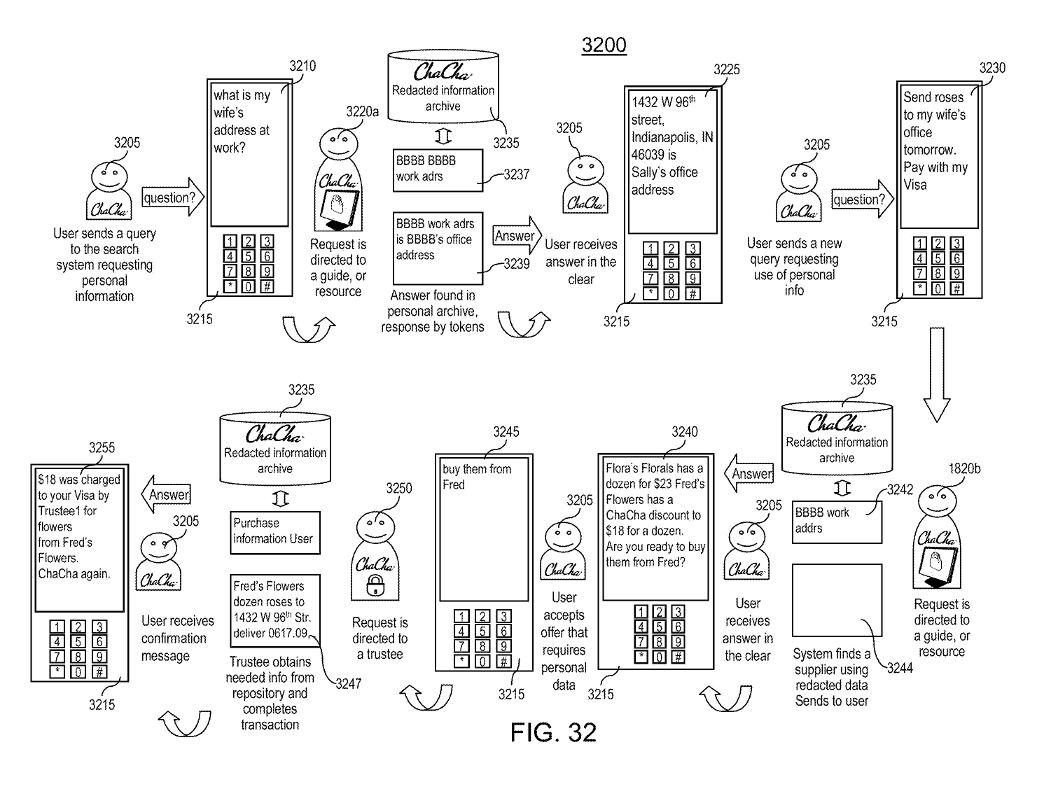

An exemplary sequence of messages between a user, a number of guides, and the search system 1530 (FIG. 15) which may utilize information indicated in a redacted information repository is illustrated in FIG. 32. A user 3205 may create a repository of redacted information 3235 as previously described herein. The user 3205 may send a private information request 3210 from a user device 3215 to the search system 1530. As the private information request 3210 includes a request for information which may be indicated in a repository of redacted information, the request 3210 may be routed to a confidential guide 3220a. The confidential guide 3220a may perform a search of the repository 3235 and may obtain a redacted search result 3237. The confidential guide 3220a may compose the redacted result message 3239 which may be provided to the search system 1530. The search system 1530 may access the repository 1735 and provide the result message 3225 to the user device 3215.

At some time, the user 3205 may send a purchase request message 3230 from the user device 3215 to the search system 1530. The purchase message 3230 may be provided to a confidential guide 3220b, who may or may not be the same guide as the confidential guide 3220a. The confidential guide 3220b may access the repository 3235 and/or other resources and may obtain search results 3242 which may or may not include redacted information. The confidential guide 3220b may provide the search result message 3244. The search system 1530 (FIG. 15) may provide a response message 3240 to the user 3205 using the user device 3215.

At some time, the user 3205 may send a purchase acceptance message 3245 to the search service 1530. As the acceptance message 3245 may be interpreted to require that information indicated in the repository 3235 is revealed, the purchase acceptance message 3245 may be provided to a trustee guide 3250. The trustee 3250 may obtain and/or reveal information indicated in the repository 3235, which may be received by a provider in order to complete a transaction requested by the user 3205. The trustee 3250 may compose a confirmation message 3247, which is provided to the search system 1530. The search system 1530 may provide the confirmation message 3255 to the user 3205 at the user device 3215.

While an exemplary sequence of messages between a single user device and the search system has been used for the purpose of illustration in FIG. 31 and FIG. 32, no limitation is implied thereby. Any number of user devices and/or services might be used in an exchange of information utilizing information indicated in a repository of redacted information, which may be assisted by any number of guides.

Using the methods and system described herein an information seeker or user may obtain information from a database of restricted information which has been identified by the information seeker using the assistance of one or more human searchers or human assistants or guides. A user may obtain assistance from one or more guides in order to perform a transaction. A transaction may include any type of activity such as a purchase, exchange, bid, transfer, etc. As needed, a user may be provided with access to a guide who has an appropriate level of security access in order to process a user transaction.

A user may receive information from a guide which is stored in a database of restricted information without revealing the information to the guide. A user may provide information to a guide that may be stored in a database or repository of restricted information. Guides may have various types of access privileges. For example, a guide may have the ability to access restricted data files, but may not be able to determine the content of the files, or a trusted guide of ‘concierge’ may have access to various types of personal information such as credit card information, or other sensitive information which may be used to complete various types of transactions on behalf or a user, or a guide may have access to view any or all content of a file indicated in a database of restricted information. Access rights may be based on a user, a guide, a type of transaction, a provider of service, and/or other factors.

A guide and/or concierge may perform a transaction (service) on behalf of a user. A query history may be provided to a guide in order that a transaction may be completed by a number of guides who may be utilized to fulfill a user request. A guide may obtain permission from a user to allow access to private or restricted data to be provided to a third party. A third party which may provide an item and/or service may be determined at least in part by a guide who may interact with the third party and/or a user in order to respond to a request from the user. Using a database of restricted information and/or access to a human assistant, a user may complete any sort of transaction using information from restricted and/or unrestricted information resources. Any type of communication service which allow a user to access search services such as wired or wireless voice, SMS, EMS, MMS, Instant Messaging, internet protocol (IP), email, may be used in order to identify and complete a transaction.

A layered approach to management of requests allows the system to respond suitably to many types of requests flexibly, if a request requires a human assistant, an expediter or searcher guide may be assigned to the task. If a request requires access to confidential information, a confidential guide, who may access, but not reveal content of private or redacted records is assigned to respond to the request. If a request requires confidential or redacted information to be revealed, a trustee guide with suitable security and qualifications is assigned to the request.

While the system has been described in the context of a user requesting information and executing a purchase transaction, use of the system is not limited to purchase transactions. For example, a user might need to access financial information, legal documents, medical information, business data, personal records such as photos, videos, etc. As the level of access may be blended using guides, confidential guides, and trustees, who may be associated with different categories and types of information a user may access, distribute and manage practically any type of information from anywhere any time. As the confidential information is indexed and accessible, it may be requested as needed. Further a human assistant may readily understand a request for a document which would be inaccessible to a search system.

The operator of the search system or information archive benefits greatly as confidential information may be provided without the need for large numbers of guides who have the credentials required to handle highly sensitive documents such as healthcare, financial, employment, etc. information. Thus the cost of providing a premium service is lowered due to the ability to provide a trustee only when needed, rather than having a trustee handle every transaction.

As the cost of providing a search service which protects confidential information is reduced, users may be more likely to recognize the benefits of such a service. A provider of search services may cooperate with a provider of credit card, banking, and/or other services who may offer such a service by using the underlying search service as a ‘white labe1’ provider. This may allow a lower cost to serve for the financial service provider, and direct income for the search service provider.

Using the embodiments described herein, a user may submit a request using a user system and may receive a response which is associated with an ‘activity’ or triggered activity which includes a defined group of one or more trigger actions which may produce a system response when the action is detected. An activity may be defined by a content provider and does not require specific knowledge of how to contact a user, or of a user device. An activity may be associated with a user based on various criteria which may be selected. Content of an activity may be defined by an administrator and/or may be defined by a content provider. A message may be transmitted to a user when an activity is associated with the user. A message may be delivered to a user via a wireless service provider and/or using the services of a wireless messaging aggregator and/or using any communication services associated with the user.

A content provider is registered and may provide information in order that content can be delivered to a user. A user may not be required to register. Content to be provided to a user may be selected based on various information associated with the content such as content provider, service provider, aggregator, category, location, area code, keyword, etc. which may be associated with a user system and/or a search request. If a trigger action is detected, a response action may be performed, which may cause a number of activities to be associated with and/or disassociated with a user. Activities associated with a user system may be tracked and may be modified as agreed with a content provider in order to resolve any conflicts which may exist between activities which are associated with a user system.

A user may be allowed to receive a message such as an SMS message which may include instructions regarding an activity as well as other forms of sponsored content. Keywords and/or other actions which are associated with a user system rather than being associated with all user systems may be enabled. The new system allows personalization of system responses based on any characteristic which is assigned to a user. Such personalization may be used to optimize user experience, more effectively target information to a user, enhance revenue opportunities, and customize user experience without overburdening the information system. Historical information of a user may be employed to associate activities with the user which may customize responses at the individual user level.

While a limited number of examples of user interactions have been illustrated, there are no limitations on the types of trigger events and/or trigger actions. The embodiments and principles described herein may be used to implement features such as games, polls, automatic responses, system help, localization of messages, etc. The personalization of messaging based on a unique user may be used in human assisted search activities, but may be applied to other systems as well. For example, an interactive automated search might be implemented using text responses to messages which are transmitted to a search service, or a response to a query which includes multiple elements might be navigated by text responses of a user. The flexibility and scalability of the system may allow a content provider to use different types of messaging and content without the need to explicitly direct the content to a known group of user. Further content management is simplified as the system may operate while modified and/or new content is provided.

Any or all of the operations described herein may be implemented via one or more hardware components. However, the present invention is not limited to any specific implementation of an operation. For example, one or more operations discussed herein may be implemented via software executed on a device while others may be executed via a specific hardware device.

The present invention may be implemented using a program stored, for example, in a computer-readable storage medium such as a CD-ROM, etc., or using one or more specialized terminals, devices or systems that is enabled to execute operation(s) described herein. The storage or recording medium used in an embodiment can be selected from among various computer-readable media including, a disk, a DVD, an internal storage device (memory such as RAM or ROM) in a computer, etc.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the described features, functions and/or operations can be provided.

The many features and advantages of the claimed invention are apparent from the detailed specification and thus, it is intended by the appended claims to cover all such features and advantages of the claimed invention that fall within the true spirit and scope of the invention. Further, since numerous modifications and changes will readily occur to those skilled in the art, it is not desired to limit the invention to the exact construction and operation illustrated and described for the disclosed embodiments, and accordingly all suitable modifications and equivalents may be resorted to, falling within the scope of the claimed invention. It will further be understood that the phrase “at least one of A, B and C” may be used herein as an alternative expression that means “one or more of A, B and C.”

What is claimed is:

1. A computer-implemented method of interacting with a user, comprising:
defining an action and associating the action with a first response;
associating the action with a second response;
associating the action and the first response with a user;
detecting the action;
determining whether the action is associated with the user;
executing the first response when said determining indicates that the action is associated with the user; and
executing the second response when said determining indicates that the action is not associated with the user.

2. The computer-implemented method of claim 1, comprising:
delivering a message to the user; and
associating the action and the first response with the user based on content of the message.

3. The computer-implemented method of claim 1, comprising:
modifying the action based on a message received from the user.

4. The computer-implemented method of claim 1, comprising:
modifying the first response based on a rating of a content provider.

5. The computer-implemented method of claim 1, comprising:
defining a user characteristic;
associating the characteristic with the action and the first response;
determining whether the action is associated with the user based on the association of the characteristic with the user.

6. The computer-implemented method of claim 1, comprising:
providing an advertisement as the first response;
providing a poll as the second response;
analyzing a message of a user device to detect the action; and
analyzing a message history associated with the user to determine whether the action is associated with the user.

7. The computer-implemented method of claim 1, wherein;
the action is a message including a keyword;
the first response includes providing the message to the user; and
the second response includes associating the action with a third response.

8. The computer-implemented method of claim 1, wherein;
the detecting includes analyzing a text message;
the determining includes obtaining a keyword included in a previous message to the user and at least one additional character; and
the first response includes providing a message including the at least one additional character to a resource associated with the first response.

9. The computer-implemented method of claim 1, wherein;
the detecting includes analyzing a text message;
the determining includes obtaining a keyword included in a previous message to the user and at least one additional character;
the first response includes providing a message including the at least one additional character to a resource associated with the first response.
the action is a message including a keyword;
the first response includes providing a message to the user; and
the second response includes associating the action with a third response the method comprises:
delivering the message to the user; and
associating the action and the first response with the user based on content of the message;
modifying the action based on the message received from the user.
defining a user characteristic;
associating the characteristic with the action and the first response;
determining whether the action is associated with the user based on the association of the characteristic with the user.
providing an advertisement as part of the first response;
providing a poll as a part of the second response;
analyzing a message of a user device to detect the action; and
analyzing a message history associated with the user to determine whether the action is associated with the user.

10. A system, comprising:
a search service device registering a user, receiving a request, communicating with a guide device, a content provider device, and a user device and providing a response to the request;
a user device submitting a query;
a content provider device providing content responsive to a request from the search service device;
a service provider device providing communication services to the user device and the search system device;
a network; and
a database recording and providing information of queries, users, content providers, and service providers.

11. The system of claim 10, wherein;
the search service device registers a guide;
the database records and provides information of a guide; and
the system includes a guide device responding to the query.

12. A computer readable storage medium storing therein a program for causing a computer to execute an operation including providing an interface for a user, comprising:
specifying a trigger;
sending a text message describing the trigger;
linking the trigger with a first reaction;
linking the trigger with a second reaction;
linking the trigger and the first reaction with a user;
recognizing the trigger;
resolving whether the trigger is linked with the user;
performing the first reaction when the trigger is linked with the user;
performing the second reaction when the trigger is not linked with the user.

13. The computer readable medium of claim 12, wherein the operation comprises:
linking the trigger with the user based on a response of the user to the text message;
unlinking the trigger with the user when determining that an event occurs.

14. The computer readable medium of claim 12, comprising:
initiating a game as the first reaction; and
providing a download of a media file as the second reaction.

15. The computer readable medium of claim 12, comprising:
linking a location with the user; and
linking the trigger with the location.

16. The computer readable medium of claim 12, comprising:
selecting the first reaction based on a ranking of an advertisement; and
selecting the second reaction based on a ranking of a guide.

17. The computer readable medium of claim 12, comprising:
sending an advertising message describing the trigger;
including sending a selected advertisement in the first action; and
including sending a selected poll in the second action.

18. The computer readable medium of claim 12, wherein the recognizing includes analyzing an SMS message, the resolving includes determining a location and a service provider associated with the user, and a content provider provides the trigger and the first reaction.

19. The computer readable medium of claim 12, wherein the recognizing includes analyzing an SMS message, the resolving includes determining a location and a service provider associated with the user, and the operation includes:
providing by a content provider the trigger and the first reaction;
linking the trigger with the user based on a response of the user to the text message;
unlinking the trigger with the user when determining an event occurs;
initiating a game in the first reaction;
providing a download of a media file in the second reaction;
linking a location with the user;
linking the trigger with the location;
selecting the first reaction based on a ranking of an advertisement;
selecting the second reaction based on a ranking of a guide;
sending an advertising message describing the trigger;
sending a selected advertisement in the first action;
sending a selected poll in the second action; and
providing by a content provider the trigger and the first reaction.

20. A computer-implemented method, comprising:
creating an index of redacted information associated with a user; and
selectively revealing the redacted information to an authorized human assistant to perform a transaction on behalf of the user.

21. A method of interacting with a user, comprising:
determining whether a request received is associated with an action; and
customizing a response to the request based on content resulting from triggering the action when said determining indicates that the request is associated with the action.
